(19) United States
(12) Patent Application Publication
(10) Pub. No.: US 2016/0125481 A1
(43) Pub. Date: May 5, 2016

(54) APPRAISAL SYSTEM AND INTERFACE THERETO

(71) Applicant: Canary Analytics International B.V., Amsterdam (NL)

(72) Inventors: Jeremy D. Sicklick, Palos Verdes Estates, CA (US); Christopher V. Stroud, San Antonio, TX (US); Joseph R. Pitzo, San Francisco, CA (US)

(21) Appl. No.: 14/926,021

(22) Filed: Oct. 29, 2015

Related U.S. Application Data
(60) Provisional application No. 62/075,348, filed on Nov. 5, 2014.
(60) Provisional application No. 62/245,982, filed on Oct. 23, 2015.

(51) Int. Cl. G06Q 30/02; G06Q 50/16

(52) U.S. Cl. CPC G06Q 30/0278; G06Q 50/16

(57) ABSTRACT

A framework for real property appraisal includes a backend computer system having a user interface mechanism supporting a graphical user interface to the backend computer system; and one or more devices operably connected to the backend computer system and interacting with the backend computer system via the user interface mechanism. Each of the devices is programmed to: obtain information from the backend computer system about a particular property; obtain user input about the particular property; and provide appraisal information to the backend computer system based on the user input.

### CROSS REFERENCE TO RELATED APPLICATION

This application is related to and claims priority from: (i) U.S. Provisional Patent Application No. 62/075,348, filed Nov. 5, 2014, titled “Appraisal System and Interface Thereto,” and (ii) U.S. Provisional Patent Application No. 62/245,982, filed Oct. 23, 2015, titled “Appraisal System and Interface Thereto,” the entire contents of both of which are fully incorporated by reference herein for all purposes.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### BACKGROUND OF THE INVENTION

### Field of the Invention

This invention relates to a framework for appraisals of real property, and, more specifically, to a graphical user interface supporting appraisals of real property.

### BRIEF DESCRIPTION OF THE DRAWINGS

Other objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification. None of the drawings are to scale unless specifically stated otherwise.

FIGS. 1-2 show overviews of aspects of an appraisal framework in accordance with exemplary embodiments hereof;

FIGS. 3A-3D depict aspects of devices in accordance with exemplary embodiments hereof;

FIGS. 4A-4E depict aspects of computing and computer devices in accordance with exemplary embodiments hereof; and

FIGS. 5A-5D, 6A-6H, 7A-7F, 8A-8H, 9A-9C, 10A-10H, 11A-11D, 12A-12G, 13A-13B, 14A-14D, 15A-15D, and 16A-16D are sample screen shots of an exemplary graphical user interface to an appraisal framework in accordance with embodiments hereof.

### DETAILED DESCRIPTION OF THE PRESENTLY PREFERRED EXEMPLARY EMBODIMENTS

### Glossary and Abbreviations

As used herein, unless used otherwise, the following terms or abbreviations have the following meanings:

API means application programming interface;

GUI means graphical user interface;

REO means real estate owned; and

UI means user interface.

As used herein, the term “mechanism” refers to any device(s), process(es), service(s), or combination thereof. A mechanism may be implemented in hardware, software, firmware, using a special-purpose device, or any combination thereof. A mechanism may be integrated into a single device or it may be distributed over multiple devices. The various components of a mechanism may be co-located or distributed. The mechanism may be formed from other mechanisms. In general, as used herein, the term “mechanism” may thus be considered to be shorthand for the term device(s) and/or process(es) and/or service(s).

As used herein the term “real property” refers, without limitation, to any property that is attached directly to land, as well as the land itself. Real property not only includes buildings and other structures, but also rights and interests. Real property can be rental or residential or commercial. It should be appreciated that the system described herein is not limited in any way by the type or nature of the property.

### Background and Overview

It is often necessary to determine a value of property, especially real property. For example, the transfer or sale of real property typically requires a determination of a value of that property. Similarly, the use of real property as collateral for a loan or the like typically requires a determination of a value of that property. Such a value determination is generally made as a so-called appraisal by an appraiser—a person qualified to determine the value of the property.

In the case of real property, an appraisal is typically a written estimate of a property's market value completed by an appraiser. The value may be based on a number of factors including information about the property itself (e.g., the property's physical condition) and information about other properties (e.g., a market analysis of recent sales prices for similar properties in the same area). While a good and experienced appraiser may be able to determine some information about other properties, such an appraiser may not have the resources or time to make a complete and accurate evaluation of such information. Furthermore, different appraisers may use different approaches and/or information to evaluate information about other properties. This approach may lead to inconsistencies among appraisals generated by different appraisers.

Many parties (such as lending institutions (e.g., banks, etc.), buyers, borrowers, and sellers) rely on the accuracy of appraisals, and incomplete or inaccurate appraisals may lead to serious financial problems. Systemic problems with real property appraisals may cause national or international financial problems.

It is therefore desirable to provide a system that supports the accurate, consistent, and efficient determination of real property appraisals.

As used herein, the term “information about” a property refers to any information that may be determined or derived directly or indirectly about the property.

Various terms such as “buyer,” “seller,” “sale,” are used herein to describe the exemplary system. These terms are not intended to limit the scope of the system in any way.

As used herein, the term “sale” with respect to property refers to the exchange of some rights in the property (typically ownership rights) for something else of value (typically money). The rights to be exchanged may include some or all of the rights in the property. It should be appreciated that the systems described herein are not limited in any way by the type of sale being contemplated or by the rights being sold or acquired.

As used herein the term “buyer” refers to any entity or person attempting to purchase or purchasing some or all rights in a property. The system described herein is not limited in any way by the nature of buyer.

As used herein the term “seller” refers to any entity or person selling or attempting to sell some or all rights in a property.

Very often a buyer of a property borrows some or all of the money that is needed to purchase the property. The buyer will get the needed money in the form of a loan from a lender (e.g. a bank or a mortgage company or the like). As used herein a lender refers to any entity or person who may lend money or something of value to a buyer for the purchase of a real property.

Overview—Structure

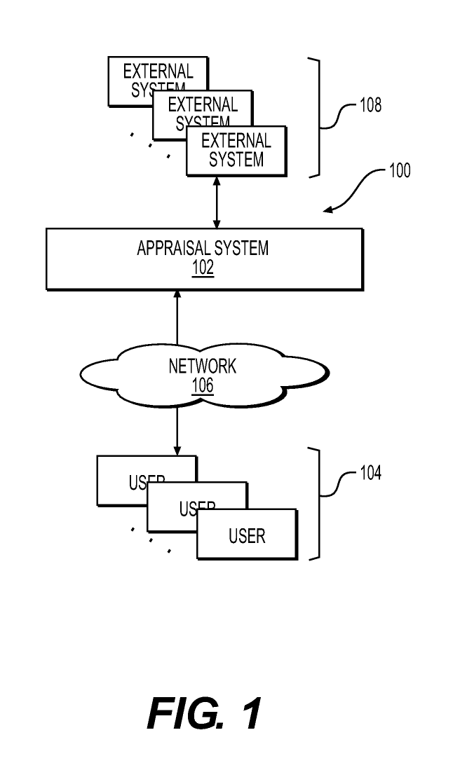

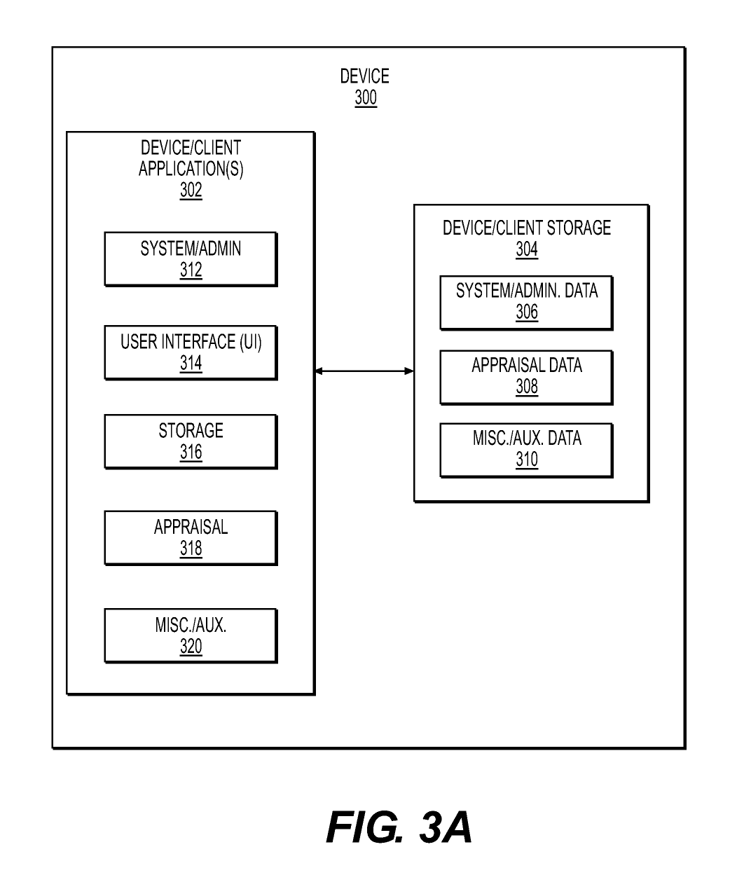

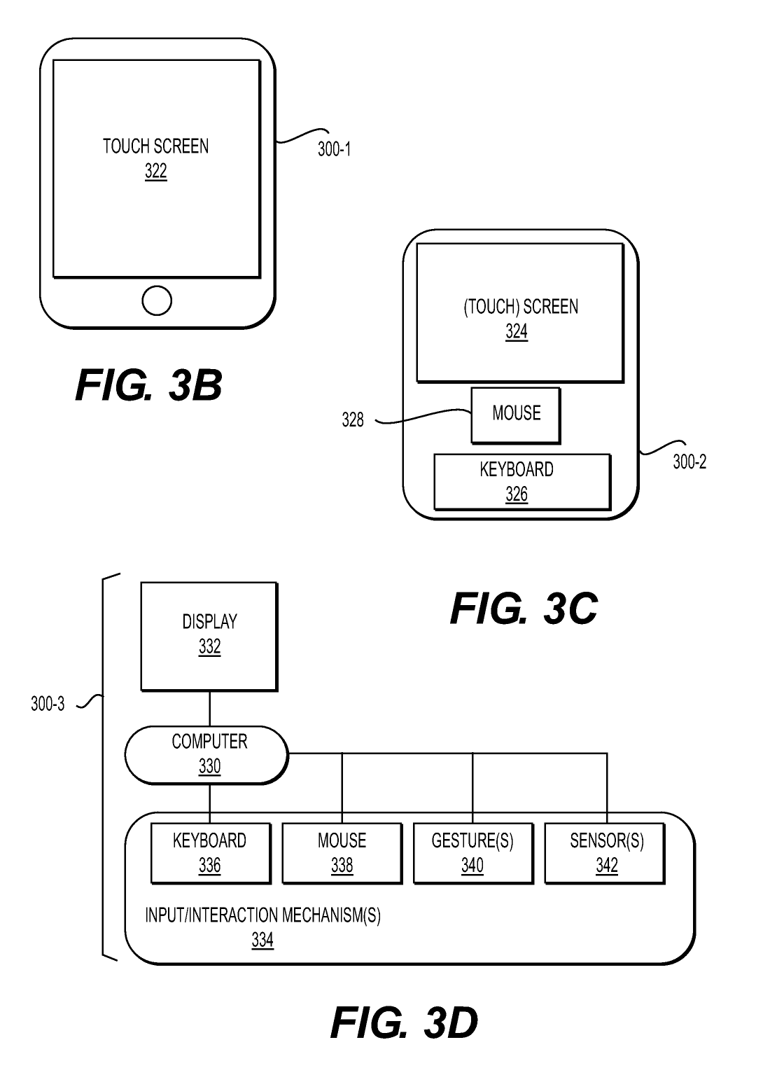

FIG. 1 shows an overview of an exemplary framework 100 for an appraisal system according to exemplary embodiments hereof. As shown in FIG. 1, an appraisal system 102 may be accessed by multiple users 104, e.g., via a network 106 (e.g., the Internet). Each user 104 (e.g., an appraiser) may access the appraisal system 102 using one or more computing devices, as discussed below with reference to FIGS. 3A-3D. The appraisal system 102 may also access and be accessible by various external systems 108 (e.g., banks, governmental entities, databases, and the like).

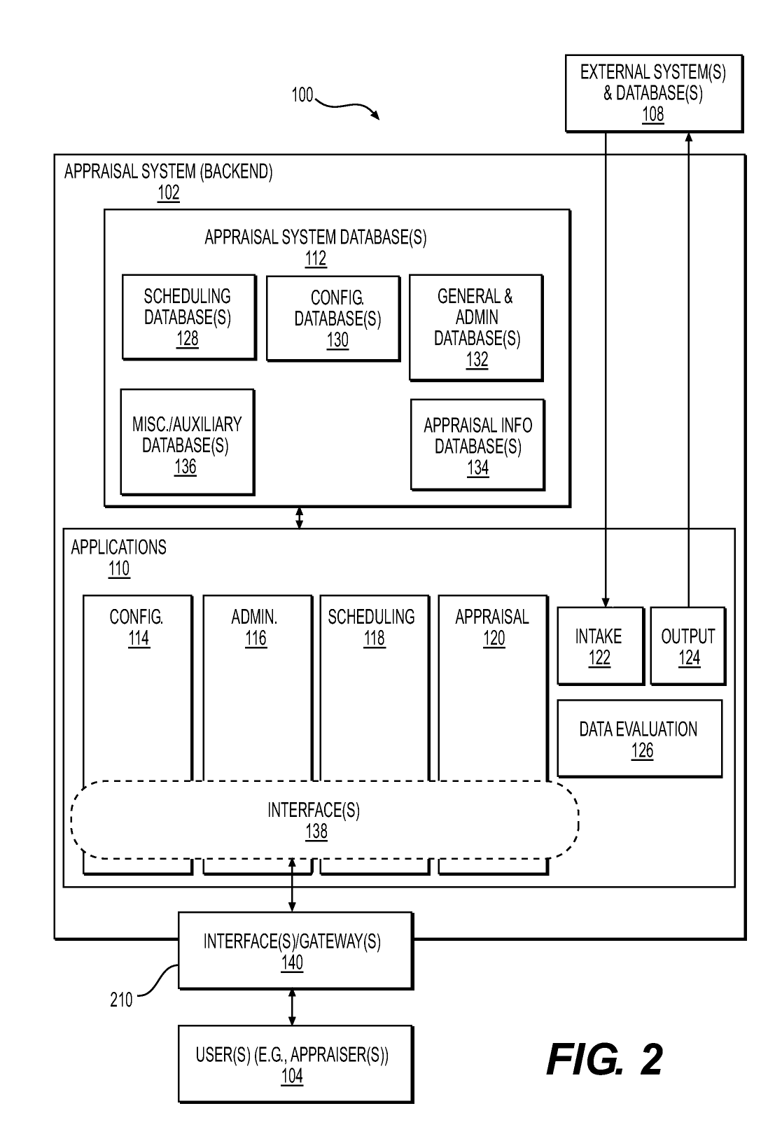

FIG. 2 shows aspects of the exemplary appraisal framework 100 of FIG. 1. As shown in FIG. 2, the appraisal system 102 (also sometimes referred to conveniently as the “backend”) comprises various applications 110 and one or more databases 112, described in greater detail below.

The database(s) 112 may be or comprise multiple separate or integrated databases, at least some of which may be distributed. The database(s) 112 may be implemented in any manner, and, when made up of more than one database, the various databases need not all be implemented in the same manner. It should be appreciated that the system is not limited by the nature or location of database(s) 112 or by the manner in which they are implemented.

Each of the applications 110 is essentially a mechanism (as defined above) that may provide one or more services via an appropriate interface. Although shown as separate mechanisms for the sake of this description, it should be appreciated that some or all of the various applications 110 may be combined. The various applications (mechanisms) 110 may be implemented in any manner and need not all be implemented in the same manner (e.g., with the same languages or interfaces or protocols).

The applications 110 may include configuration application(s) 114, administrative application(s) 116, appraisal scheduling application(s) 118, appraisal application(s) 120, intake application(s) 122, output application(s) 124, and data evaluation application(s) 126. The applications 110 may also include other miscellaneous and auxiliary applications (not shown).

The database(s) 112 may include appraisal scheduling database(s) 128, configuration database(s) 130, general and administrative database(s) 132, appraisal information database(s) 134, and miscellaneous and auxiliary database(s) 136.

As shown in the drawing in FIG. 2, the appraisal system backend 102 may access one or more external systems and databases 108. This access may include access via intake mechanism 122 which may access external systems in order to obtain data therefrom, and access via output application(s) 124 in order to provide information (e.g., appraisals) to the external systems and databases 108. Data evaluation application(s) 126 may evaluate data (e.g., obtained from external systems and databases 108 and/or in the back-end's appraisal system database(s) 112) in order to determine information therefrom. The data evaluation application(s) 126 may include: one or more applications to determine market trends for a region; one or more applications to determine consistency of appraisals, etc.

Various applications 110 in the appraisal system backend 102 may be accessible via interface(s) 138. These interfaces 138 may be provided in the form of APIs or the like, made accessible to external users 104 via one or more gateways and interfaces 140. For example, the appraisal application(s) 120 may provide APIs thereto (interface(s) 138), and the backend 102 may provide external access to aspects of the appraisal application(s) 128 (to users 104) via appropriate gateways and interfaces 140 (e.g., via a web-based application and/or an application running on a user's device).

Users' Devices

Users (e.g., appraisers, lenders, etc.) may access the appraisal system backend 102 using computing devices. It should be appreciated that the box labeled 104 in the drawings may refer to a user's computing device. The devices can be any kind of computing device, including mobile devices (e.g., phones, tablets, etc.), computers (e.g., desktops, laptops, etc.), and the like. Computing devices are described in greater detail below.

FIG. 3A shows aspects of a typical device 300, including device/client applications 302 interacting with device/client storage 304. Device/client storage 304 may include system/administrative data 306, appraisal data 308, and miscellaneous/auxiliary data 310. The device/client application(s) 114 may include system/administrative applications 312, user interface (UI) applications 314, storage applications 316, appraisal applications 318, and other miscellaneous/auxiliary applications 320. The categorization of data in storage 304 is made for the purposes of aiding this description, and those of ordinary skill in the art will realize and appreciate, upon reading this description, that different and/or other categorizations of the data may be used. It should also be appreciated any particular data may categorized in more than one way. Similarly, it should be appreciated that different and/or other categorizations of the device/client applications 302 may be used and furthermore, that any particular application may be categorized in more than one way.

Some or all of the components that make up a device may be integrated into a single physical device or appliance (e.g., a laptop computer), or they may all be separate components (e.g., a desktop computer). The connections between some or all of the components may be wireless. As another example, a device may be integrated into a television or a set-top box or the like. Preferably each user's device has access to (or has built in) a camera or the like.

FIGS. 3B-3D show examples of devices 300-1, 300-2, and 300-3 that may be used within the system 100. These may correspond, e.g., to devices used by the users 104 in FIG. 1. Device 300-1 (FIG. 3B) has an integrated display and input mechanism in the form of touch screen 322. The device 300-1 is integrated into a single component, e.g., a smartphone, a tablet computer, or the like. Device 300-2 (FIG. 3C) is also integrated into a single component, but, in addition to a screen 324, it includes a keyboard 326 and an integrated mouse 328. The keyboard may be a hardware keyboard (e.g., as in the case of a BlackBerry phone). The screen 324 may be a touch screen and the keyboard may be implemented as a software (or virtual) keyboard. Device 300-3 (FIG. 3D) comprises multiple components, including a computer 330, a computer monitor 332, and input/interaction mechanism(s) 334, such as, e.g., a keyboard 336 and/or a mouse 338. The device 300-3 may also include gesture recognition mechanism 340 and one or more sensors 342. The sensors 342 may include microphones, cameras and the like. In addition, the sensors 342 may include specialized sensors for measurement of environmental factors such as radon, gas, electromagnetic radiation and the like. Some or all of these components may be integrated into a single physical device or appliance (e.g., a laptop computer), or they may all be separate components (e.g., a desktop computer). Although the various components of device 300-3 are shown connected by lines in the drawing, it should be appreciated the connection between some or all of the components may be wireless. For example one or more of the sensors 342 may be wirelessly connected to the device.

Some of the sensors may be incorporated into wearable devices (e.g., Google glass-type systems) possibly with voice recognition.

As another example, a device may be integrated into a television or a set-top box or the like. Thus, e.g., with reference again to FIG. 3D, the display 332 may be a television monitor and the computer 910 may be integrated fully or partially into the monitor. In this example, the input/interaction mechanisms 334 (e.g., keyboard 336 and mouse 338) may be separate components connecting to the computer 330 via wired and/or wireless communication (e.g., via Bluetooth or the like). In some cases, the input/interaction mechanisms 334 may be fully or partially integrated into a remote control device or the like. These input/interaction mechanisms 334 may use virtual keyboards generated by the computer 330 on the display 332.

These exemplary devices are shown here to aid in this description, and are not intended to limit the scope of the system in any way. Other devices may be used and are contemplated herein.

A User Interface

A user interface (UI) may be implemented, at least in part, on a device 300, and preferably uses the device's display(s) and input/interaction mechanism(s). Use of a UI may require selection of items, navigation between views, and input of information. It should be appreciated that different devices support different techniques for presentation of and user interaction with the UI. For example, a device with an integrated touch screen (e.g., device 300-1 as shown in FIG. 3B) may display UI information on the touch screen 332, and accept user input (for navigation, selection, input, etc.) using the touch screen (perhaps with a software/virtual keyboard for some types of input). A device with an integrated screen, keyboard, and mouse (e.g., device 300-2 as shown in FIG. 3C) may display UI information on the screen 324, and accept user input using the hardware keyboard 326 and hardware mouse 328. If the screen/display 324 is also a touch screen display, then user interactions with the UI may use the screen (e.g., with a virtual keyboard) instead of or in addition to the keyboard 326 and mouse 328. A device with separate components (e.g., device 300-3 of FIG. 3D) may display UI information on the display 332 and accept user input to the UI using the keyboard 336, mouse 338 (and possibly via gesture mechanism 340).

UI Interactions

A UI presents information to a user, preferably in the form of text and/or graphics (including drawings, pictures, icons, photographs, etc.) on the display(s) of the user's device(s). The user may interact with the UI by variously selecting regions of the UI (e.g., corresponding to certain desired choices or functionality), by inputting information via the UI (e.g., entering text, pictures, etc.), and performing acts (e.g., with the mouse or keyboard) to affect movement within the UI (e.g., navigation within and among different views offered by the UI).

The UI application(s) 314 (FIG. 3A) preferably determines (or knows) the type and capability of the device on which it is running, and the UI may vary its presentation of views depending on the device. For example, the UI presented on a touch screen display on a smartphone may have the same functionality as the UI presented on the display of general-purpose desktop or laptop computer, although the navigation choices and other information may be presented differently.

It should be appreciated that, depending on the device, the UI may not actually display information corresponding to navigation, and may rely on parts of the screen and/or gestures to provide navigation support. For example, different areas of a screen may be allocated for various functions, and the UI may not actually display information about these regions or their potential functionality.

Thus, the manner in which UI interactions take place will depend on the type of device and interface mechanisms it provides.

As used herein, in the context of a UI, the term “select” (or “selecting”) refers to the act of a user selecting an item or region of a UI view displayed on a display/screen of the user's device. The user may use whatever mechanism(s) the device provides to position the cursor appropriately and to make the desired selection. For example, a touch screen 332 on device 300-1 may be used for both positioning and selection, whereas device 300-3 may require the mouse 328 (and/or keyboard 336) to position a cursor on the display 332 and then to select an item or region on that display. In the case of a touch screen display, selection may be made by tapping the display in the appropriate region. In the case of a device such as 300-3, selection may be made using a mouse click or the like.

Touch-screen devices (e.g., an iPad, iPhone, etc.) may recognize and support various kinds of touch interactions, including gestures, such as touching, pinching, tapping, and swiping. These gestures may be used to move within and among views of a UI.

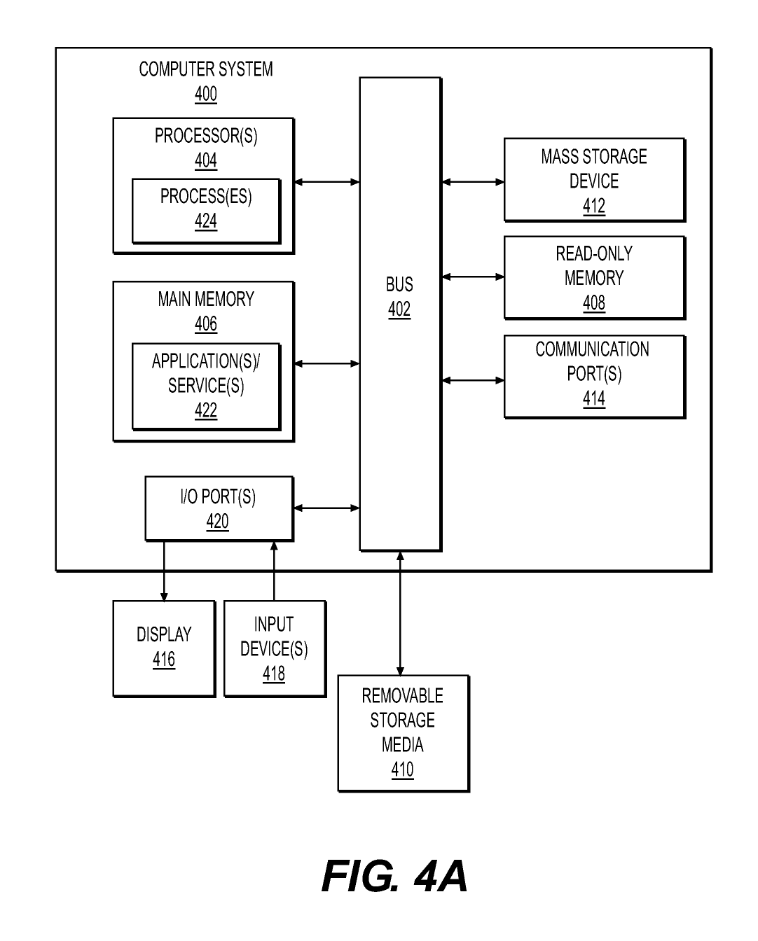

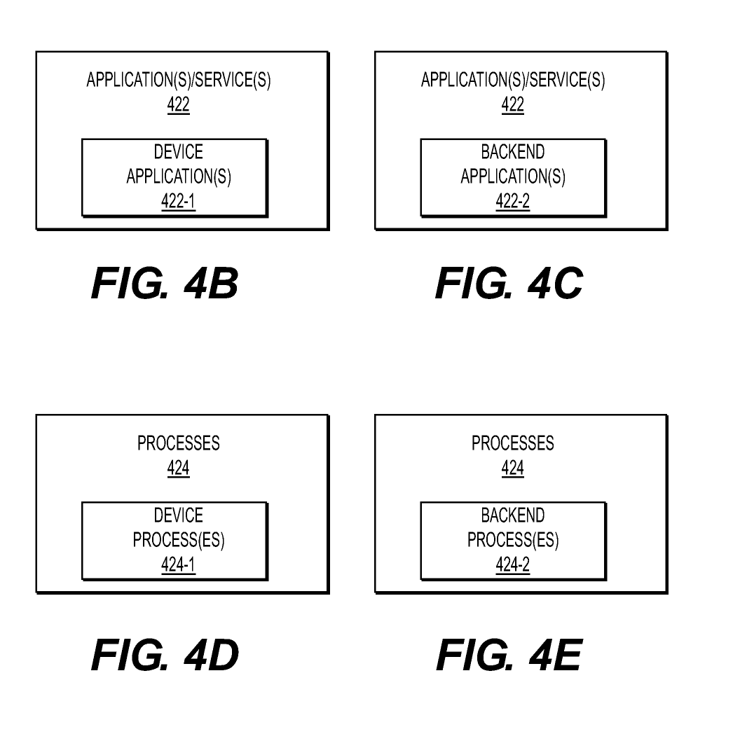

FIG. 4A is a schematic diagram of an exemplary computer system 400 upon which embodiments of the present disclosure may be implemented and carried out. The computer system 400 is discussed in greater detail below.

### Exemplary Implementation & Operation

Clients (users' devices) interact with the appraisal system 100 (FIGS. 1-2) via an appropriate interface 140 to the appraisal system backend 102. These interactions preferably take place using a user interface (UI) application 314 (FIG. 3A) running on each client.

Appraisal Scheduling

A UI preferably provides a user such as a lender with a way to request an appraisal of a real property. A user may interact with the appraisal scheduling application(s) 118 to request such an appraisal. Preferably the user is registered with the system and appropriate security measures are taken to authenticate appraisal requests. The appraisal system may then assign the appraisal to an appraiser in some manner. Preferably appraisers are registered with or known by the system. The assignment of a particular appraisal to a particular appraiser may be done in any way, and the system is not limited by the manner of such assignment or by the relationship of the appraiser to the appraisal system. It should be appreciated that the user requesting an appraisal may be any entity including, e.g., an appraisal management company, a lender, a property owner, etc. Such a user may make use of a different interface specifically designed to locate appraisers who are available and near a property needing appraisal. Thus, in some implementations appraisers may pre-register with the system and provide real-time details of their availability and location. The system or an operator thereof may then select an available appraiser to perform a particular appraisal based on that appraisers current location and availability.

Once an appraisal is ordered for a particular real property, the appraisal system 102 determines information about that particular property. As is well known, each real property has some unique way of being identified (e.g., by a street address, by map coordinates, or the like). The appraisal system 102 may use external information as well as internal information (from its own database(s) 112) to determine information about the property. The appraisal system 102 may also determine information about other properties that may be useful for the appraisal of this particular property. For example, the appraisal system may determine market indicators and other information about the type of property, the property's neighborhood, etc.

The appraisal system creates a template for the appraisal of this particular property and pre-populates the template with information about the property and with other information that may be considered relevant to the appraisal.

Appraisal

Once assigned an appraisal (in whatever manner the assignment took place), the appraiser may begin the appraisal process. The UI preferably provides an appraiser (a user) with a way to use and control aspects of an appraisal system.

As noted, the system creates and pre-populates a template for the appraisal. The appraiser is then presented with the pre-populated template and is guided through aspects of the appraisal process. In places where the system has included information (e.g., about the neighborhood or about the particular property), the appraiser is provided (via the GUI) with the ability to vary or comment on this information. The appraisal system may use the appraiser's input to modify future appraisals for the same or different properties.

Once the appraiser has completed the appraisal it is sent back to the appraisal system that may then provide it to the requesting party.

Example GUI

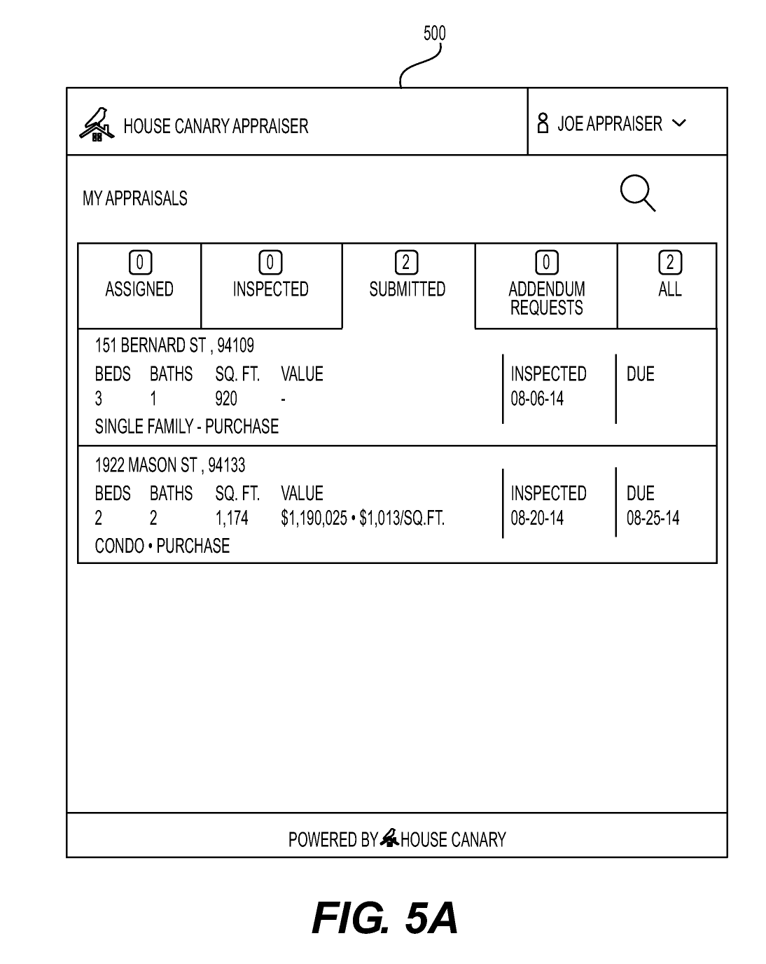

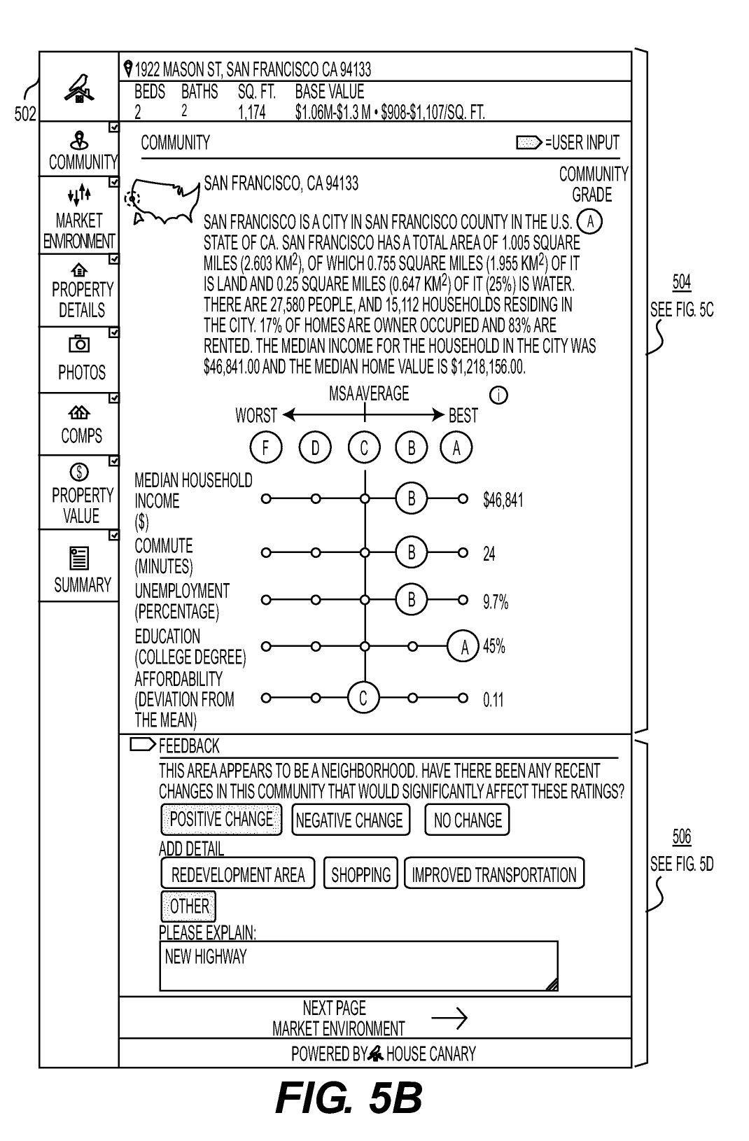

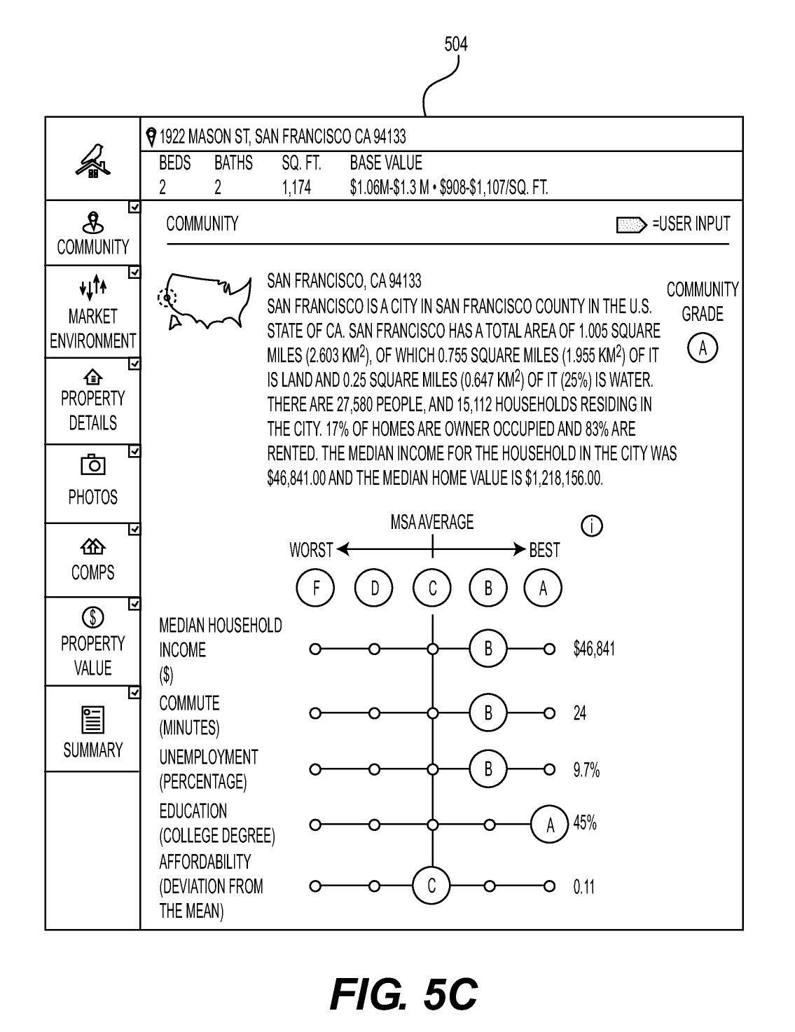

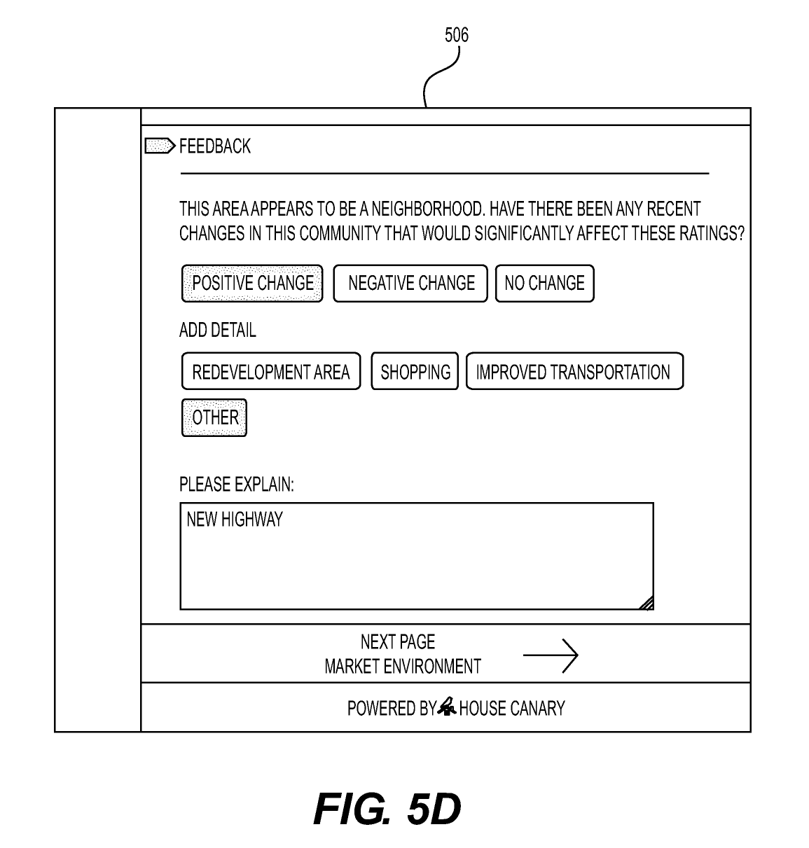

FIGS. 5A-5D, 6A-6H, 7A-7E, 8A-8H, 9A-9C, 10A-10G, 11A-11D, 12A-12G, and 13A-13B are screen shots of aspects of an exemplary graphical user interface (GUI) to an appraisal framework in accordance with embodiments hereof. It should be understood that these example screens would appear, at least in part, on the display of a user's device. In some of the examples a series of screens are shown as one continuous display, it being appreciated that a user may need to scroll on the device to see different aspects of the display. Thus, as should be appreciated, some of the example screens shown here may not fit on a single display of a device, and a user may have to move aspects of the screen into the visible display window of their device.

Dashboard

FIGS. 5A-5D are screen shots of aspects of a dashboard in a graphical user interface to an appraisal framework in accordance with embodiments hereof. This display is presented to an appraiser who is in the process of two appraisals. The dashboard shows the user the current status of each appraisal and allows the user to select and review either appraisal. Appraisals that have been submitted can preferably not be modified without having to be re-submitted.

In the example shown in FIG. 5A, one of the properties has an address “1922 Mason Street”. FIGS. 5B-5D shows aspects of the display provided by the GUI when the user selects the “1922 Mason Street” property from the display in FIG. 5A. As can be seen, the portion 504 of the display (see also FIG. 5C) shows information that the appraisal system has determined about the property and about its location and surrounding properties. This information is put into the appraisal template by the appraisal system and cannot be changed by the appraiser. However, as can been seen from the portion 506 of the display (see also FIG. 5D), the appraiser is provided with an opportunity to provide feedback to the appraisal system. The appraiser's feedback becomes part of the appraisal for this property (and may be used by the appraiser to justify his appraisal value).

The UI may provide a community rating determined by the backend 102. In a present implementation communities are rated from “A” (Most Attractive) to “F” (Least Attractive). As should be appreciated, the community a home is in typically has a major impact on the value of the appraised value now and over time. “A” rated communities are considered highly attractive given a combination of great schools, low crime rates, short commute times, and often have higher income residents with low unemployment rates. Properties in “A” rated communities typically hold their values better across time and often grow in value faster than properties in less attractive communities.

In some embodiments hereof the appraisal system may determine how communities have changed, are changing, or are expected to change over time. For example, a community may have a new road or a new shopping mall or the like. This information may be determined from external sources (e.g., external system 108 such as permit data, mapping data, public works records, or the like). Aspects of such change information may be presented to the user via the UI. It should be appreciated that these changes may affect an appraisal value (positively or adversely) and that the system preferably presents information that might affect appraisal values.

In some embodiments hereof the system may indicate whether comparable properties were appraised before or after such changes were made. For example, if a comparable value was determined before a major improvement then the comparable value may require reevaluation. The system may flag such comparables (e.g., via the UI).

In most cases the user/appraiser can move through the appraisal template in any order, and can review and revise sections of the appraisal until it is submitted. A menu (presented as icons and text on the top left side of the display) allows the user to navigate between aspects of the appraisal process.

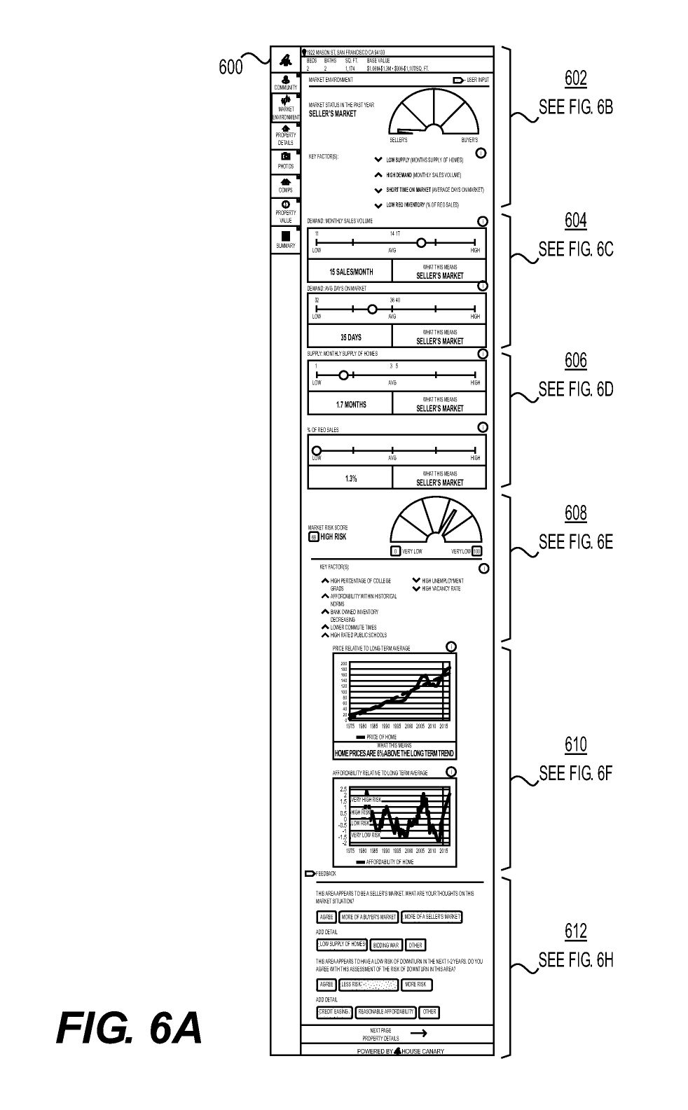

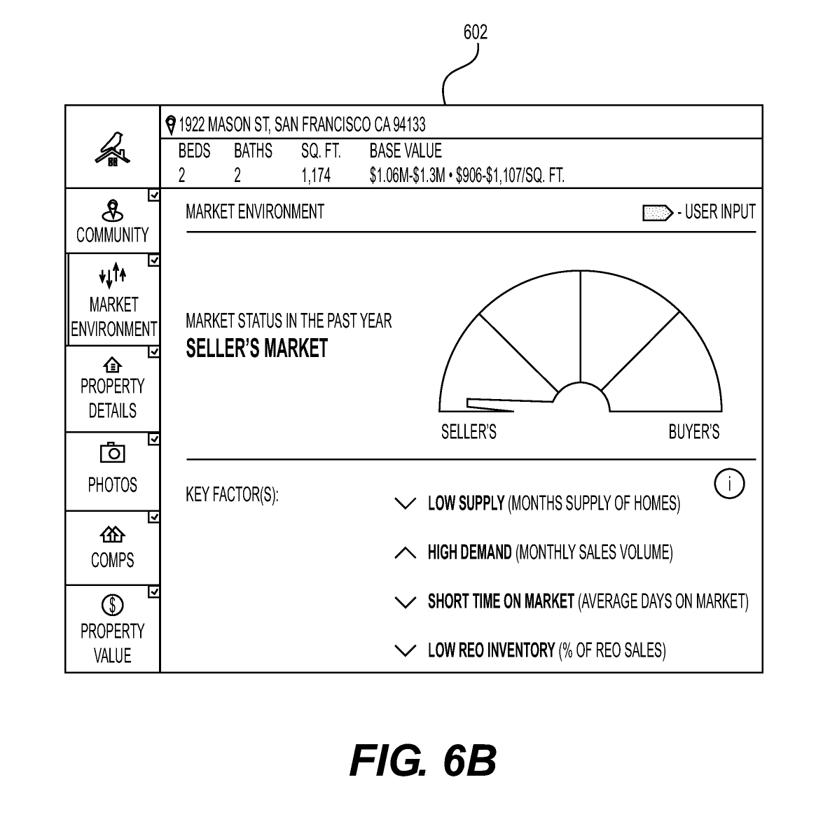

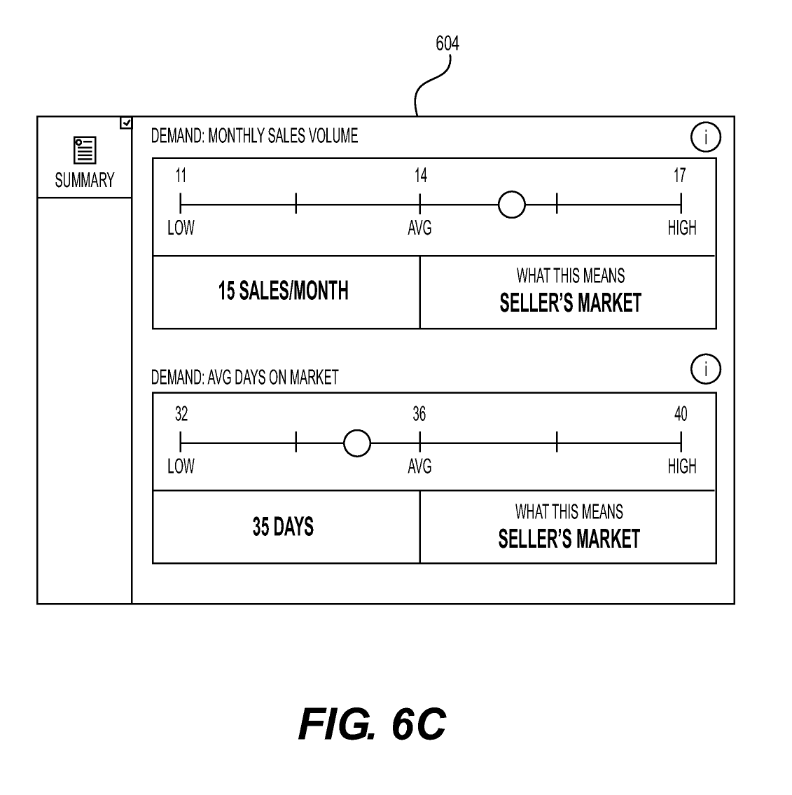

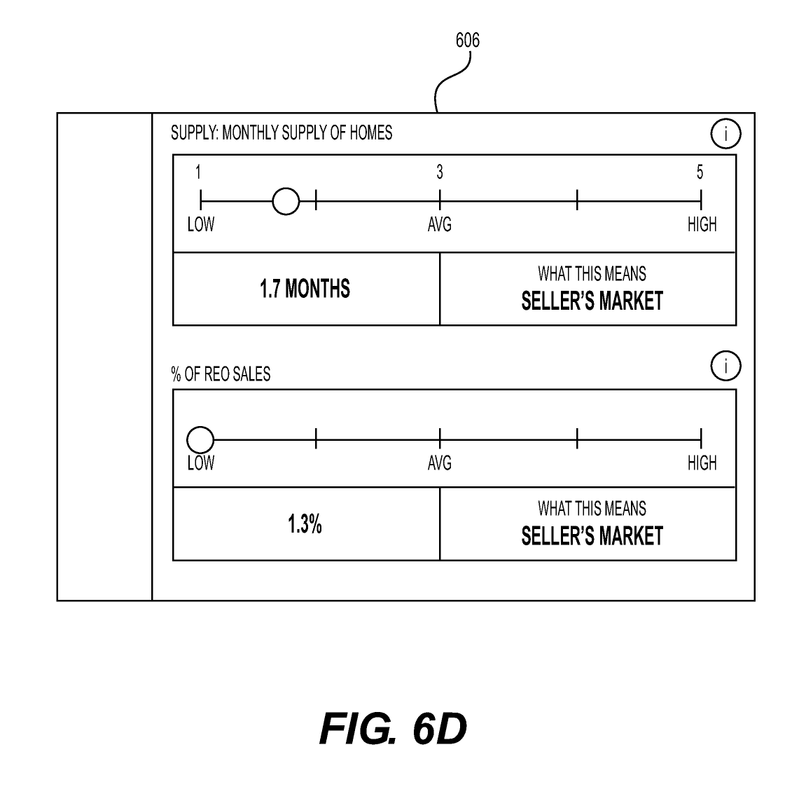

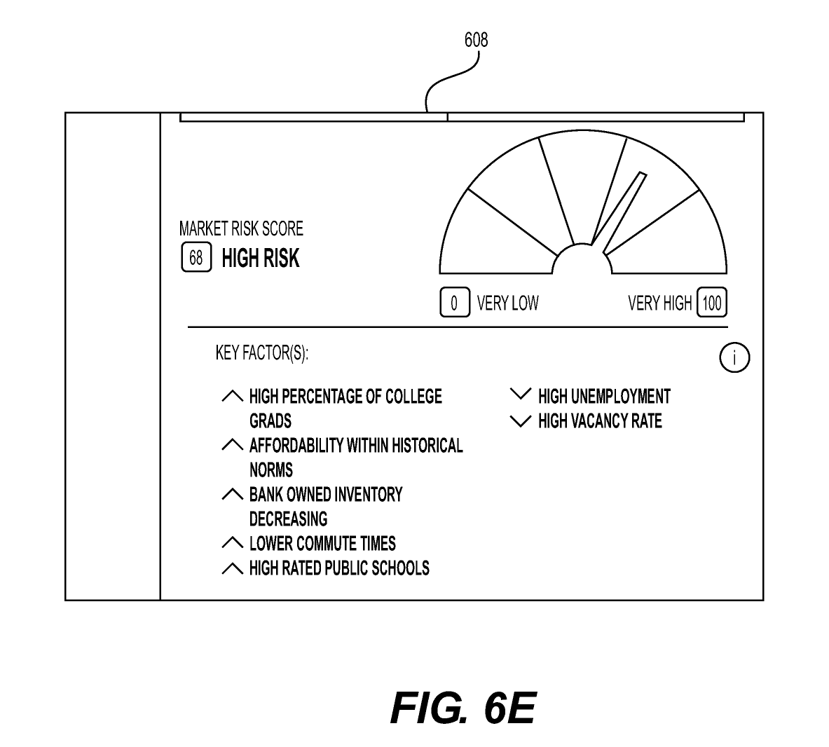

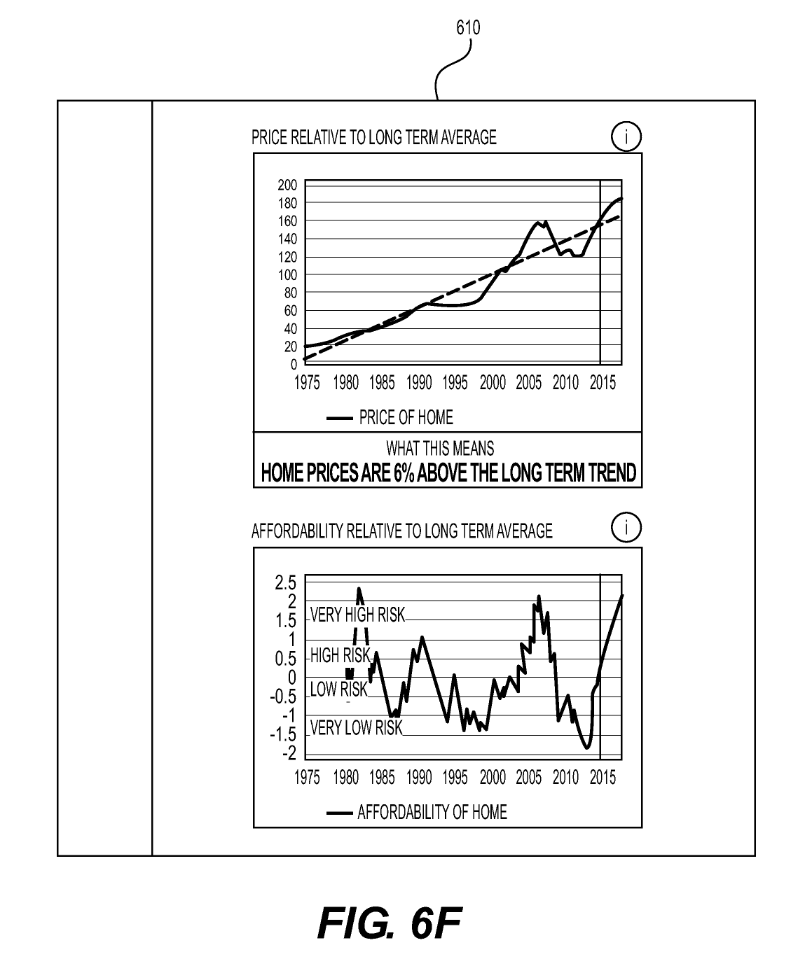

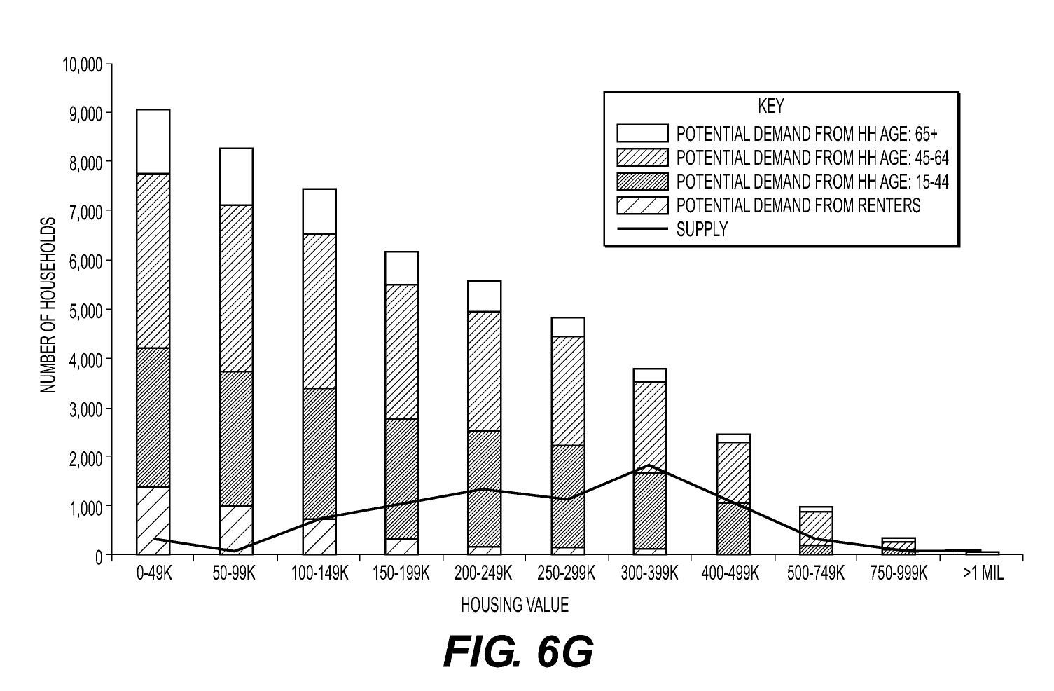

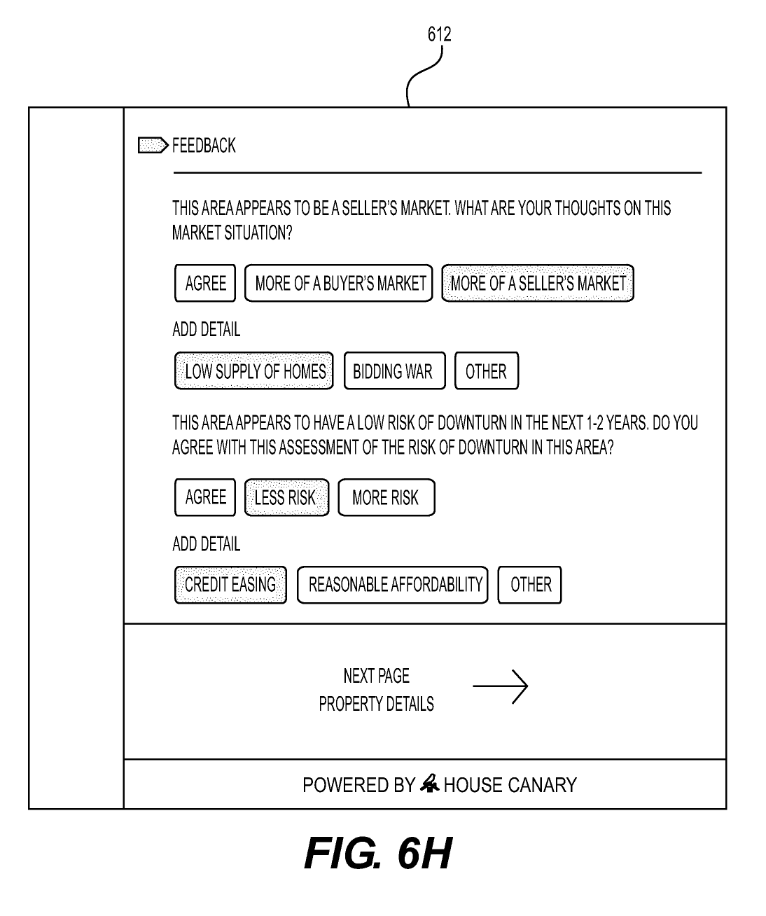

Having seen the summary provided on the dashboard in FIG. 5A, and with the option of providing feedback (in section 506), the appraiser may select the next page (“Market Environment”) of the appraisal. Selection of the “Market Environment” region of the display in FIG. 5A causes the GUI to display the Market Environment screen 600 (FIGS. 6A-6H).

Market Environment

The Market Environment screen 600 (FIGS. 6A-6H) provides pre-populated information screens to the appraiser about the market environment for this particular property. Much of the information on these screens is determined by the appraisal system 100 and cannot be modified by the appraiser. However, once again, the appraiser is able to provide feedback to the appraisal system (in section 612, see also FIG. 6G).

The UI may present an indication (e.g., a gauge) of whether the market is considered to be a buyer's market or a seller's market (see 602 FIG. 6B). The gauge may be determined by the backend 102 based on information from other sources (external system 108). In a present implementation the system may use a multi-factor model to calculate whether it is a buyer or seller's market. In a present implementation a seller's market occurs when there are strong demand (including above average sales volume, below average days on market) and low supply (including low months supply of homes available for sale, low shadow inventory). Buyer's markets occur when the opposite is true. A seller (buyer) market highlights high (low) demand in the market that drives prices up (down).

In the market environment display 602 the UI may provide a list of factors that influenced the system's determination.

In some implementations the UI may provide information (determined, e.g., by the backend 102) relating to monthly sales volume: e.g., the total number of new homes and resales sold in a month. Higher (lower) than seasonal average monthly sales volume highlight strong (weak) demand in the market which will drive prices up (down) (604 FIG. 6C).

In some implementations the UI may provide information (determined, e.g., by the backend 102) relating to the average days on market: the number of days from listing to sale. Lower (higher) than average days on market highlight strong (weak) demand in the market which will drive prices up (down) (604 FIG. 6C).

In some implementations the UI may provide information (determined by the backend 102) relating to months supply of homes: listings available for sale divided by current sales volume. Lower (higher) than average months supply highlights strong (weak) demand in the market that will drive prices up (down) (604 FIG. 6C).

In some implementations the UI may provide a percentage of real estate owned (REO) sales (606 FIG. 6D). Real estate owned refers to a class of property owned by a lender—typically a bank, government agency, or government loan insurer—after an unsuccessful sale at a foreclosure auction. The UI may provide an indication of combined short sales and foreclosure sales as a percent of total sales. A lower (higher) than average percentage of REO sales highlights lower (higher) shadow inventory in the market that will drive prices up (down).

In some implementations the UI may provide an indication of market risk (e.g., as a score) (608 FIG. 6E). The score may be determined by the backend 102 and provided to the user's device. The risk score highlights the potential likelihood of a downturn. When the risk of downturn is low (medium to high), the appraiser should consider this in appraising the value of the home and how the values from prior comparative sales are factored in.

In some exemplary embodiments hereof the risk score is a metric that measures the probability that house prices, in the local area (e.g., in the local zip code), will be lower than their current value twelve months in the future. The Housing Risk Score may be measured on a 0 to 100 scale where a higher score implies greater likelihood that prices will decline in the future. The actual risk score in a particular implementation may be interpreted, e.g., as follows:

| Risk Score | Interpretation | Risk |
|---|---|---|
| 0-20 | It is highly likely that prices will | Very low |
| | increase in the future | |
| 21-50 | It is more likely that house prices | low |
| | will increase in the future | |
| 51-80 | It is more likely that house prices | high |
| | will decline in the future | |
| 81-100 | It is highly likely house prices will | Very high |
| | decline in the future | |

It should be appreciated that the Housing Risk Score may be measured using a different scale, and the meaning and ranges of risk scores may vary. Different scales and ranges are contemplated herein.

In some embodiments, e.g., as shown in 608 FIGS. 6A and 6E, the risk score may be categorized using colors or the like on the UI to indicate degrees of risk. It should be appreciated that any colors may be used to depict the risk on the UI and that different and/or other ranges may be used to categorize the risk.

The risk score highlights the potential likelihood of a downturn and, as such, provides useful information to an appraiser. When the risk of downturn is low (medium to high), the appraiser should consider this in appraising the value of the home and how the values from prior comparative sales are factored in.

In some implementations the UI may provide an indication of price relative to long term average (e.g., as a line graph) (610 FIG. 6F). A current home price index comparison to historical long-term trend is considered a critical indicator. The greater the price's distance from long term trend line, the greater the likelihood for a snapback or reversion to the long-term average. The graph in FIG. 6G shows an exemplary way to highlight the risk of a property by understanding the potential demand for that property versus the supply of available properties in the market.

In some implementations the UI may provide an indication of affordability relative to long term average (e.g., as a line graph) (610 FIG. 6F). Home prices, mortgage rates and household income are important factors in determining the affordability of a home. When affordability is below (above) long-term average, this often reduces (raises) the risk of downturn. As mortgage rates increase, homebuyers' payments will become a larger part of household income and put downward pressure on home prices.

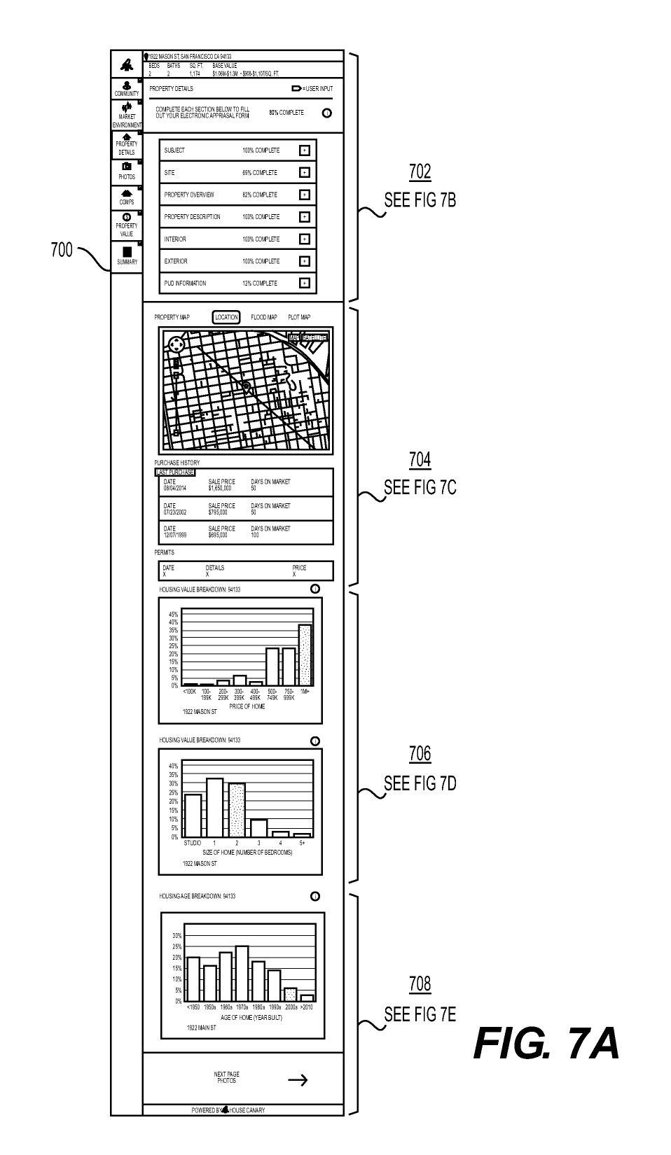

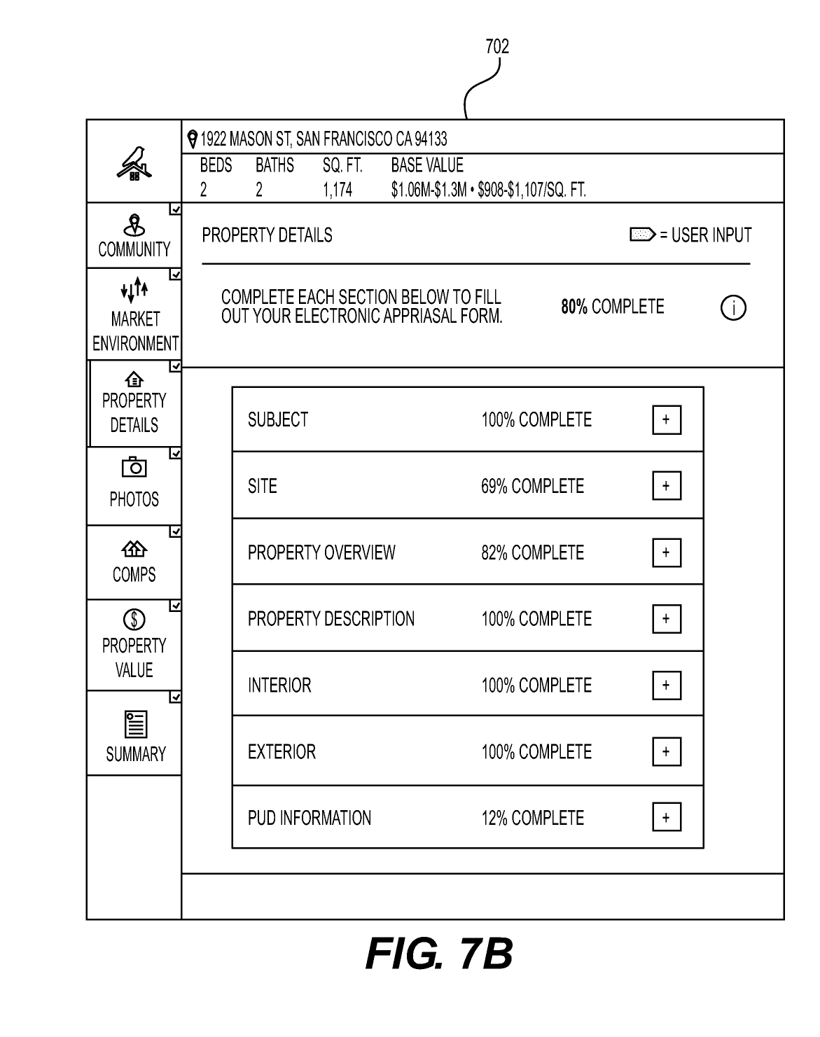

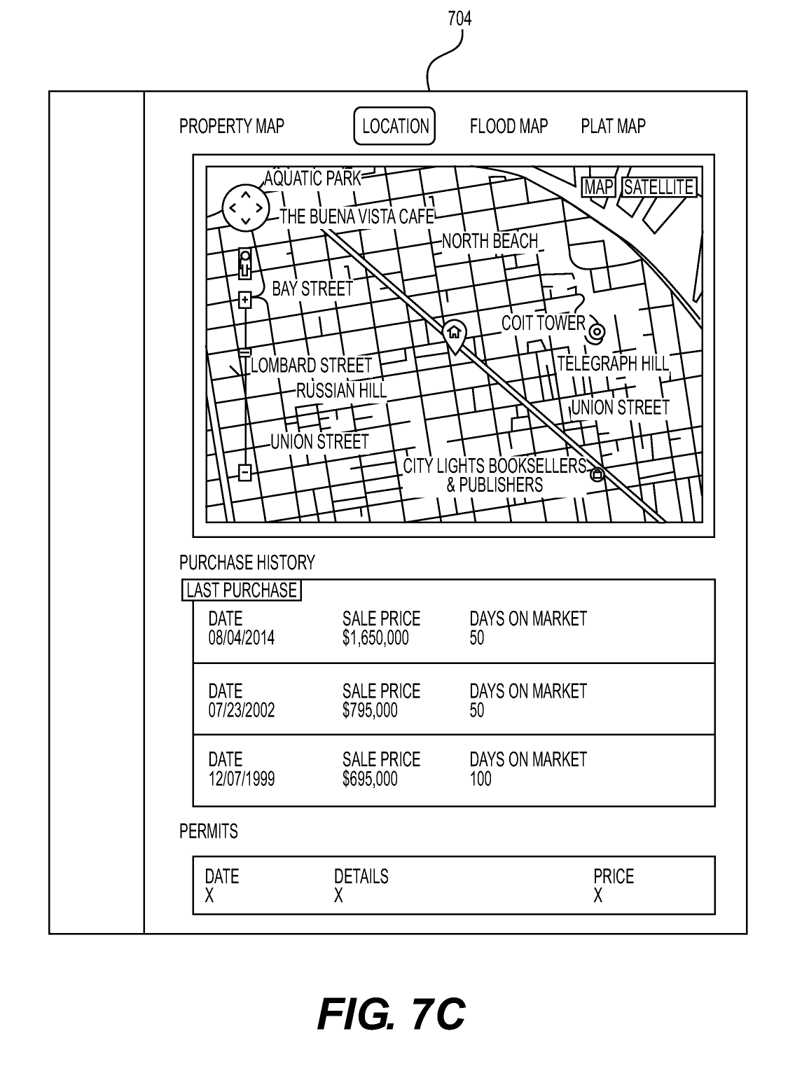

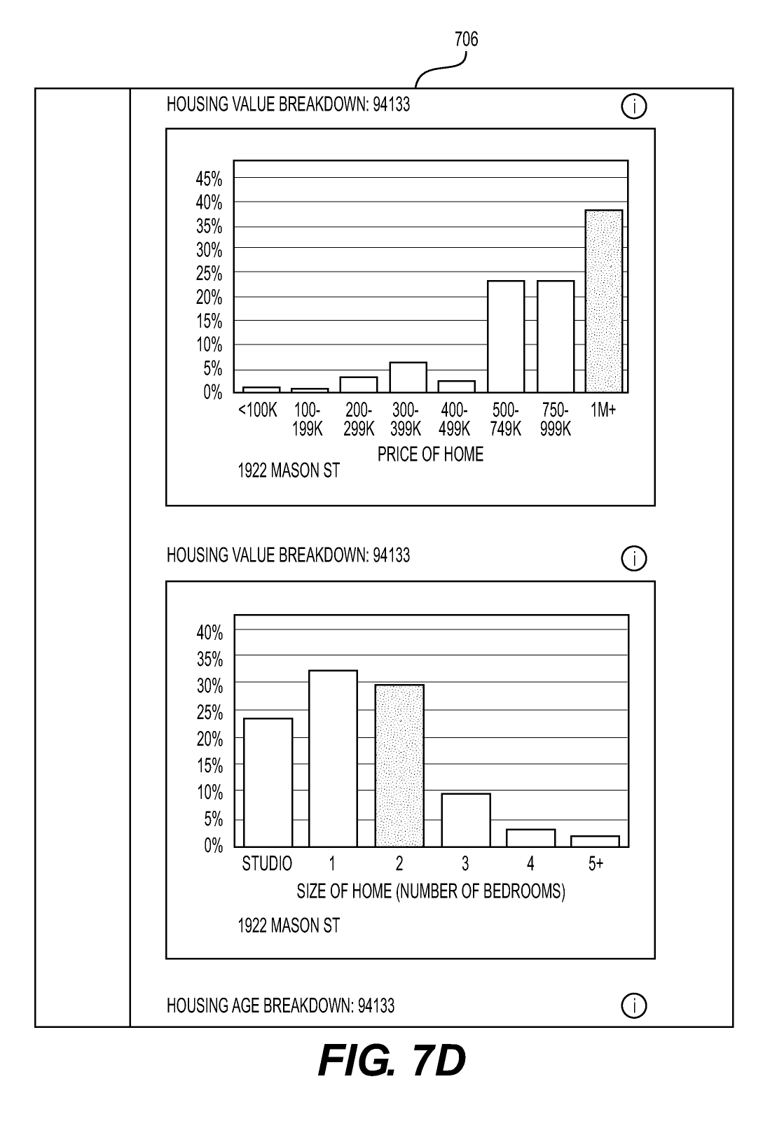

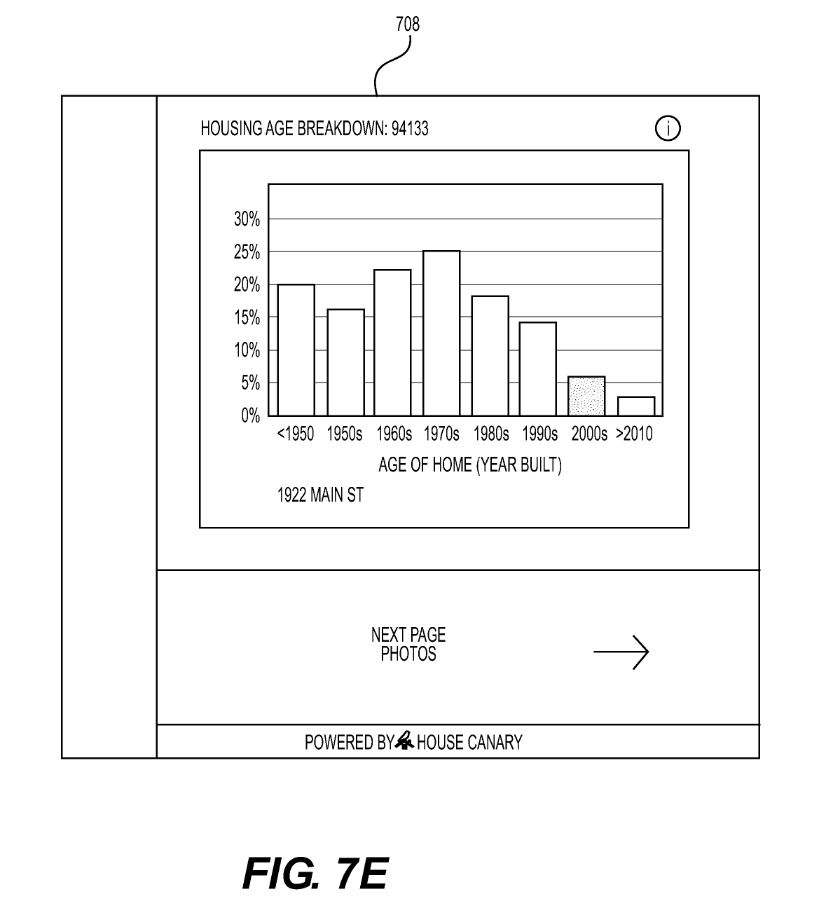

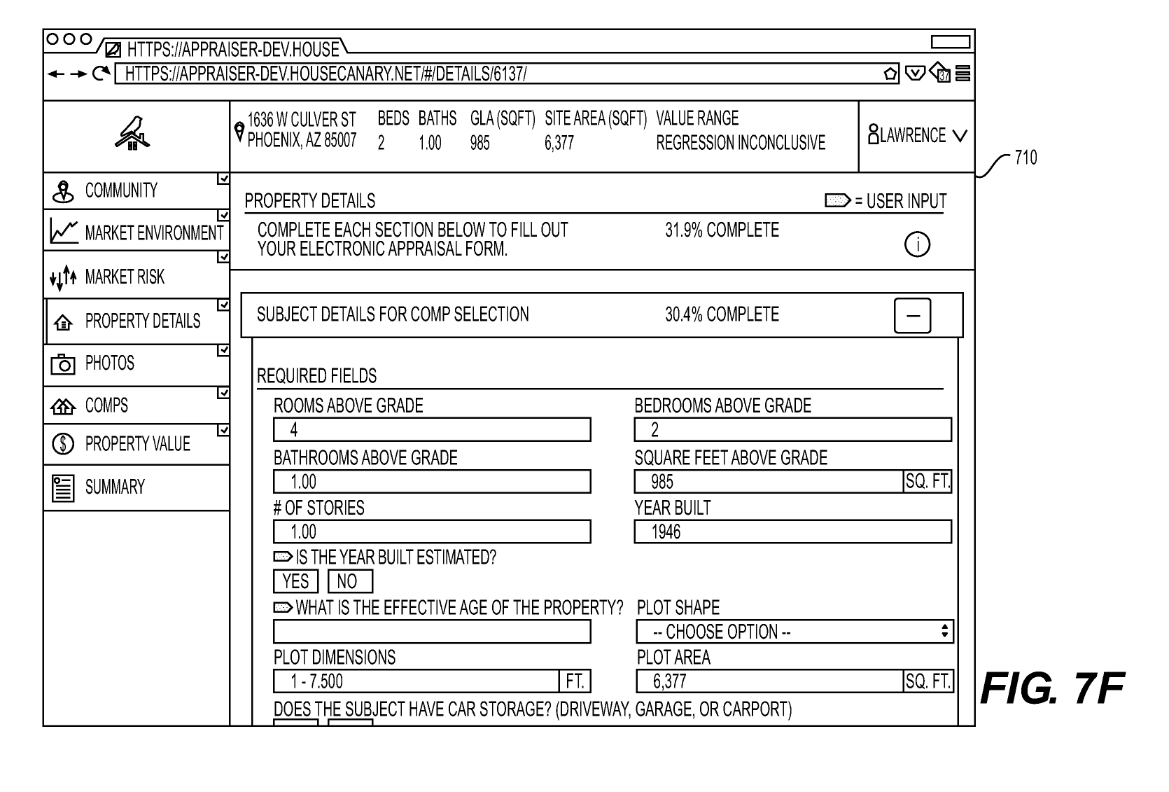

Having seen the Market Environment screen 600 and with the option of providing feedback (in section 612), the appraiser may select the next page (“Property Details”) of the appraisal. Selection of the “Property Details” region of the display in FIG. 6A causes the GUI to display the Property Details screen 700 (FIGS. 7A-7E).

Property Details

The Property Details screen 700 (FIGS. 7A-7E) according to exemplary embodiments hereof includes details about the particular property for which the appraisal is being performed. A first section 702 of the Property Details screen 700 (FIG. 7B) provides a UI whereby the appraiser can input details about the particular property. As shown in FIG. 7B, this first section 702 may include regions which, when selected by the user, allow the user to input information (including text and photographs) about the property. In a present exemplary implementation, this first section 702 includes regions supporting user input about the Subject, the Site, the Property Overview, the Property Description, the Interior, the Exterior, and so-called PUD (Planned Unit Development) information. Each of these regions preferably also provides a summary of whether or not it is complete. For example, in the section 702 shown in FIG. 7B, the Property Overview is shown as only 82% complete. As should be appreciated, this overview/summary provides the appraiser with useful information about what is still required to complete the appraisal.

In some implementations the UI may provide information relating to the housing value breakdown (706, FIG. 7D). This information may be determined by the backend 102 and presented as a percent of homes that are valued in each price segment in the local area (e.g., highlighted bar displays the appraised home). Properties that are significantly higher (lower) than average may be in lower (higher) demand than the average property in the area.

In some implementations the UI may provide information relating to housing size breakdown (percent of homes that are in each size segment in the local area (e.g., highlighted bar displays the appraised home)) (706, FIG. 7D).

In some implementations the UI may provide information relating to housing age breakdown (percent of homes that are in each age segment in the local area (highlighted bar displays the appraised home)). Properties that are newer (older) than average may command higher (lower) price than the average property in the area (708, FIG. 7E).

In some exemplary embodiments hereof, the property screen may provide additional details about the value of the property. For example, as shown in the screen 710 (FIG. 7F), the property details are only 31.9% complete and the “value range” for the property is shown as “Regression inconclusive.” As described in greater detail below, the system 102 may provide (or suggest) comparable properties, and present the appraiser with regression analysis details, and the value may be adjusted (by the appraiser and/or automatically) based on the comps and the regression analysis.

With further reference to FIG. 7F, in operation, an appraiser may add/edit details for comparable property selection, based, e.g., on the subject property's details.

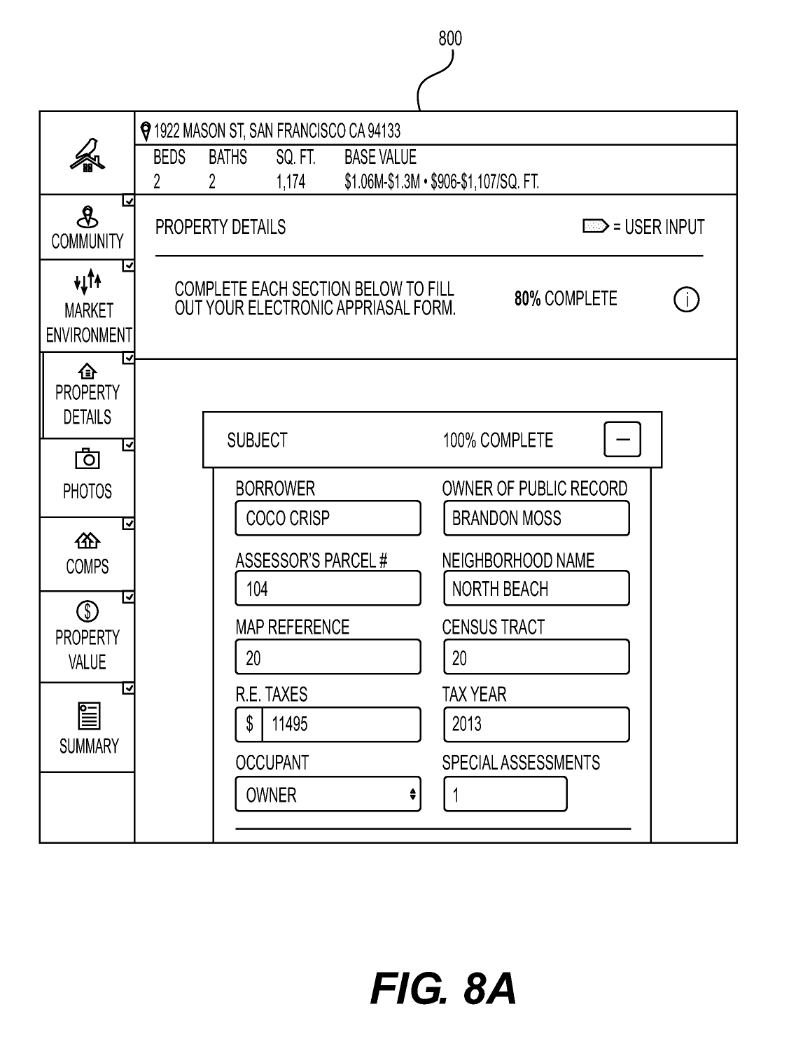

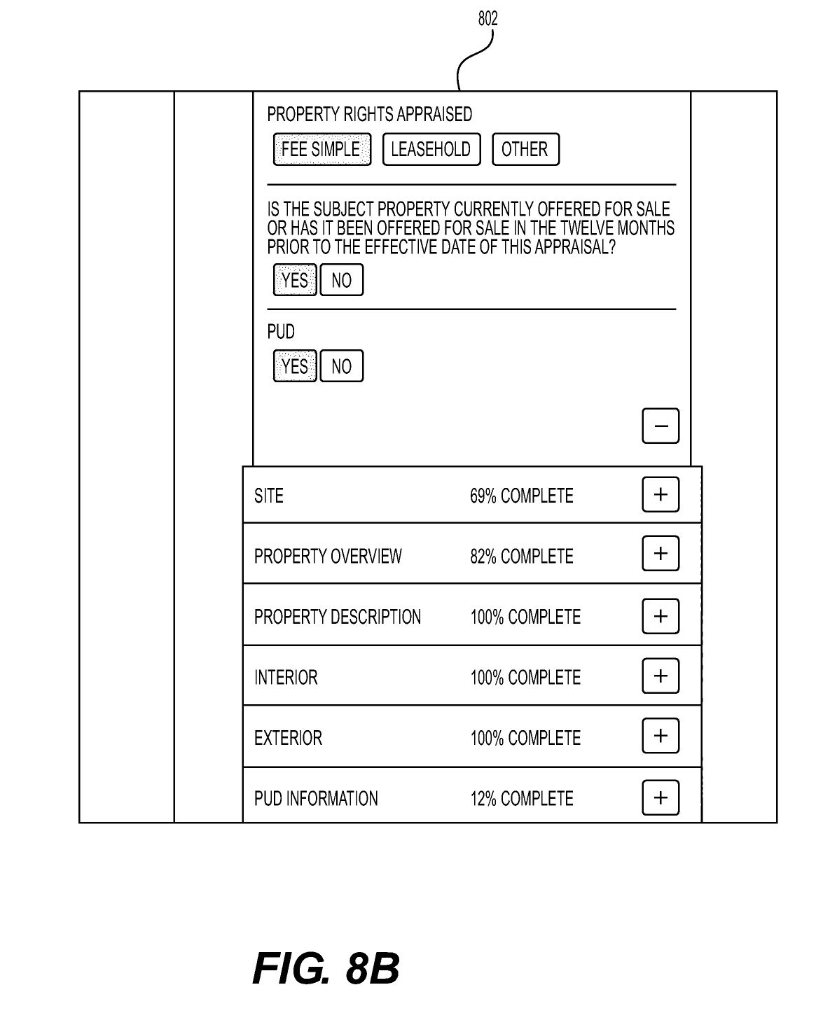

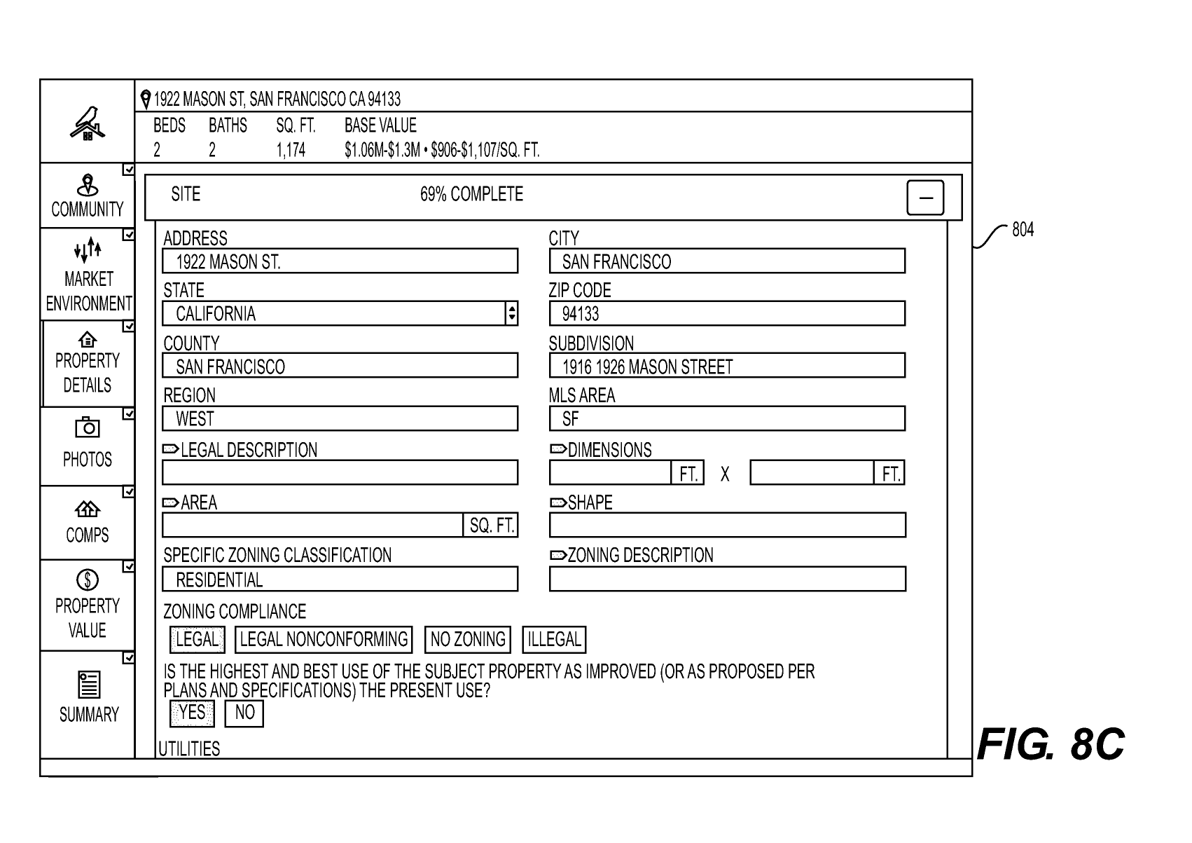

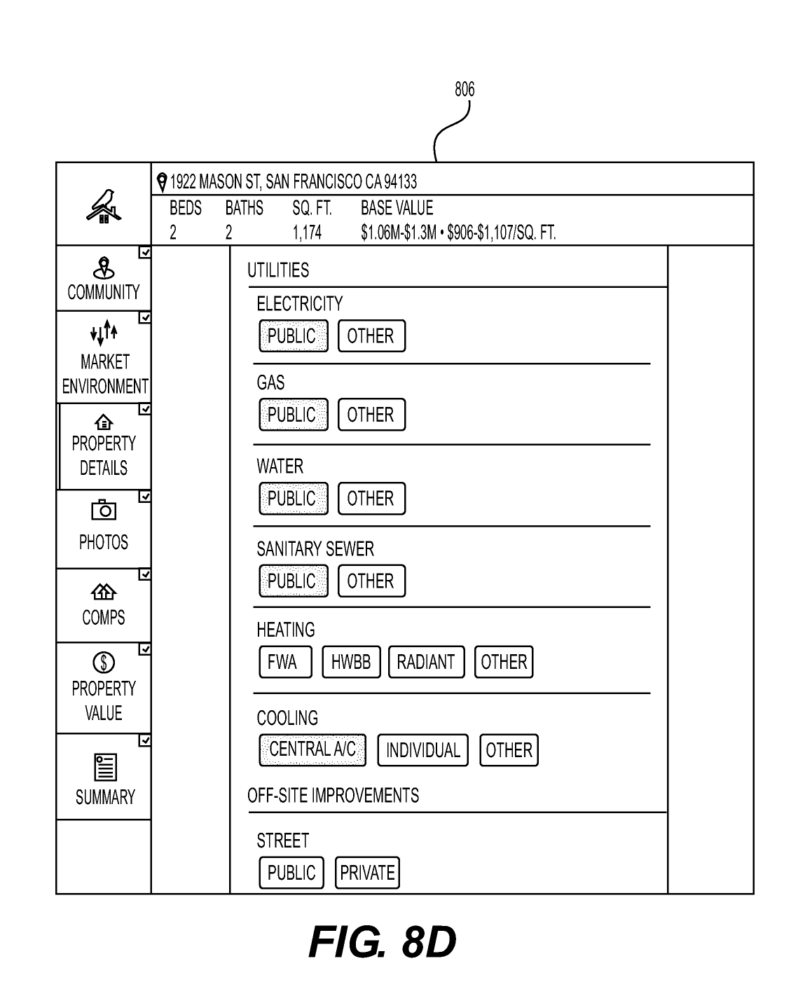

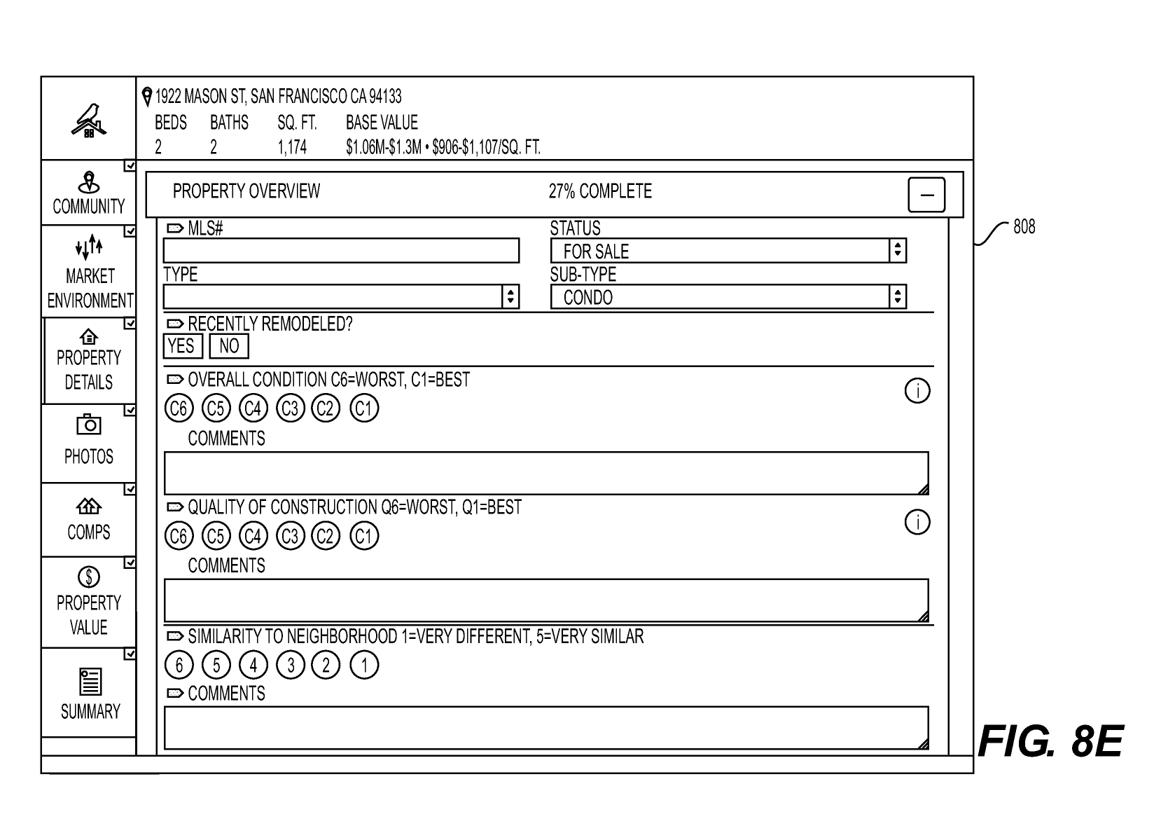

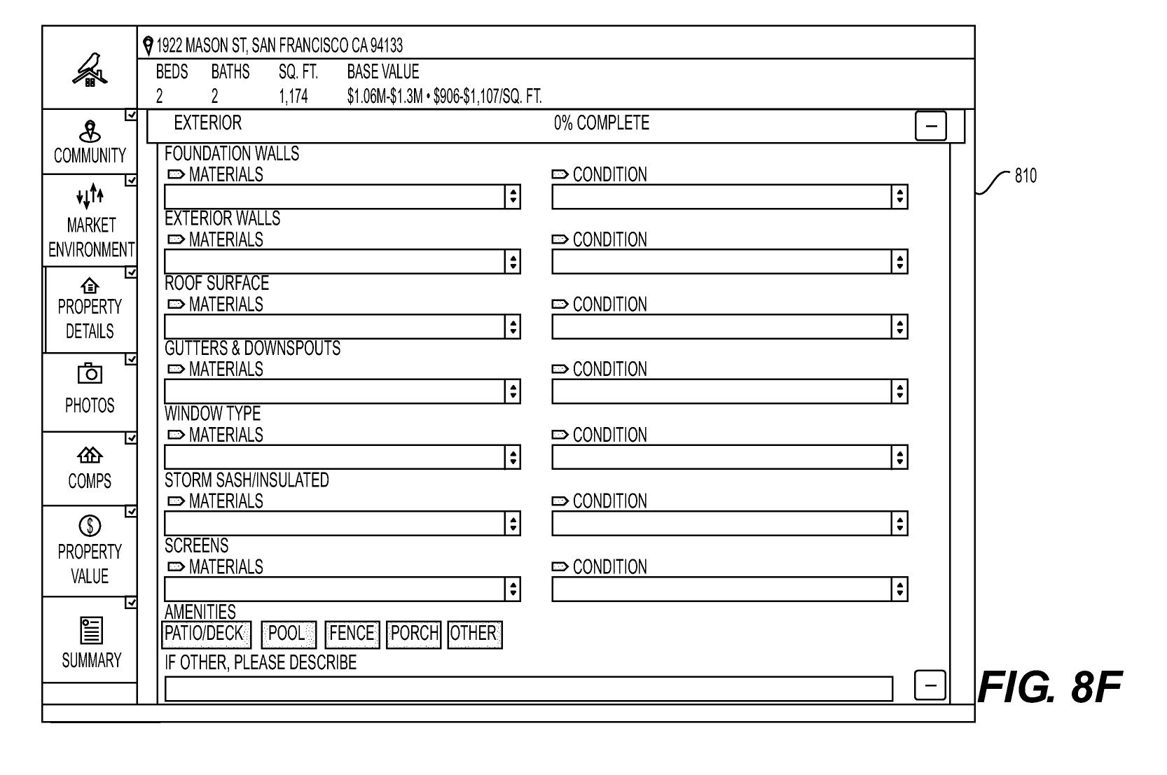

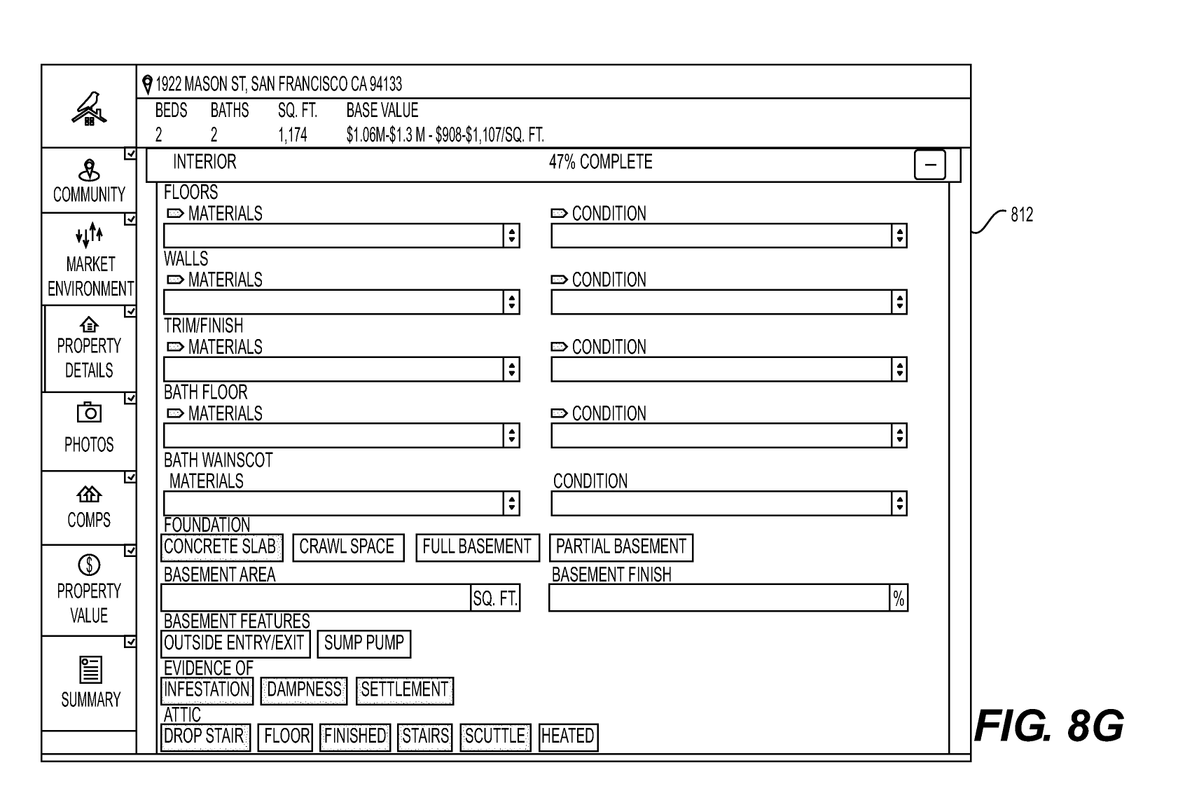

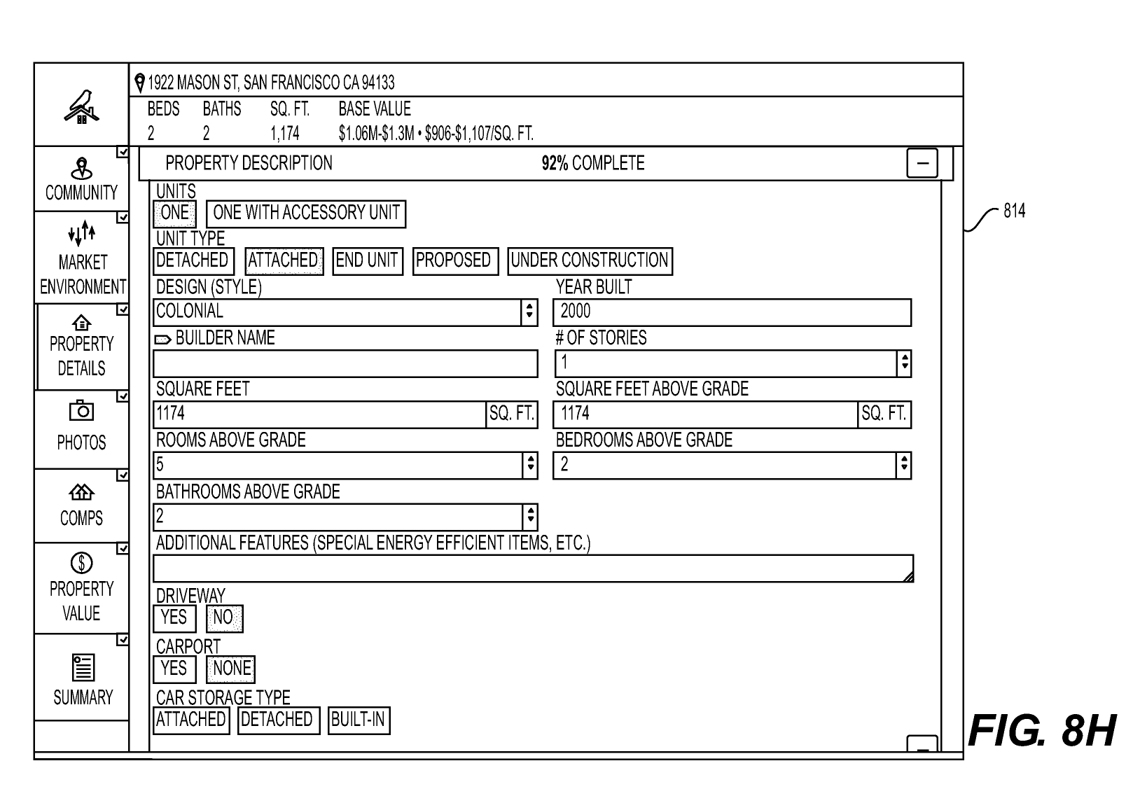

FIGS. 8A-8H are example screens of the UI when various of the property details sections of the Property Details screen 700 are selected. For example, the screens 800 and 802 (FIGS. 8A-8B) are examples of the screen shown on the UI when the user selects “Subject” from the Property Details screen 700. The Subject information may be pre-populated by the system, but some of the data may changed by the appraiser.

The screen 804 shown in FIG. 8C is an example of a screen shown on the UI when the user selects the “Site” option from the Property Details screen 700. The user may modify and/or insert details about the Site from this screen 804.

The screen 806 shown in FIG. 8D is an example of a screen shown on the UI when the user selects the “Utilities” option from the Property Details screen 700. The user may modify and/or insert details about the utilities from this screen 806.

The screen 808 shown in FIG. 8E is an example of a screen shown on the UI when the user selects the “Property Overview” option from the Property Details screen 700. The user may modify and/or insert details about the property details from this screen 808.

The screen 810 shown in FIG. 8F is an example of a screen shown on the UI when the user selects the “Exterior” option from the Property Details screen 700. The user may modify and/or insert details about the exterior of the property from this screen 810.

The screen 812 shown in FIG. 8G is an example of a screen shown on the UI when the user selects the “Interior” option from the Property Details screen 700. The user may modify and/or insert details about the interior of the property from this screen 812.

The screen 814 shown in FIG. 8H is an example of a screen shown on the UI when the user selects the “Property Description” option from the Property Details screen 700. The user may modify and/or insert details about the interior of the property from this screen 814.

The Property Details screen 700 may also show the following:
a property map (in 704, FIGS. 7A and 7C) and a purchase history of the property along with details of any permits;
housing value and housing size details (in 706, FIGS. 7A and 7D) and a purchase history of the property along with details of any permits; and
housing age details (in 708, FIGS. 7A and 7E).

The user may navigate off the Property Details screen 700 using the “Next Page—Photos” region on the page.

Photos

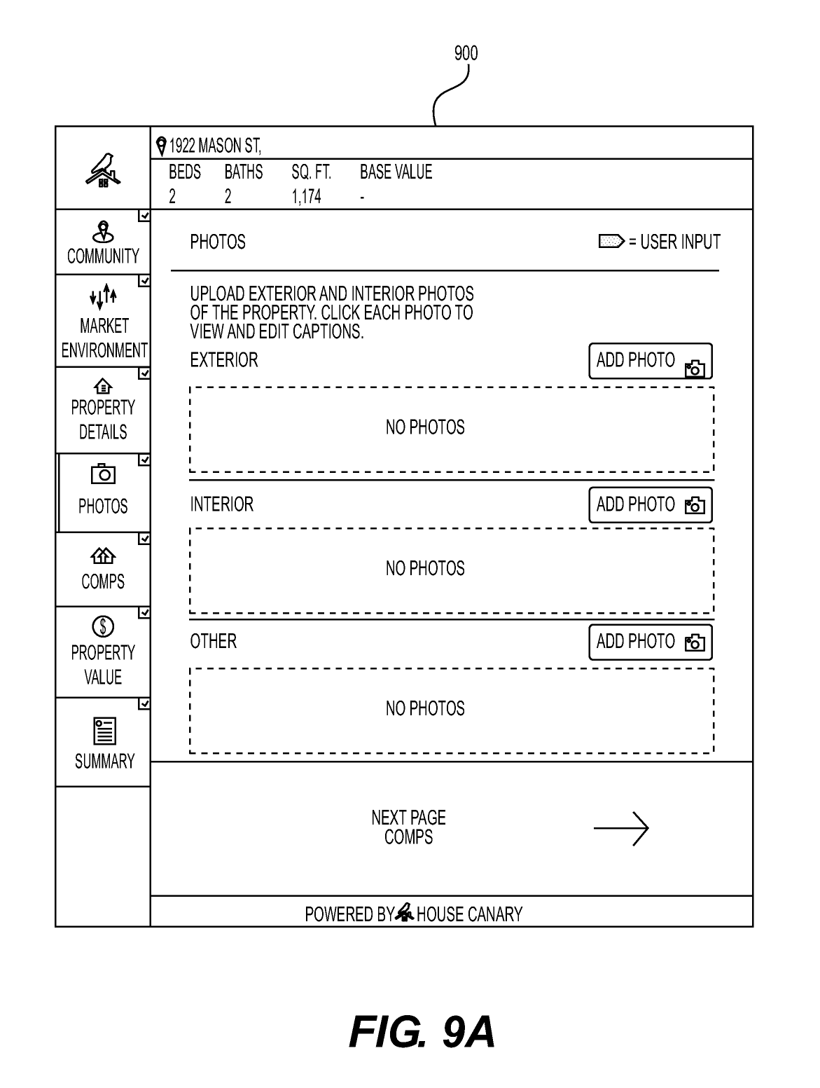

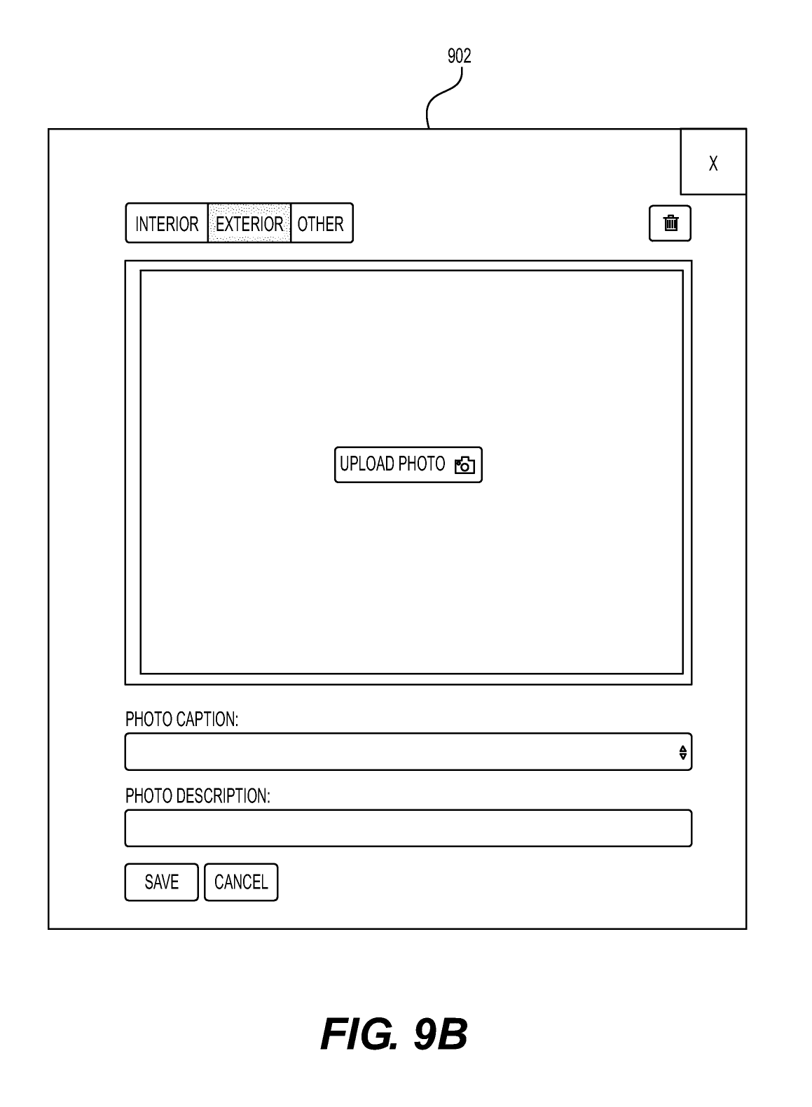

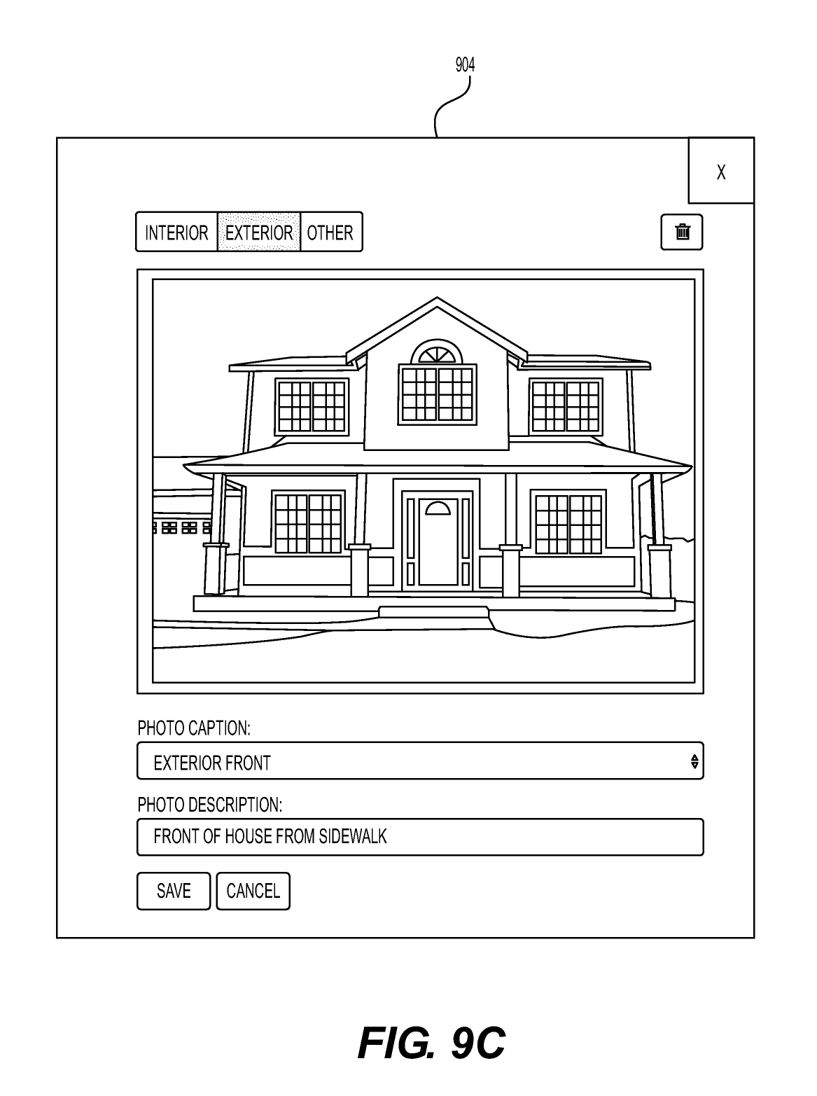

FIGS. 9A-9C show screens 900, 902, 904 presented on the UI that allow the user to add photographs to the appraisal. The user may use any camera, including a camera on the device running the UI. In some implementations the UI may include information generated by the device (e.g., GPS-generated location information) that may be used to authenticate pictures taken by the user.

Comparables

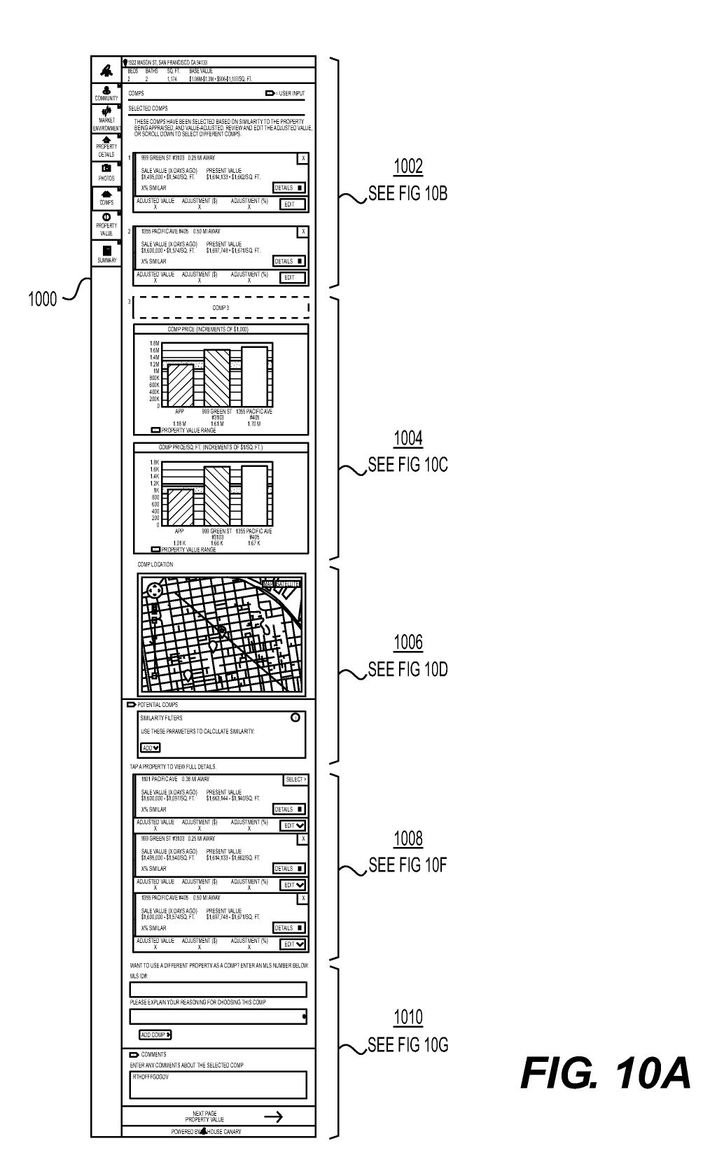

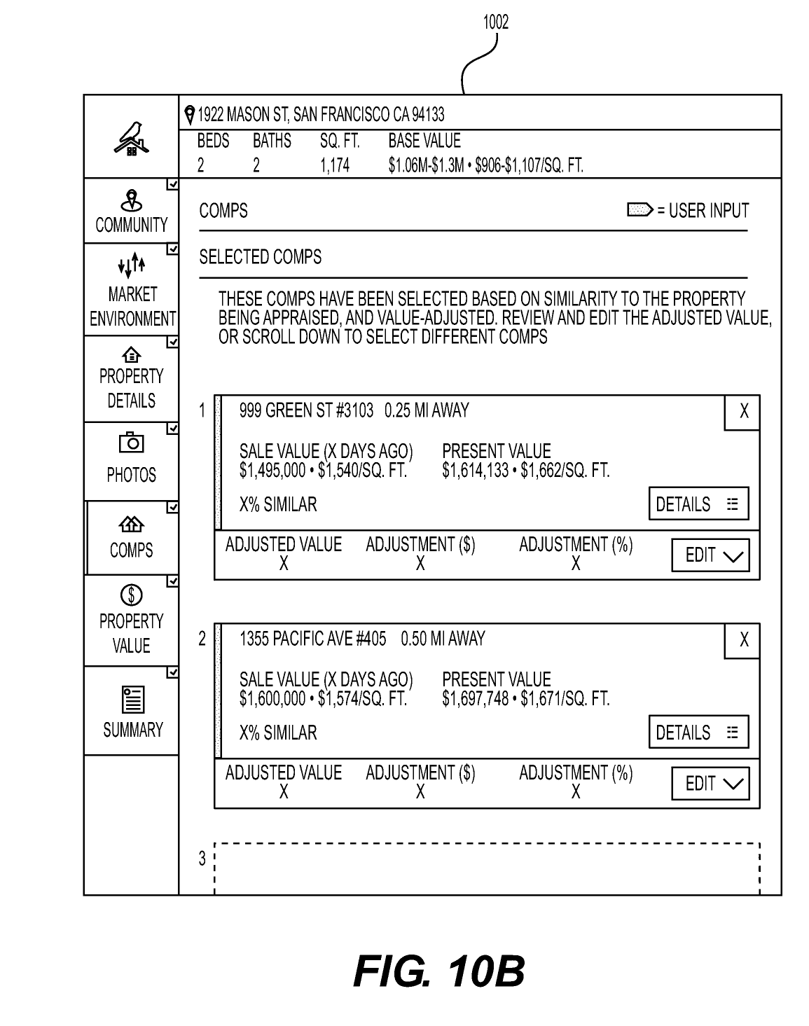

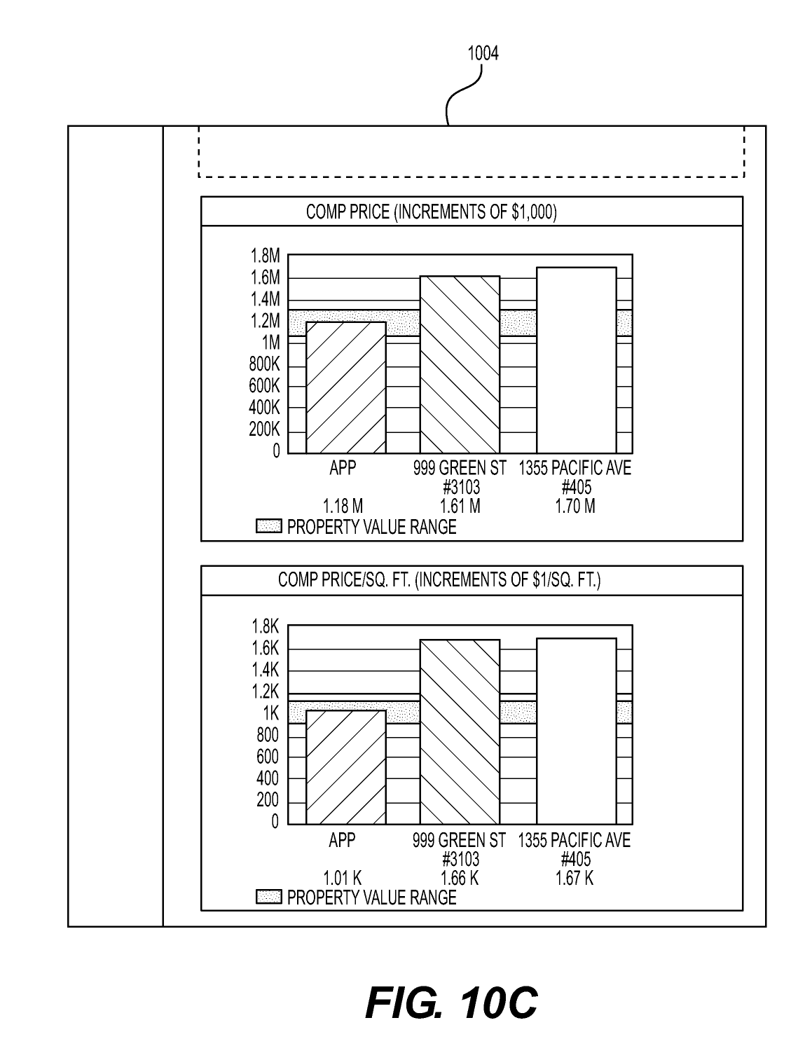

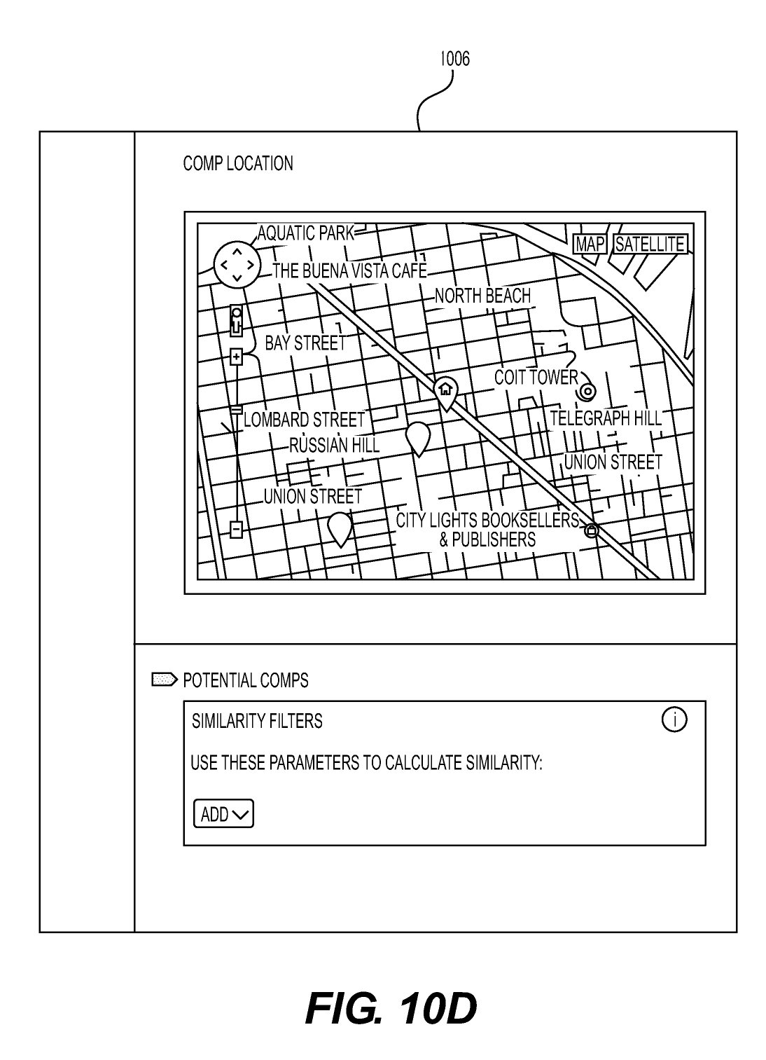

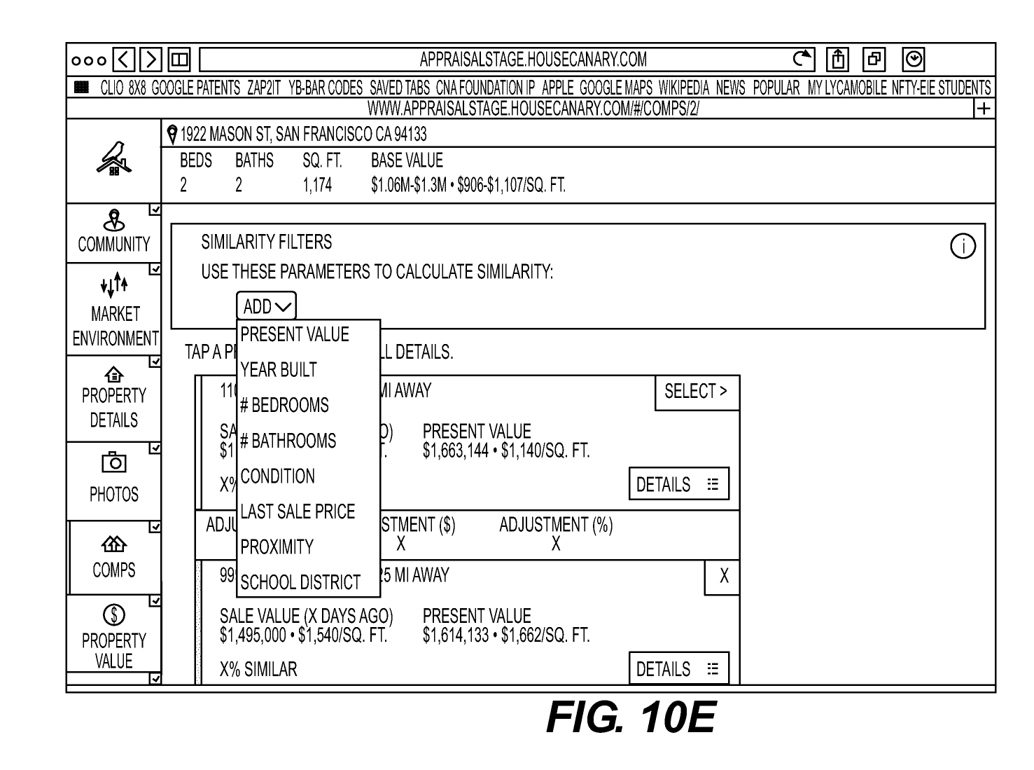

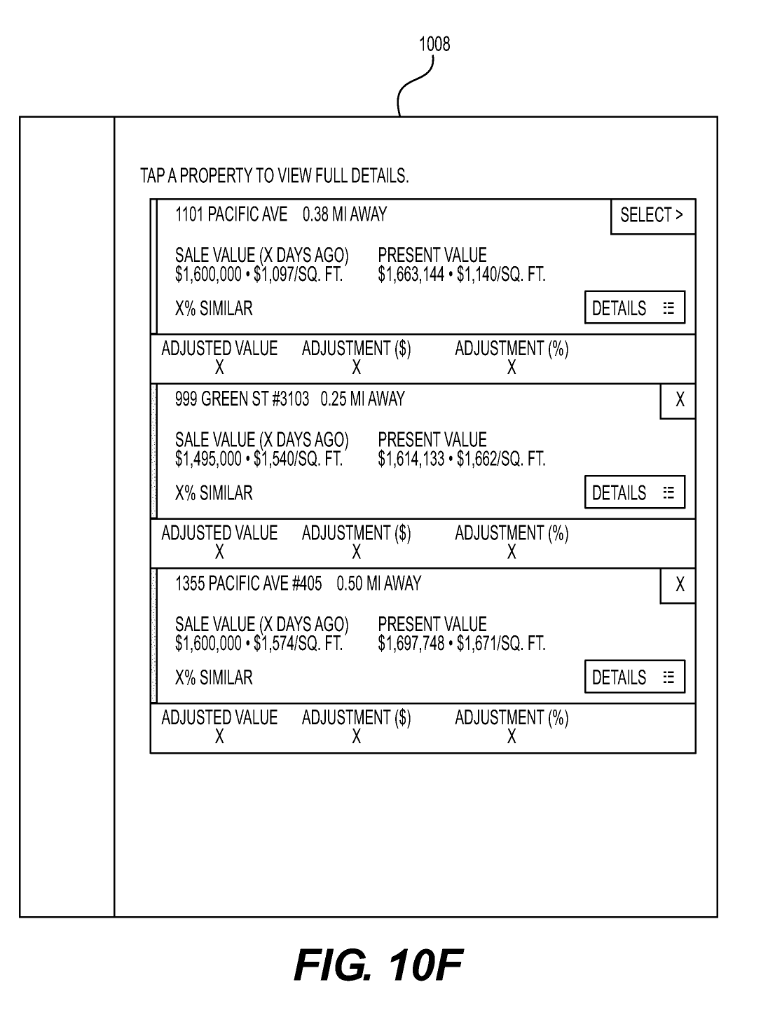

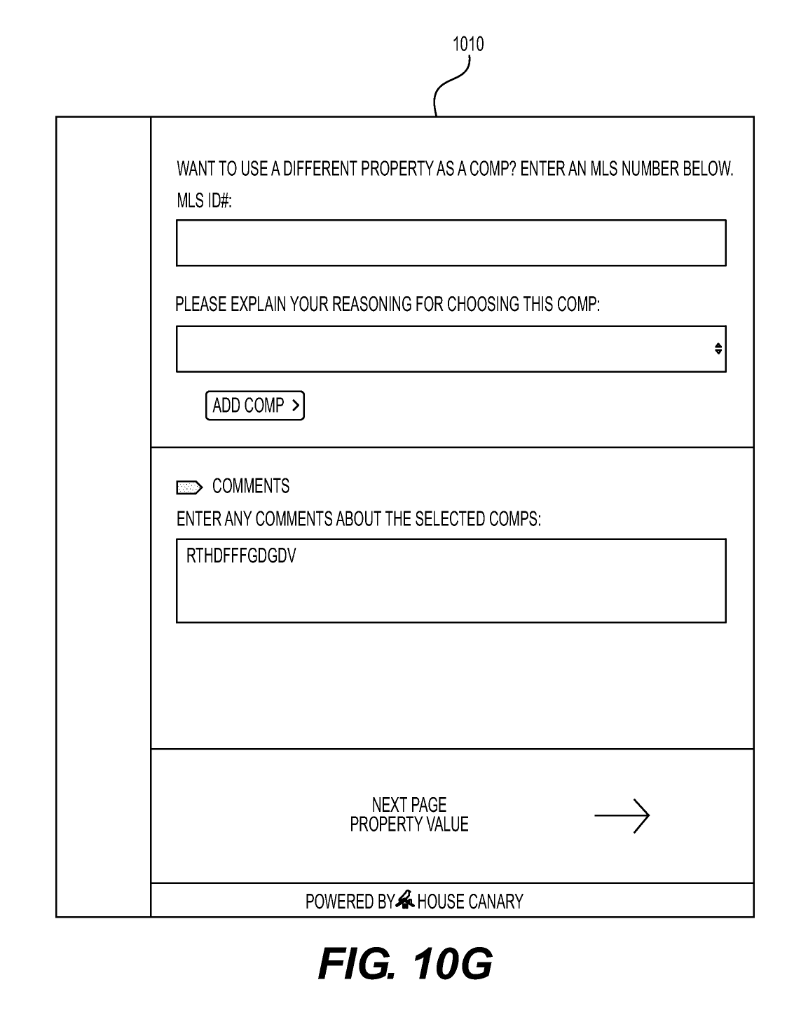

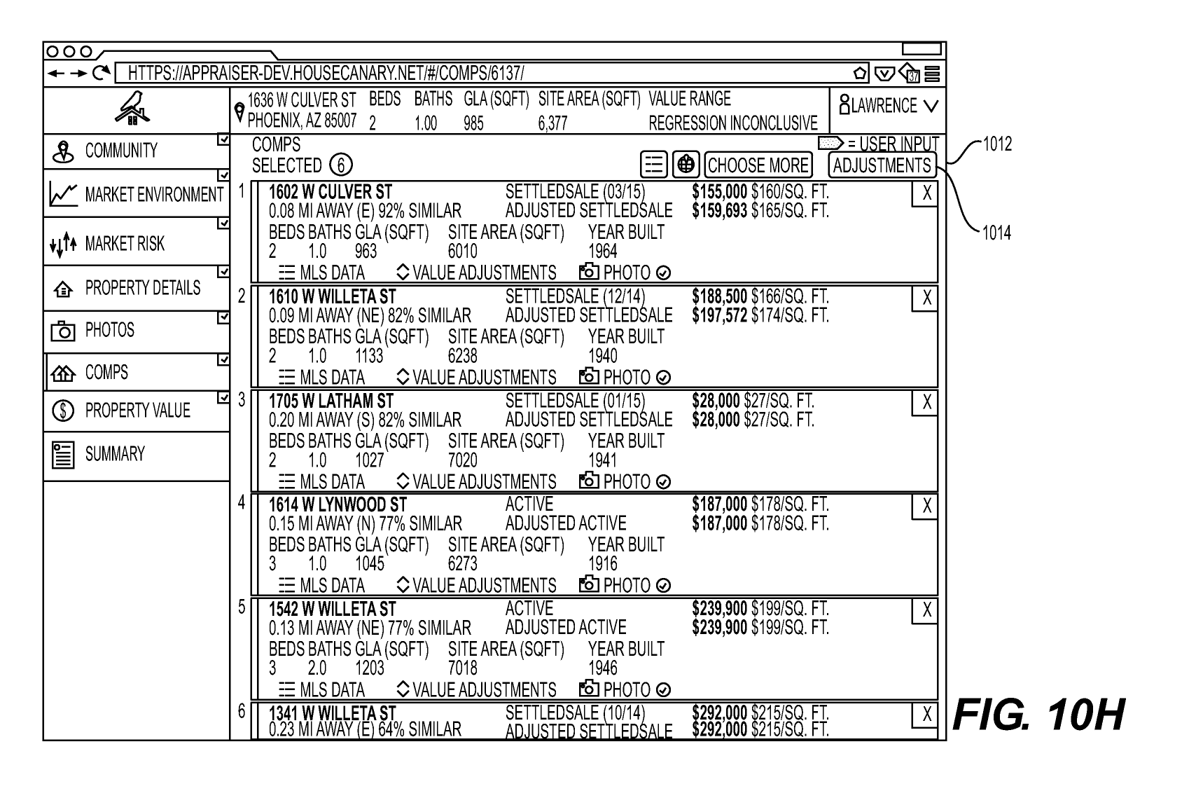

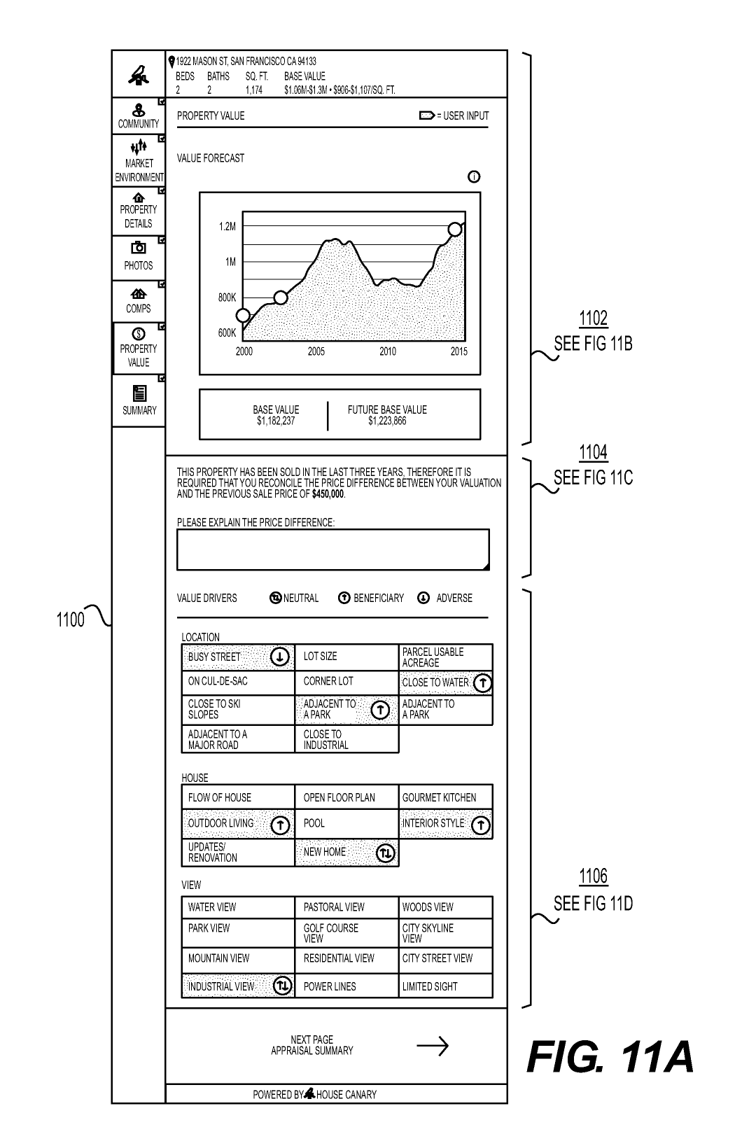

FIGS. 10A-10H show screens 1000, 1002, 1004, 1006, 1008, 1010, 1012, presented on the UI that show information about comparable properties. Screen portion 1002 (FIG. 10B) shows a listing of comparable properties (“comps”) selected, e.g., based on similarity to the property being appraised. Preferably the comps are initially selected by the backend 102 and the appraiser is able to use the UI to adjust the values and/or select different or additional comps (e.g., using “Add Comp” button in 1010, FIG. 10G).

Similarity filters can be selected (and removed) to identify recently sold properties most similar to the property being appraised. A percentage similarity score may be determined by taking into account the differences between all attributes selected for the comparative properties and the property being appraised. Those of ordinary skill in the art will realize and appreciate, upon reading this description, that any kind of similarity score may be used and that the system is not limited by the manner in which the score is determined or represented.

The parameters used to determine similarity for comps may be modified by the user using a tab in the UI (1006, FIG. 10D). Using the tab allows the user to add and/or remove parameters used to determine similarity for comps. In a present implementation the user may add/remove the following parameters: present value, year built, number of bedrooms, number of bathrooms, condition, last sale price, proximity, and school district (FIG. 10E). It should be appreciated that this list is merely exemplary, and different and/or other parameters may be used.

In some exemplary embodiments hereof a user (e.g., appraiser) may adjust the value of comparable properties (e.g., to normalize these values). Thus, as shown in FIG. 10B, the user may select a comparable property and make adjustments.

Screen portion 1012 (FIG. 10H) shows another listing of comparable properties (“comps”) (these for the property described in screen 710, FIG. 7F), selected, e.g., based on similarity to the property being appraised. Note that in this example the value range for the subject property (“1636 W Culver St”) is shown as “Regression inconclusive.”

In the example in FIG. 10H, the appraisal system 102 has provided/suggested six comps, four sold and two active. The comps are preferably ordered by similarity to the subject property, preferably based on a similarity score for each comp determined (e.g., by the appraisal system 102). The similarity score may be determined, e.g., by comparing aspects of the subject property to each of the comps. The appraiser may delete some or all of the comps and may also choose more comps. The screen portion 1012 includes a selectable region (or button) 1014 labeled “Adjustments,” which is discussed in greater detail below.

Value

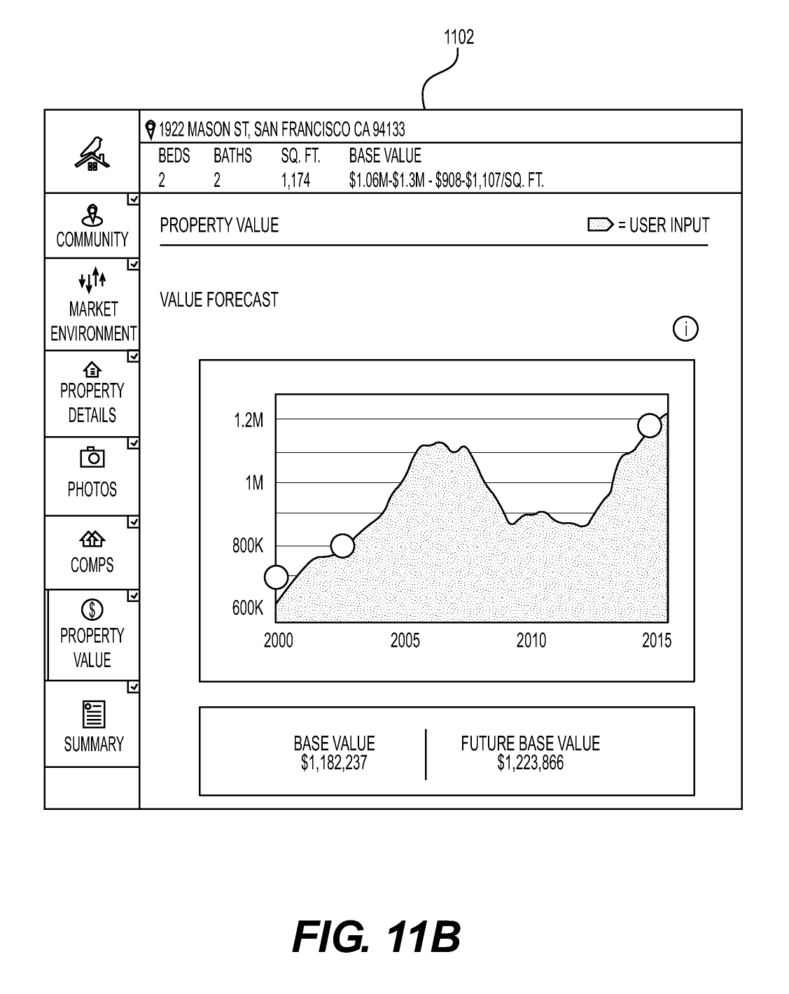

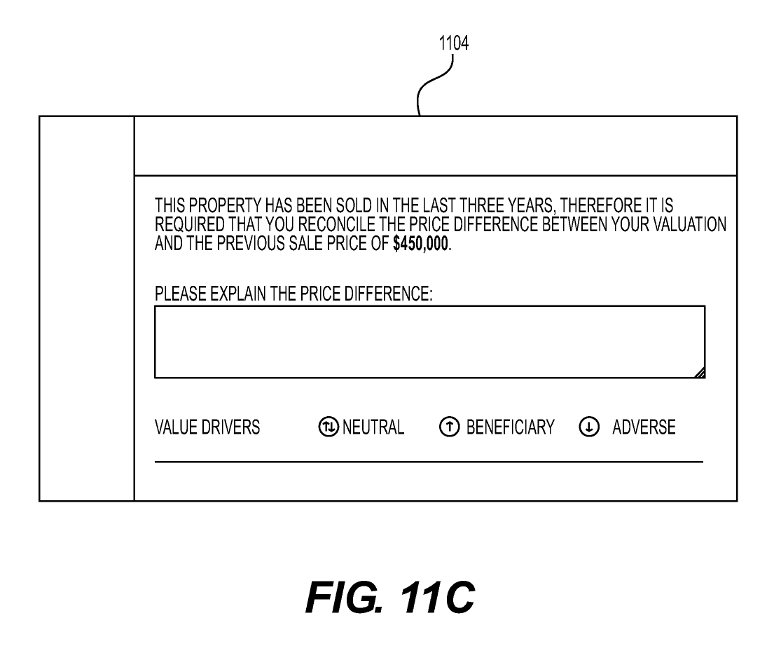

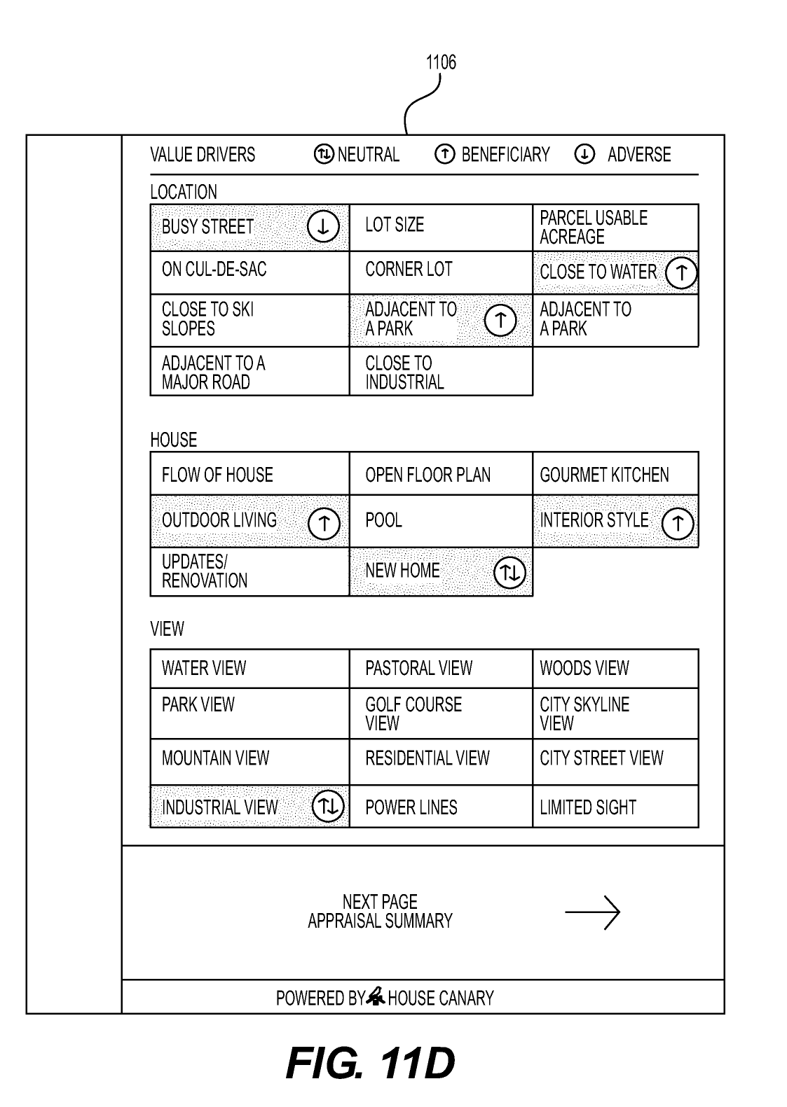

FIGS. 11A-11D show screens 1100, 1102, 1104, 1106, presented on the UI that show information about the property value. The user may modify some of the information. Factors that may affect value are preferably highlighted (e.g., by an up arrow for a desirable feature that may increase the property's value and a down arrow for an undesirable feature that may decrease the property's value).

In some implementations the UI may provide a value index and forecast (1102, FIG. 11B). In exemplary embodiments the backend 102 determines a repeat sales home price index for each major zip code in the US. The index highlights where the property being reviewed sold at in the past, relative to the home price appreciation in the market. The system (e.g., the UI) then asks the appraiser to make value adjustments for recent changes to the property. The system may also provide forecasts for how home prices in the market are predicted to change in the future, so the appraiser can take future market expectations into account when valuing the property.

An implementation may display one or more value drivers on the UI (1106 FIG. 11D). Value drivers define a hierarchy of factors that impact value most and value adjustments for the property being appraised. Value drivers/factors may include location factors, house-specific factors, and view factors. The user/appraiser may use the value drivers to justify or explain an appraisal value.

In some embodiments hereof the appraisal system may determine and provide a list of features that may be used to adjust the value of the property being appraised. For example, a value for a swimming pool, garden, fence, etc. may be provided via the UI. The appraiser may then use the list to adjust (e.g., add value to or subtract value from) the appraisal value. The system may track appraisers' use or non-use of these line item adjustments, and may use this information to adjust the line item values for future use.

In some embodiments hereof the appraisal system may determine prior appraisal information for the property being appraised. The prior information may be used to provide the appraiser with a list of features about the property and/or about comparable properties and/or the community that may have changed since the previous appraisal.

The user may navigate off the Value screen 1100 using the “Next Page—Appraisal Summary” region on the page.

Appraisal Summary

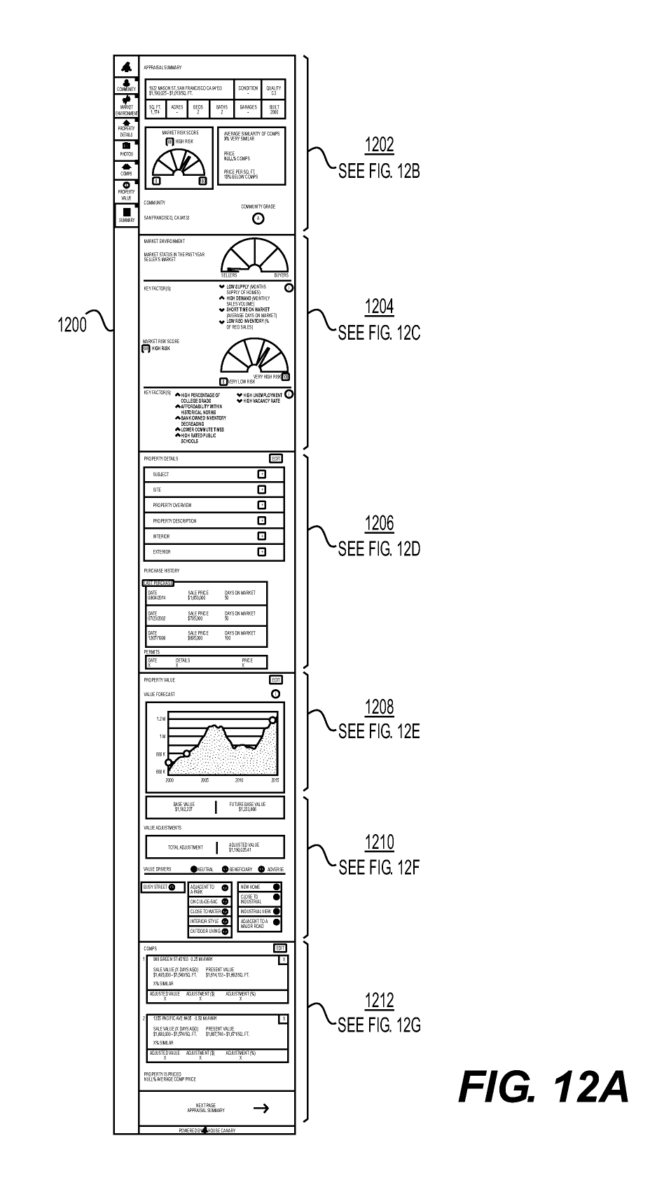

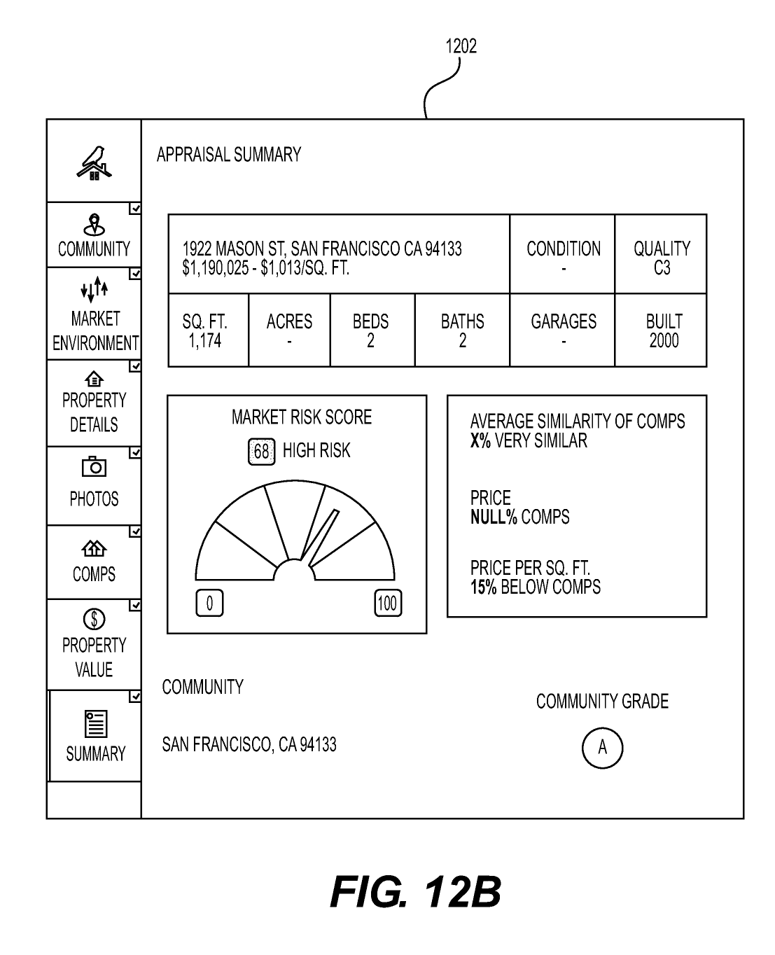

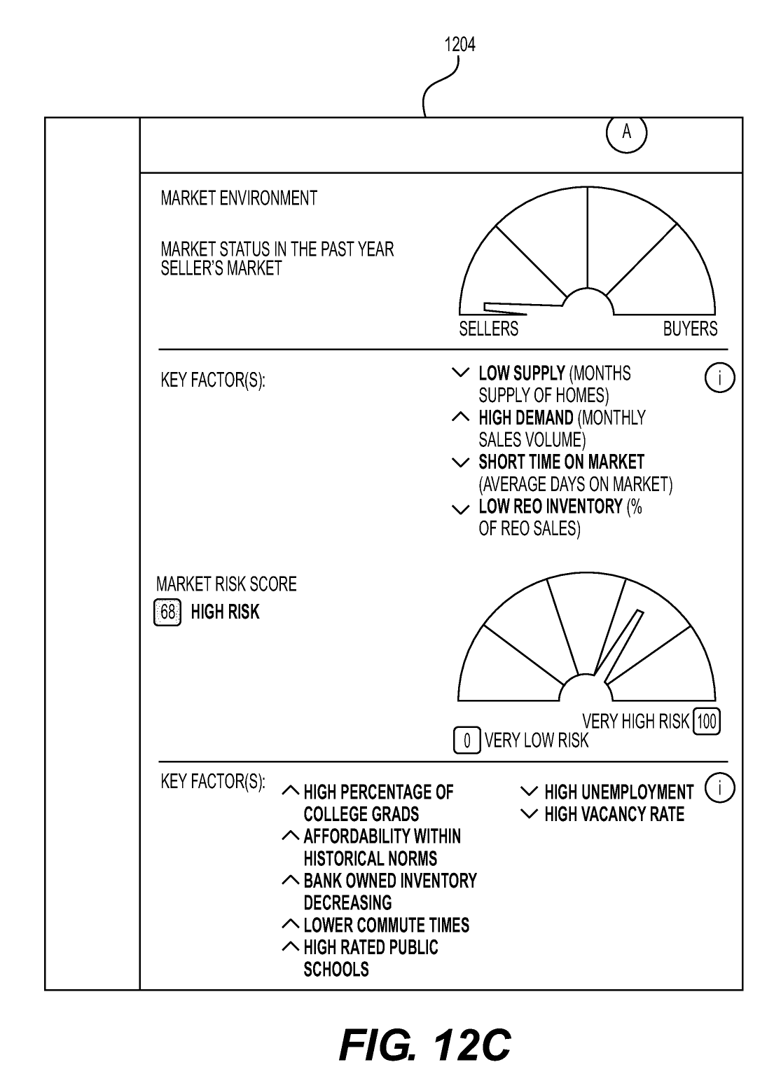

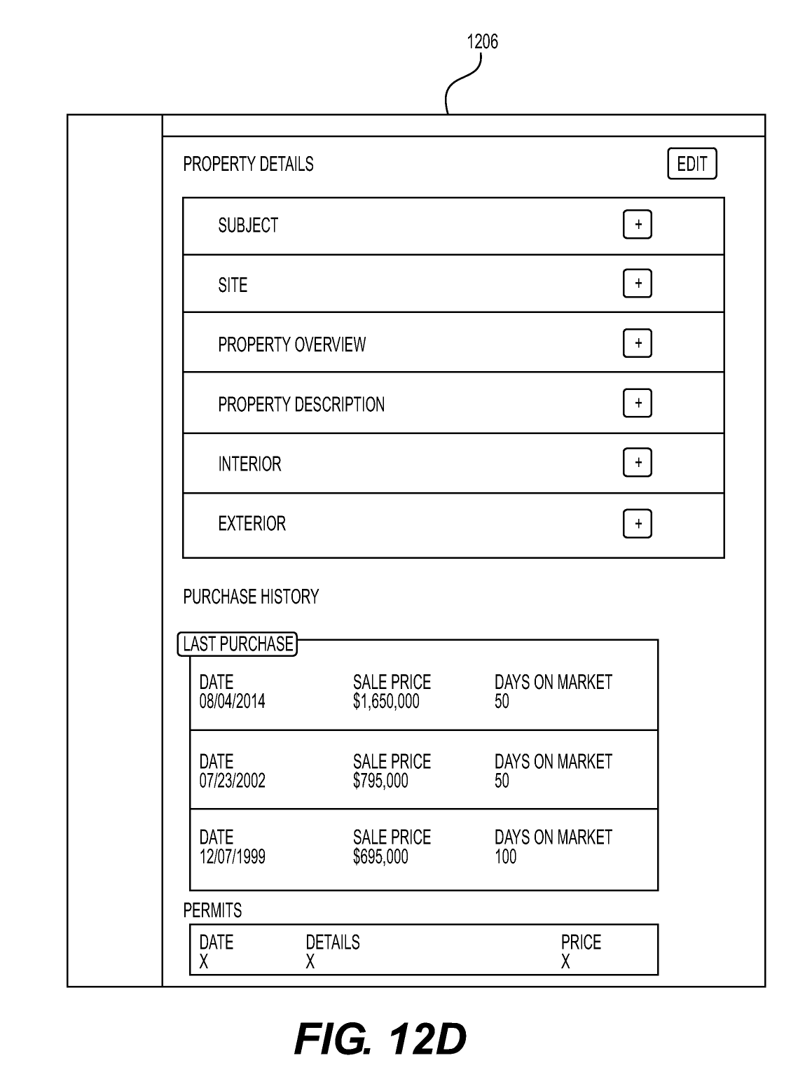

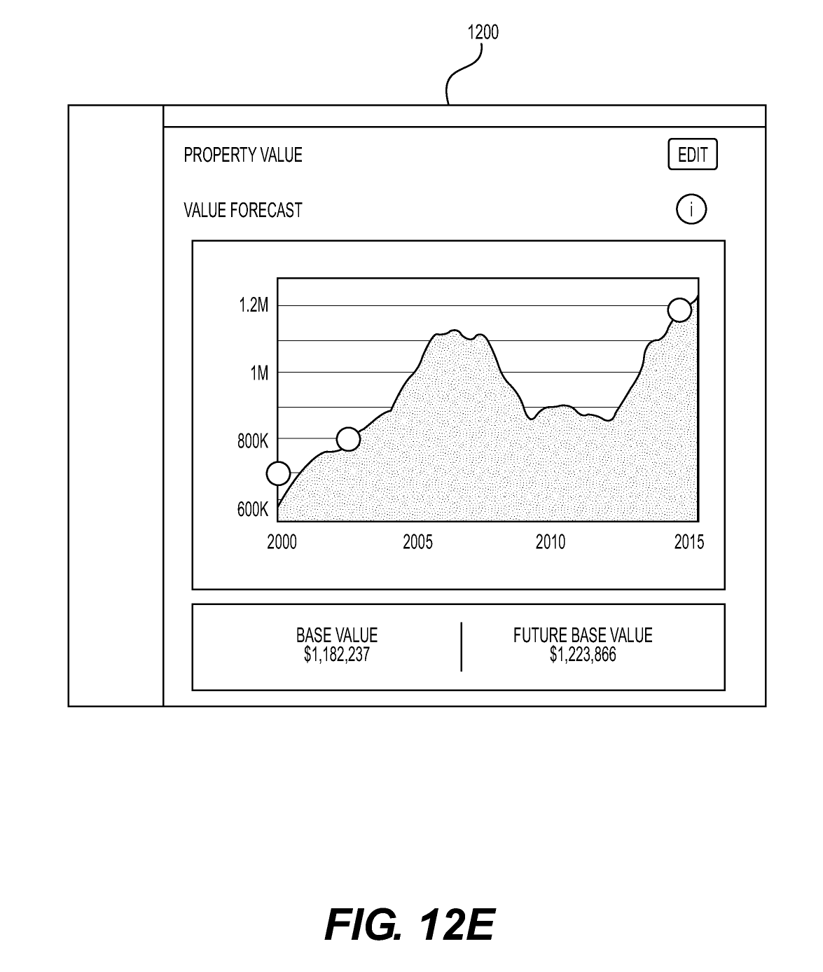

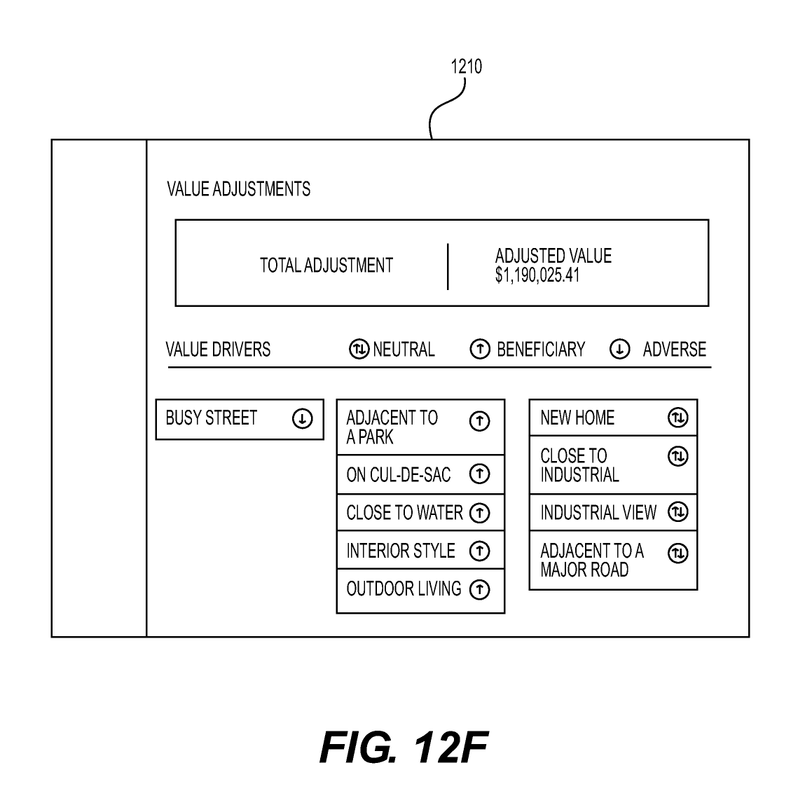

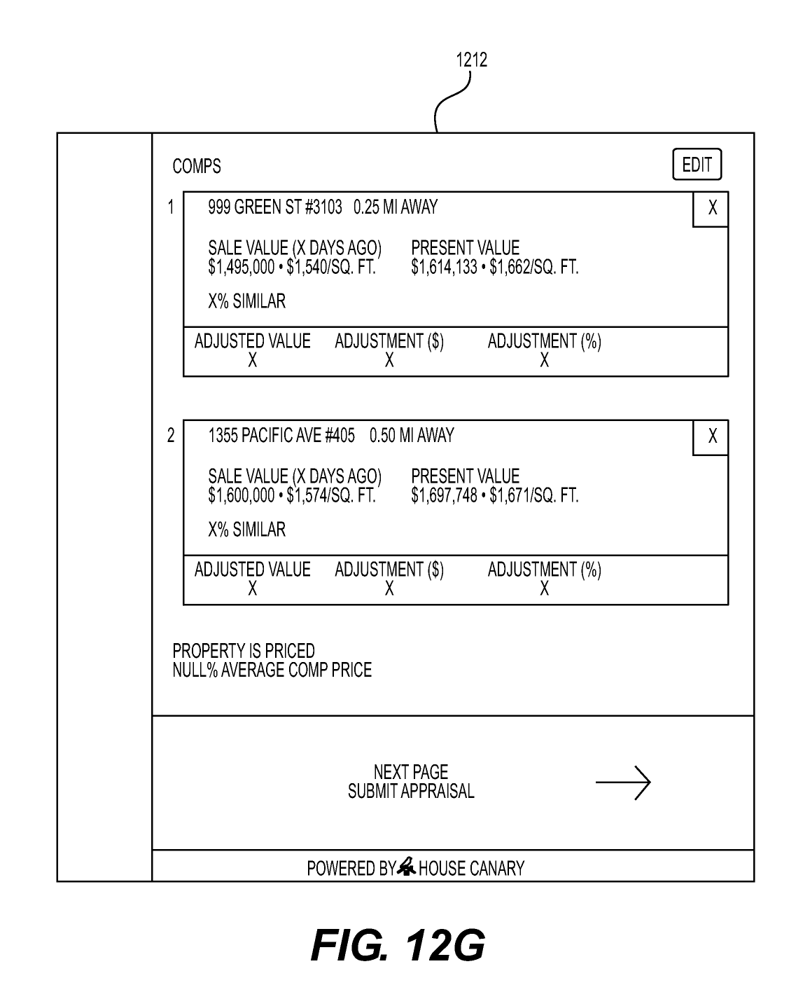

When the user navigates to the “Appraisal Summary” the UI presents the Appraisal Summary screen 1200 (shown in FIGS. 12A-12G).

Once the user is satisfied with the appraisal the user may select the “Submit Appraisal” region of the screen.

Confirmation

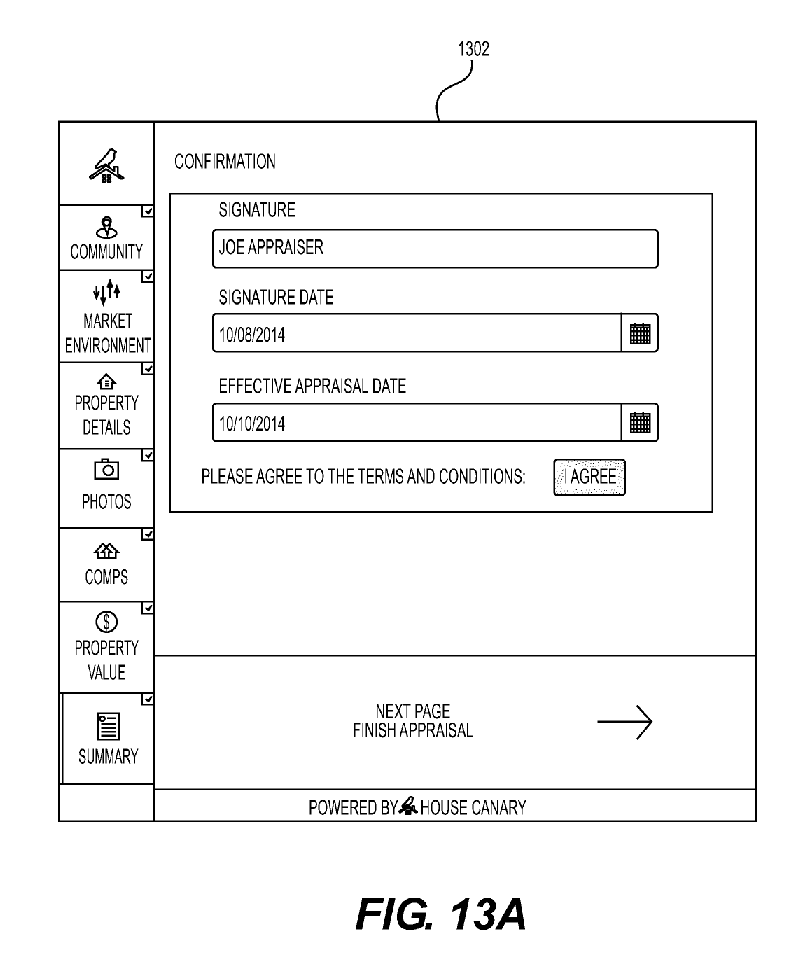

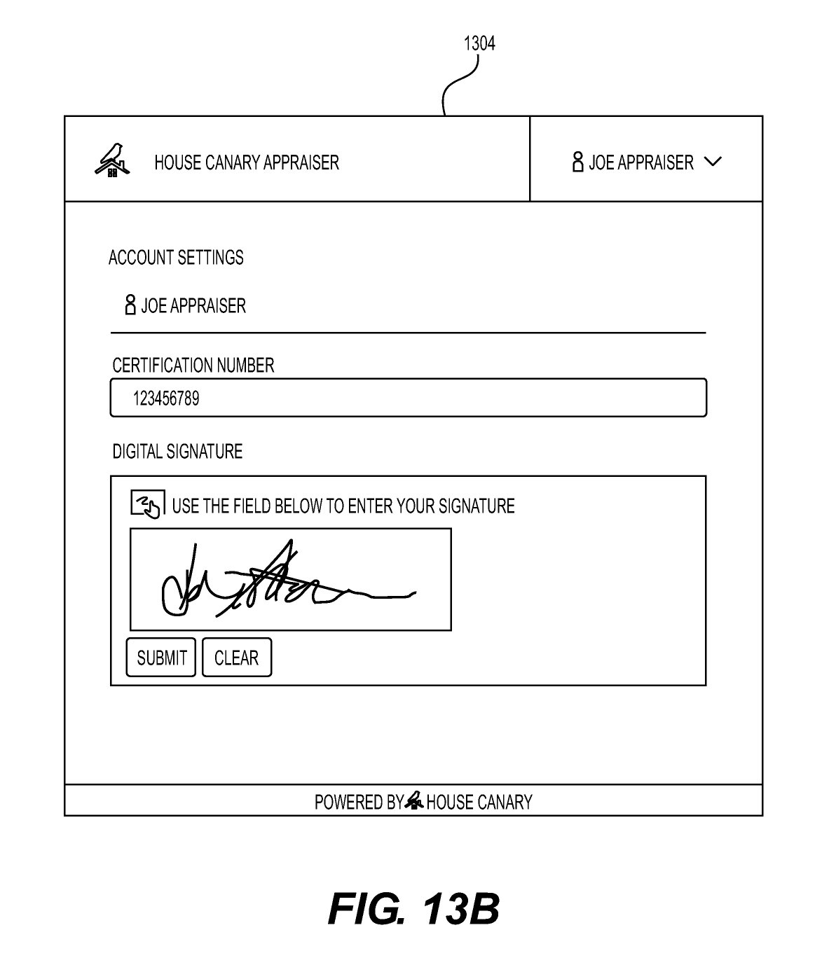

The user may then select “Finish Appraisal” on screen 1300 in FIG. 13A that brings the user to a signature page that allows the user to sign and submit the completed appraisal.

When the user submits the appraisal the submitted appraisal is added to the user's list of submitted appraisals (see screen 500, FIG. 5A) and the UI causes the completed appraisal to be sent to the appraisal system 102. The completed appraisal may be checked by the backed for integrity and completeness and may then be sent to the requesting party. If more information is needed then the appraisal system 102 may notify the user.

It should be understood that the system 102 may re-format the appraisal into a format required by the requesting party.

Comps—Regression Analysis—Value Adjustments

As shown in FIG. 10H, and discussed above, when the user/appraiser is presented with comparables, the user may choose to make adjustments, e.g., by selecting the “Adjustments” button/region 1014.

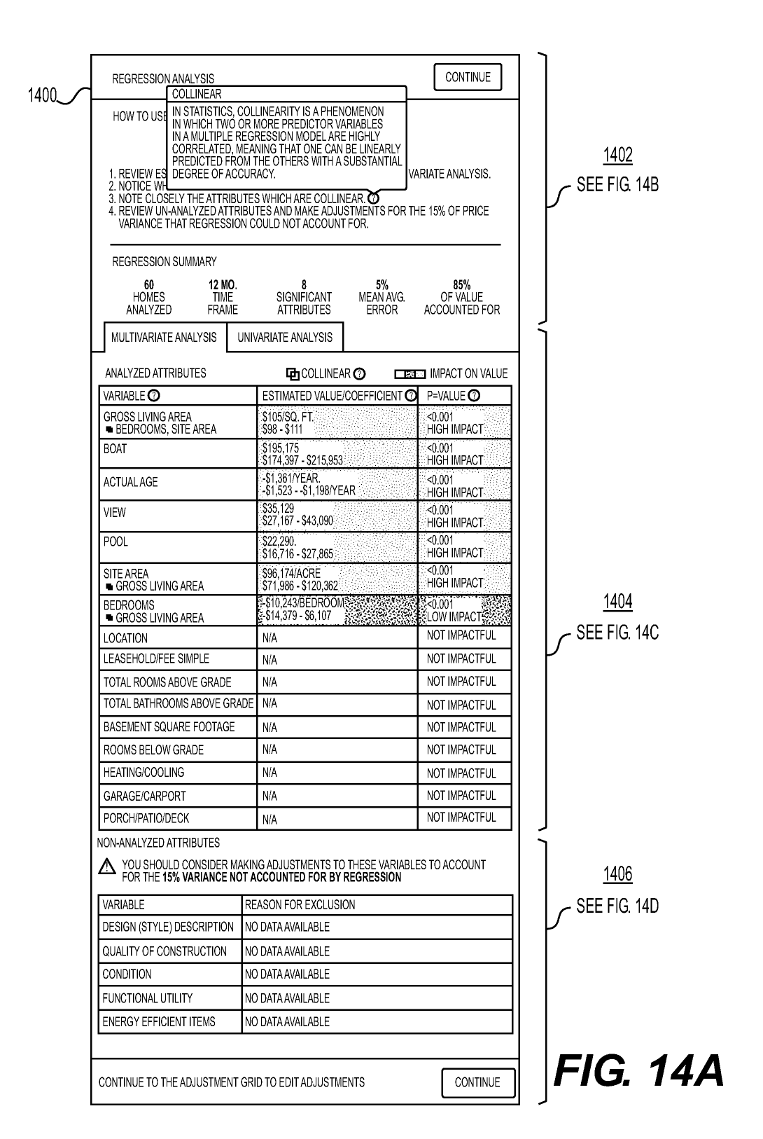

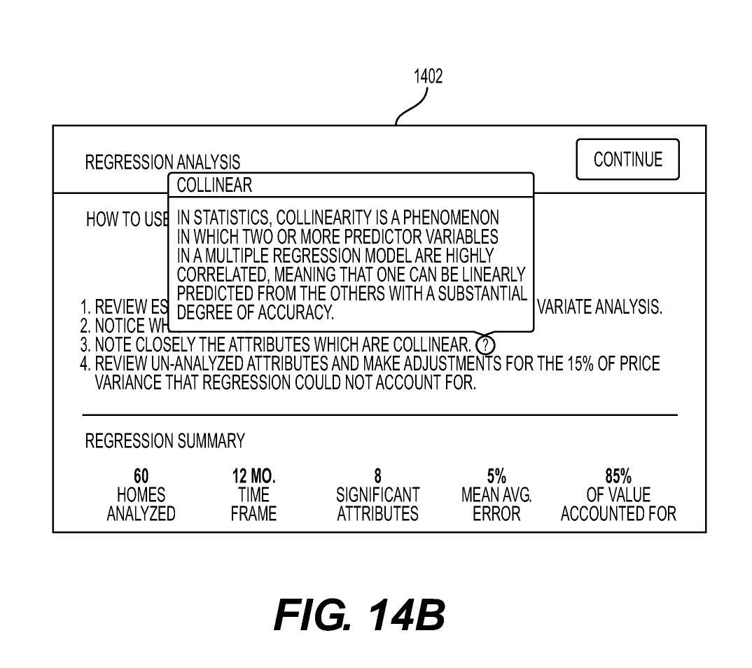

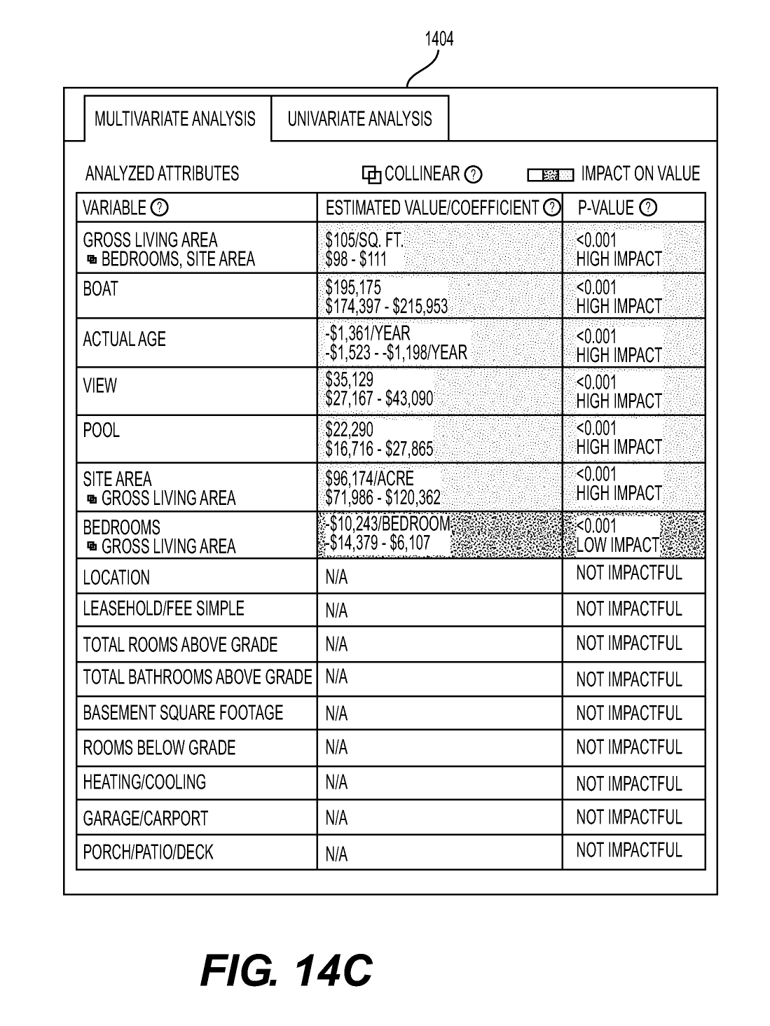

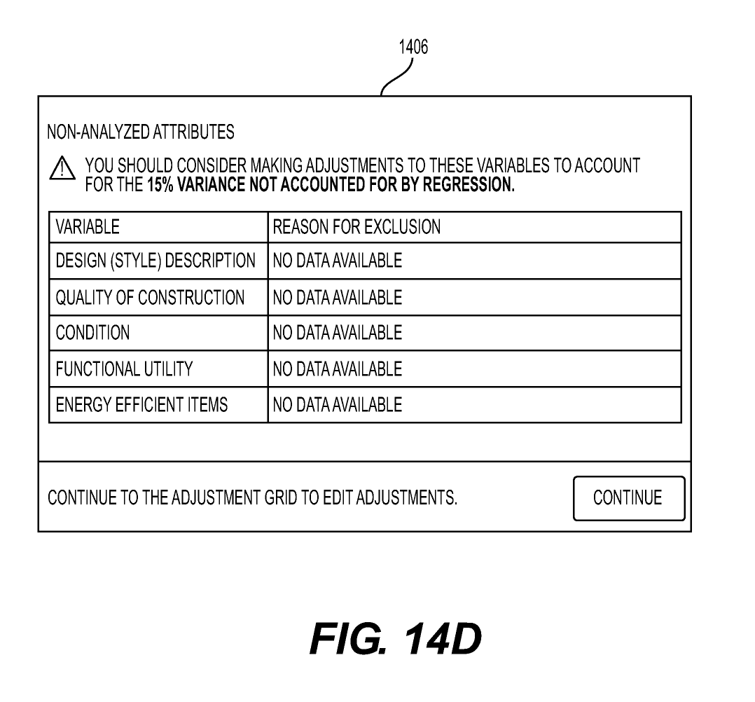

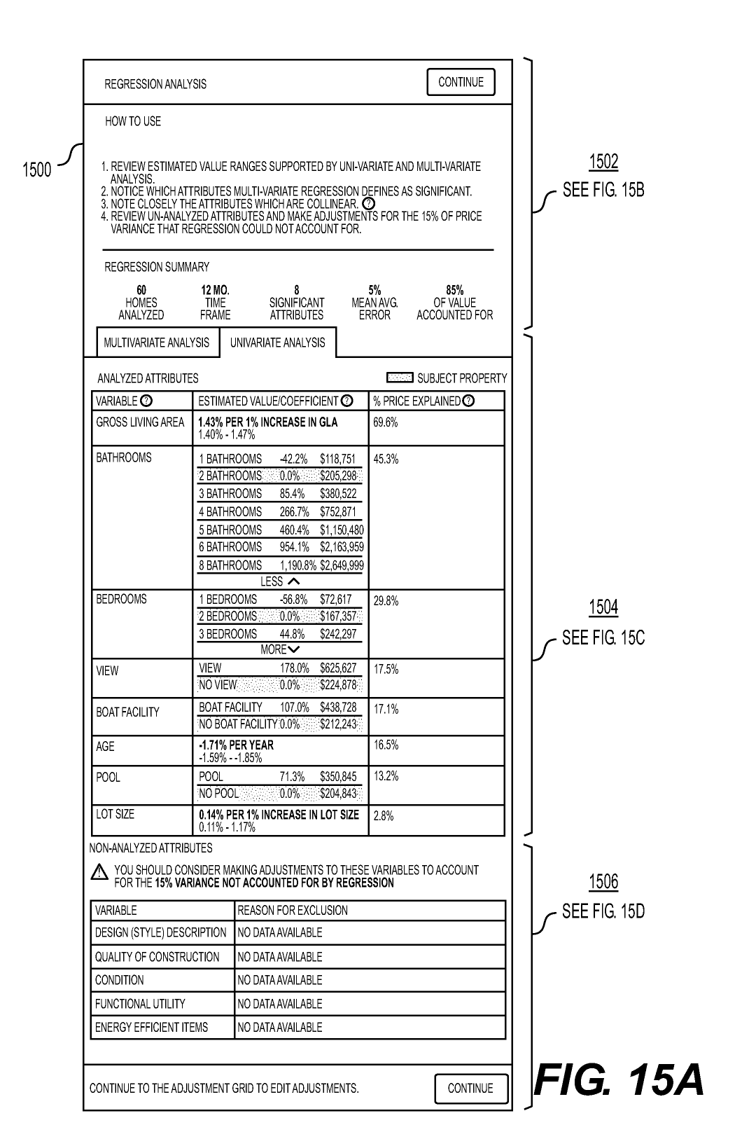

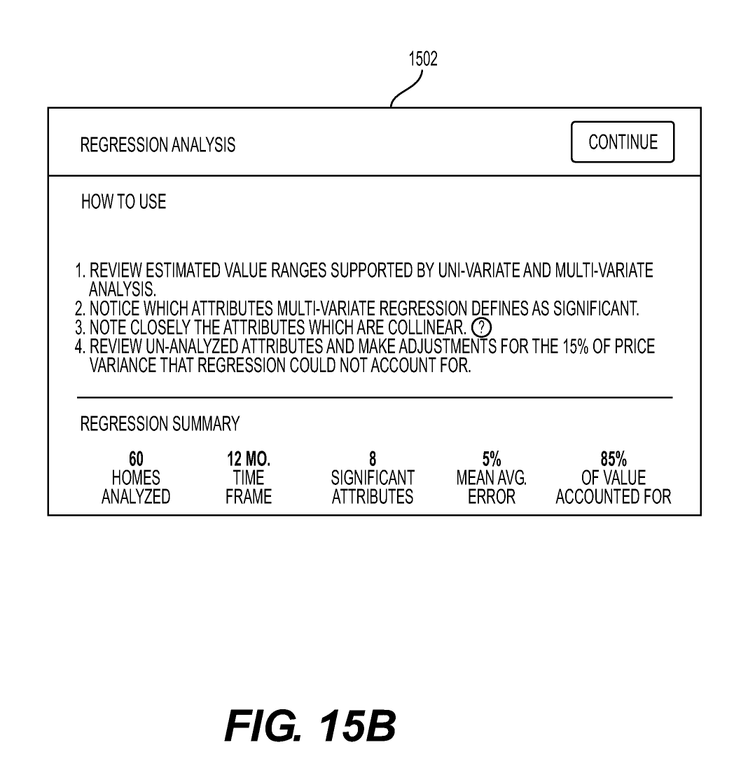

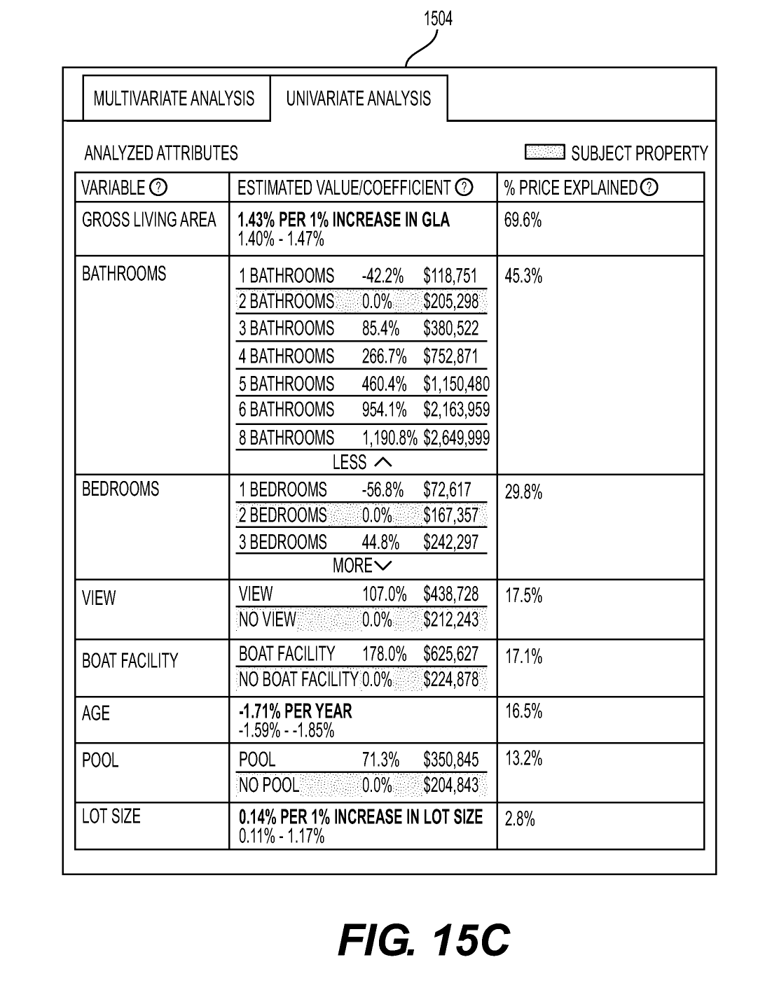

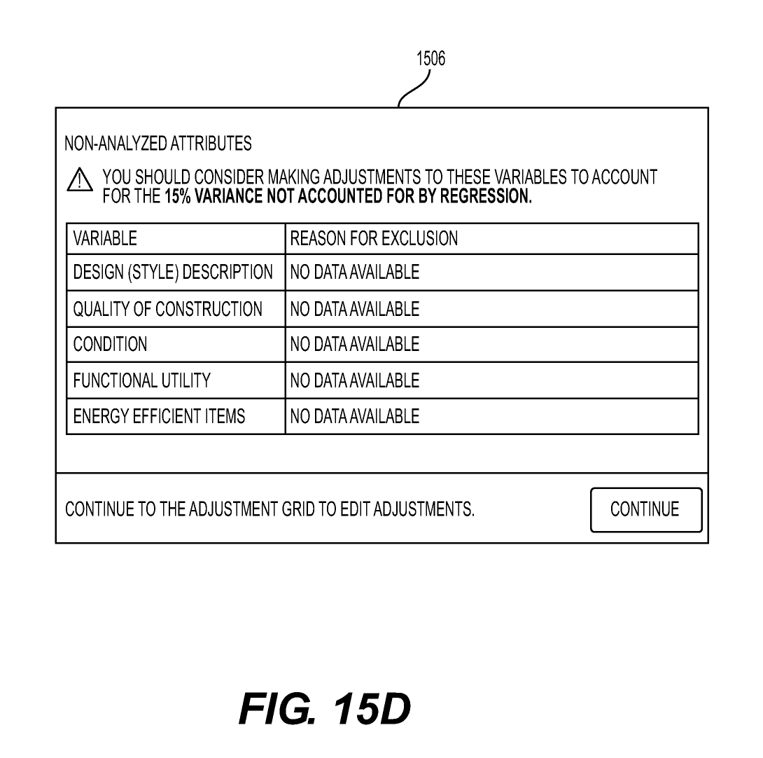

When the user selects the “Adjustments” button 1014 (FIG. 10H), the user is presented with information and options for multivariate and univariate regression analysis (FIGS. 14A-14D and 15A-15D).

With reference to FIGS. 14A-14D, the UI presents the appraiser with screen 1400 (for convenience here described as screens 1402, 1406, and 1408). The top portion 1402 of screen 1400 (FIG. 14B) provides information about how to use the regression analysis and gives the user a regression summary. The middle portion 1404 of screen 1400 (FIG. 14C) provides details of a multivariate analysis of comps with respect to various variables (e.g., “Gross living area,” “Boat,” “Actual Age,” “View,” “Pool,” “Site Area,” “Bedrooms,” “Location,” “Leasehold/Fee simple,” “Total rooms above grade,” “Total bathrooms above grade,” “Basement square footage,” “Rooms below grade,” “Heating/Cooling,” “Garage/carport,” and “Porch/patio/deck”). The UI (on screen portion 1404) also provides the appraiser with an indication of the impact of the various variables on the value. For example, in the example shown in FIGS. 14A-14D, six of the variables (“Gross living area,” “Boat,” “Actual Age,” “View,” “Pool,” “Site Area,”) are shown to have a high impact (with a P-value of less than 0.001), whereas the other variables are considered “not impactful.”

The UI also provides (in screen portion 1406, FIGS. 14A and 14D, an indication or list of non-analyzed attributes. In the example shown, the UI provides a reason why these attributes were excluded (e.g., “No data available.”). In this example the appraiser is warned to consider making adjustments to account for a variance (of 15%) not accounted for by regression.

FIGS. 15A-15D depict screens (or screen portions) 1500, 1502, 1504, 1506 that are displayed by the UI when the appraiser selects the “Univariate Analysis” tab or region. The UI lists the analyzed attributes (in the system shown here, these include “Gross living area,” “Bathrooms”, “View”, “Boat Facility,” “Age,” “Pool,” and “Lot size”). For each of these attributes the UI lists a percentage value corresponding to the attributes affect on the price. For example, the subject property has two bedrooms, and that accounts for 29.8% of its price.

As with the multivariate analysis, the UI also provides (in screen portion 1506, FIGS. 15A and 15D, an indication or list of non-analyzed attributes.

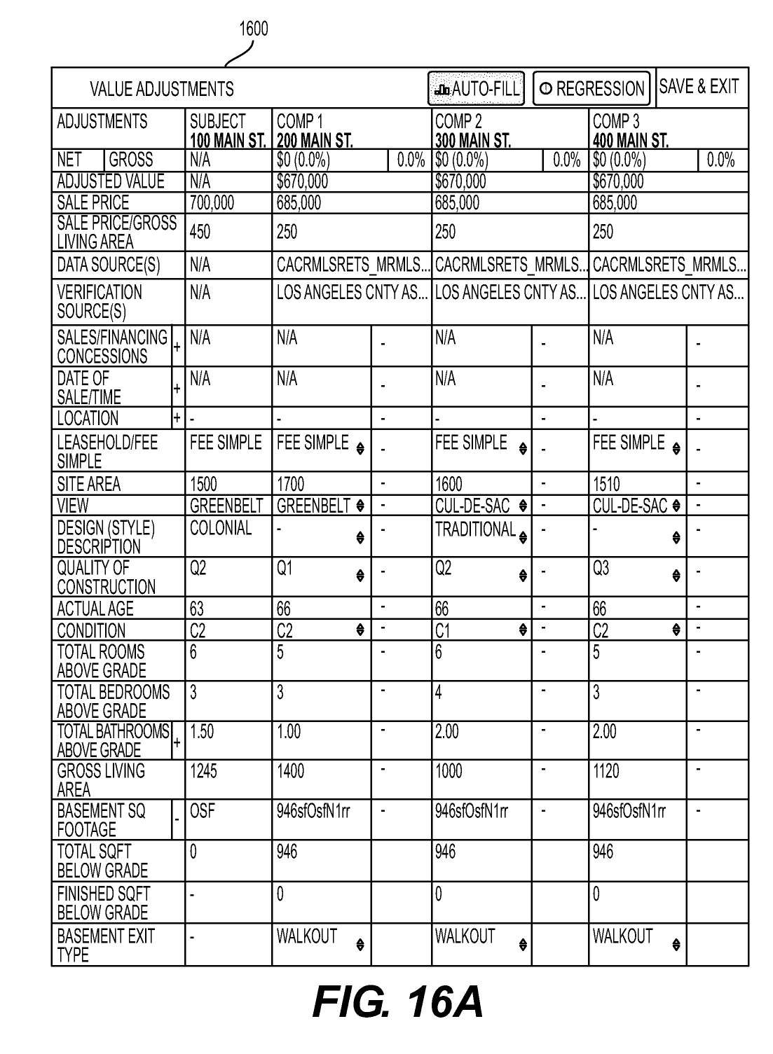

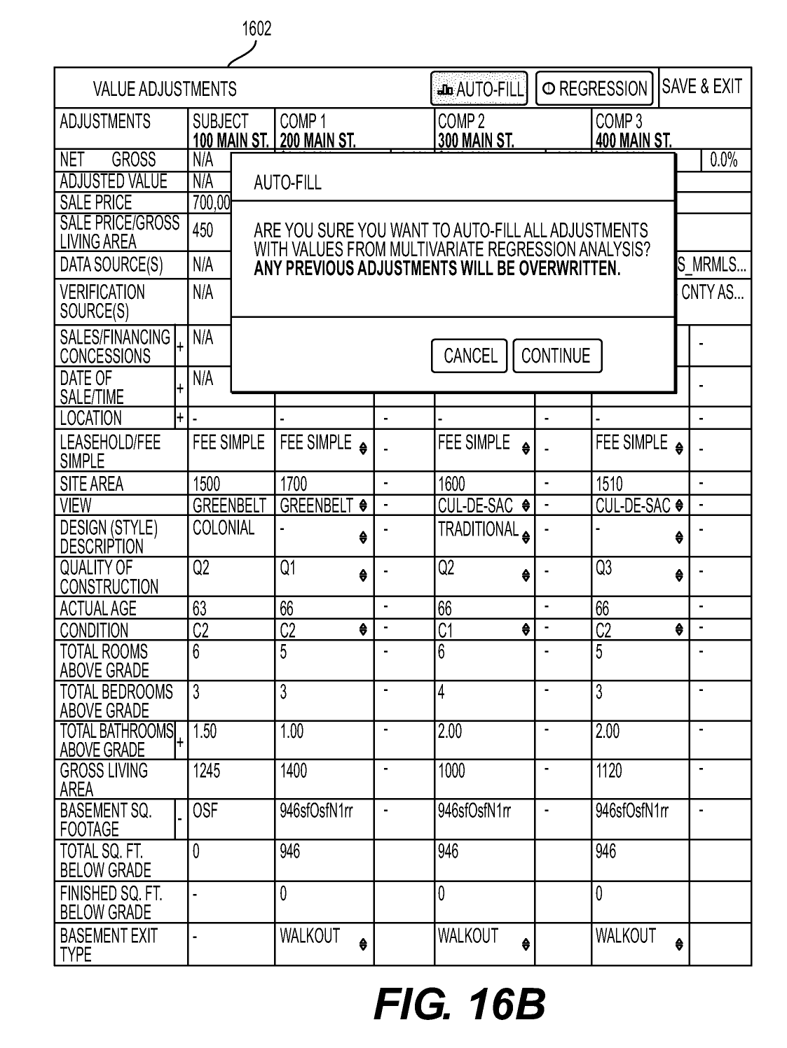

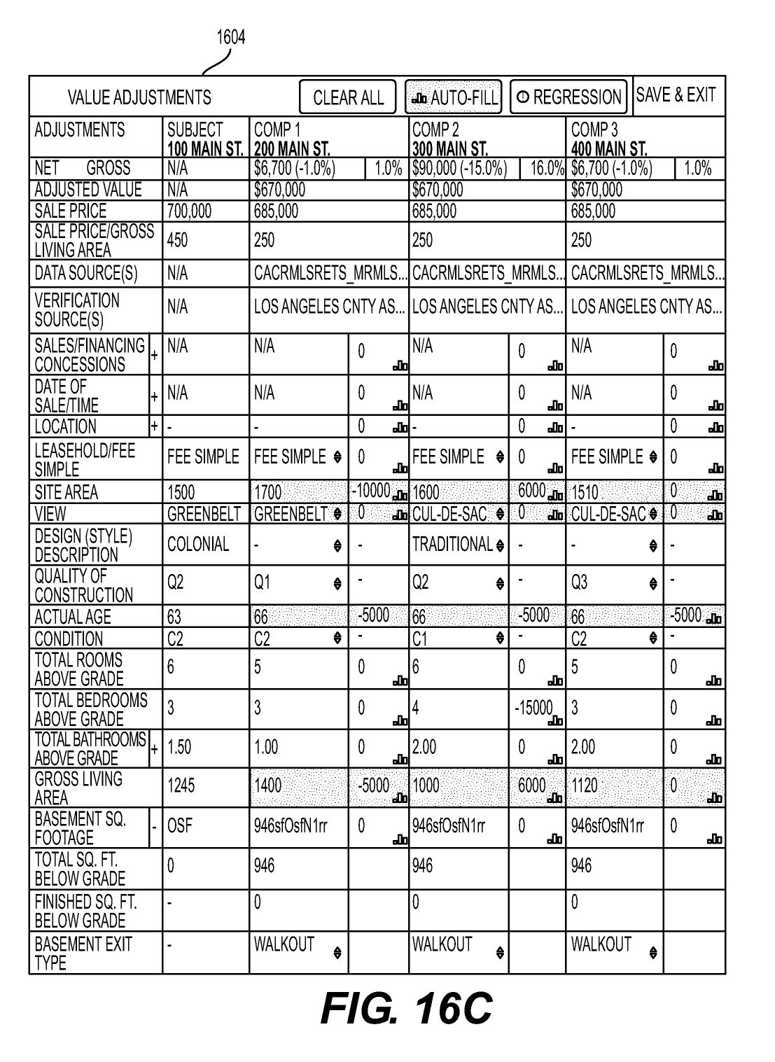

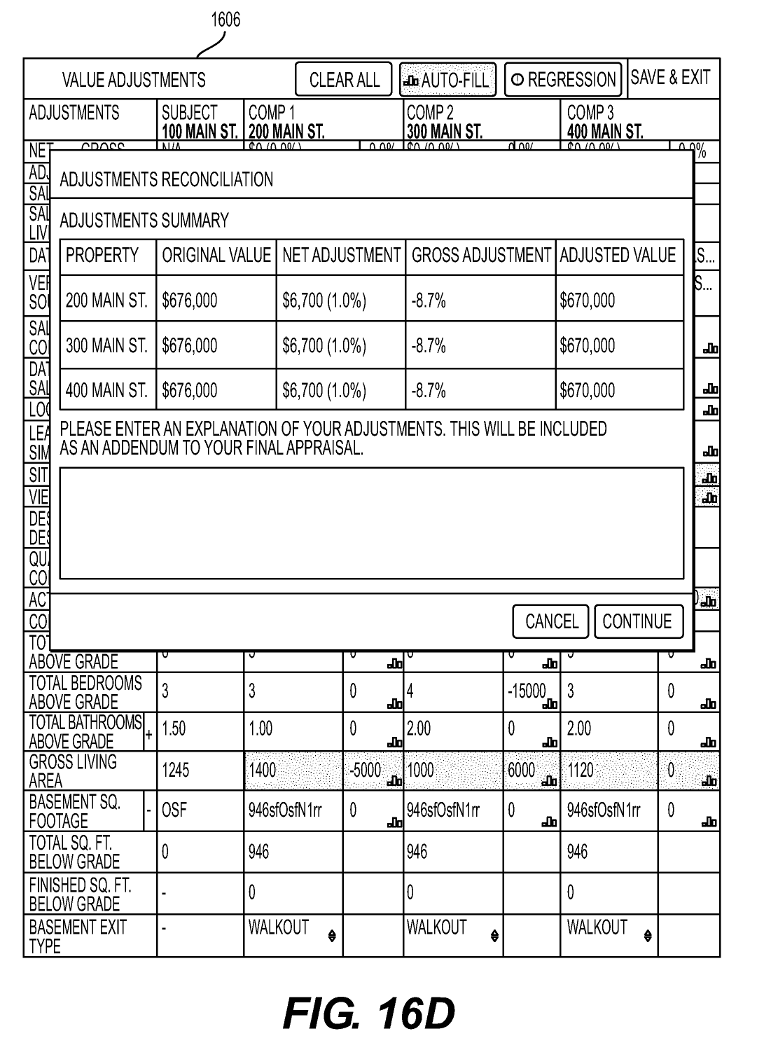

In exemplary embodiments hereof the appraisal system may automatically adjust comps using the results of the multivariate regression analysis. Thus, e.g., as shown in the screen 1600 in FIG. 16A, after performing a multivariate regression analysis, the user may select the button “Auto-Fill” to effect such adjustments. When the “Auto-Fill” button is selected then the UI asks the user to confirm that the user wants to automatically fill all adjustments with values from the multivariate regression analysis (as shown in screen 1602 in FIG. 16B). If the user confirms the automatic fill then the system updates the values for the comps, as shown in screen 1604 in FIG. 16C). The UI then presents the user with an interface (as shown in screen 1606 in FIG. 16D) which allows the user to enter an explanation of the adjustments. The user's explanation will be included as an addendum to the final appraisal.

### Integrity Checking

The system preferably performs various checks to ensure the integrity of aspects of the appraisal. Some of these checks may rely on or use information obtained by the user or the user's device.

In some exemplary embodiments hereof the device may use biometric measurements to ensure that an actual appraiser is performing the appraisal. For example, the device may include a fingerprint acquisition mechanism that can be used to confirm the identity of the user inputting information and interacting with the device. The user's biometric information may be checked on the device and/or in the backend 102. It should be appreciated that some backend integrity checking may require pre-registration of users and/or devices with the system.

In some exemplary embodiments hereof the system may check aspects of pictures (photographs) that are provided by the user. Photographs may be tagged (e.g., with time and/or with geographic location information from a GPS in the device) in order to confirm that they were actually taken at the property being appraised and to confirm when they were taken. Photographs may also be compared to known image databases to ensure that they relate to the property being appraised.

In another aspect hereof, image recognition may be used to identify comparable properties based on their having similar outside images. Image recognition may also be used to determine quality and condition of comparable properties and the property being appraised.

### Feedback

In some aspects hereof, the backend 102 may retain information from appraisers in order to train and refine data evaluation models. Appraisal information (e.g., pricing and value adjustments) made by appraisers may thus be used to provide more accurate selection of comparable properties and other information for future appraisals. For example, value drivers (discussed above) are typically known by appraisers and may be useful to determine the values of comparable properties for future appraisals.

Information provided by the backend 102 may include information about potential demand by price point by consumer segment in order to identify how many people can qualify for housing at that price point. Such information may represent potential demand from different consumer groups for each price point of housing in the area (see, e.g., FIG. 6G). Where the bar is higher than the line potential demand exceeds supply, and vice versa. This is calculated by understanding when consumers purchased their home, how much equity and total wealth they have built up to roll equity into a new home with at least 20% down (or more if they have additional equity), and the ability for consumers to meet the 33% loan to income requirements.

### Data Input

As noted, the intake mechanism 122 may obtain information from various external systems and databases 108. In some exemplary embodiments hereof the intake mechanism 122 may include a natural language processing (NLP) mechanism to identify certain information in the external databases. For example, some external databases may contain information in the form of comments (free form) from realtors or other appraisers. The NLP mechanism may process this free form information to obtain more accurate comparability scores.

For example, certain words or phrases relating to external and/or internal aspects of a property may be found using the NLP mechanism. Examples of potentially relevant words or phrases for external information about a property include the phrases: view; pool; corner; gated; cul-de-sac; golf course, level; sloped; guesthouse; street type (Dr., Ln, Ave., Rd, Pkwy); “as is” (which typically means it is in bad shape); waterfront (beach/river/lake etc.); balcony; and covered patio. Examples of potentially relevant words or phrases for internal information about a property include the phrases: walk in closets granite; stainless; “SS”; open; renovated; remodeled; upgrade; natural light; contemporary; and high ceilings/vaulted ceilings.

The intake mechanism 122 may also use non-free-form information in external databases to determine property features and more accurate comparability scores.

As noted above of the sensors may be incorporated into wearable devices (e.g., Google glass-type systems) possibly with voice recognition. It should be appreciated that with such a system an appraiser may walk through and around a property, using the wearable device and voice recognition to perform aspects of the appraisal. In such a system the UI may be modified to fit on the wearable display. Such a system may be used to record aspects of an appraisal (e.g., an appraisers walk-through of a property). Appraisal recordings may be used for training purposes or the like (e.g., in support of an appraisal training/apprenticeship program).

As noted, the device may include or be connectable to one or more sensors (342 in FIG. 3D). These sensors preferably include at least a camera to support the user taking photographs of the property being appraised.

In some exemplary embodiments hereof the sensors include distance measurement devices such as laser or sonar measurement devices that support user input of the property's dimensions. The user application may be integrated, e.g., with a device such Leica's Disto products described at http://shop.leica-geosystems.us/c/leica-disto (e.g., Disto E7500i described at http://disto.leica-geosystems.us/disto-e7500i) to support the user's ability to input room dimensions based upon 3D imaging of rooms.

Other sensor data (e.g., relating to detect radon, mold, termites, or cracked foundations) may be automatically incorporated into the appraisal report.

In some exemplary embodiments hereof the system may support the user (appraiser) taking an inventory of aspects of the property. For example, the user may identify and/or image trees and plants that might be protected.

In some exemplary embodiments hereof the system may scan any type of signals and information and barcodes from or emitted by whatever means by all systems in the property. In this manner the system will have the ability to inventory appliance s and systems such as A/C, generators, security, solar electricity, water and gas meters to determine useful information for the appraisal—such as age and condition and quality of equipment, energy and water efficiency, etc.

### Review

As contemplated herein, an appraisal may be carried out by more than one person and is typically carried out on behalf of a third party (e.g., a realtor, lender or owner). Accordingly, in some aspects hereof the system provides the user with the ability to show an appraisal report (complete or otherwise) to another party (e.g., the realtor/owner) in a manner that facilitates comments. This feature may be provided by a dashboard or the like that allows a third party (not the appraiser) to comment on some or all aspects of the appraisal.

### Computing

The services, mechanisms, operations and acts shown and described above are implemented, at least in part, by software running on one or more computers or computer systems or devices. It should be appreciated that each user device is, or comprises, a computer system.

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that can implement the processes of various embodiments. Thus, various combinations of hardware and software may be used instead of software only.

One of ordinary skill in the art will readily appreciate and understand, upon reading this description, that the various processes described herein may be implemented by, e.g., appropriately programmed general purpose computers, special purpose computers and computing devices. One or more such computers or computing devices may be referred to as a computer system.

FIG. 4A is a schematic diagram of a computer system 400 upon which embodiments of the present disclosure may be implemented and carried out.

According to the present example, the computer system 400 includes a bus 402 (i.e., interconnect), one or more processors 404, one or more communications ports 414, a main memory 406, removable storage media 410, read-only memory 408, and a mass storage 412. Communication port(s) 414 may be connected to one or more networks by way of which the computer system 400 may receive and/or transmit data.

As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process.

Processor(s) 404 can be (or include) any known processor, such as, but not limited to, an Intel® Itanium® or Itanium 2® processor(s), AMD® Opteron® or Athlon MP® processor(s), or Motorola® lines of processors, and the like. Communications port(s) 414 can be any of an RS-232 port for use with a modem based dial-up connection, a 10/100 Ethernet port, a Gigabit port using copper or fiber, or a USB port, and the like. Communications port(s) 414 may be chosen depending on a network such as a Local Area Network (LAN), a Wide Area Network (WAN), a CDN, or any network to which the computer system 400 connects. The computer system 400 may be in communication with peripheral devices (e.g., display screen 416, input device(s) 418) via Input/Output (I/O) port 420. Some or all of the peripheral devices may be integrated into the computer system 400, and the input device(s) 418 may be integrated into the display screen 416 (e.g., in the case of a touch screen).

Main memory 406 can be Random Access Memory (RAM), or any other dynamic storage device(s) commonly known in the art. Read-only memory 408 can be any static storage device(s) such as Programmable Read-Only Memory (PROM) chips for storing static information such as instructions for processor(s) 404. Mass storage 412 can be used to store information and instructions. For example, hard disks such as the Adaptec® family of Small Computer Serial Interface (SCSI) drives, an optical disc, an array of disks such as Redundant Array of Independent Disks (RAID), such as the Adaptec® family of RAID drives, or any other mass storage devices may be used.

Bus 402 communicatively couples processor(s) 404 with the other memory, storage and communications blocks. Bus 402 can be a PCI/PCI-X, SCSI, a Universal Serial Bus (USB) based system bus (or other) depending on the storage devices used, and the like. Removable storage media 410 can be any kind of external hard-drives, floppy drives, IOMEGA® Zip Drives, Compact Disc—Read Only Memory (CD-ROM), Compact Disc—Re-Writable (CD-RW), Digital Versatile Disk—Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory, which typically constitutes the main memory of the computer. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium can store (in any appropriate format) those program elements that are appropriate to perform the methods.

As shown, main memory 406 is encoded with application(s) 422 that support(s) the functionality as discussed herein (an application 422 may be an application that provides some or all of the functionality of one or more of the mechanisms described herein). Application(s) 422 (and/or other resources as described herein) can be embodied as software code such as data and/or logic instructions (e.g., code stored in the memory or on another computer readable medium such as a disk) that supports processing functionality according to different embodiments described herein.

For example, as shown in FIGS. 4B and 4C, respectively, application(s) 422 may include device application(s) 422-1 in FIG. 4B (corresponding to device/client applications 302 in FIG. 3A), and backend application(s) 422-2 in FIG. 4B (corresponding to applications 110 in FIG. 2, and corresponding to backend service(s)).

During operation of one embodiment, processor(s) 404 accesses main memory 406 via the use of bus 402 in order to launch, run, execute, interpret or otherwise perform the logic instructions of the application(s) 422. Execution of application(s) 422 produces processing functionality of the service(s) or mechanism(s) related to the application(s). In other words, the process(es) 424 represents one or more portions of the application(s) 422 performing within or upon the processor(s) 404 in the computer system 400.

For example, as shown in FIG. 4D, process(es) 424 may include device process(es) 424-1, corresponding to one or more of the device application(s) 422-1. Similarly, as shown in FIG. 4E, process(es) 424 may include backend process(es) 424-2, corresponding to one or more of the backend application(s) 422-2.

It should be noted that, in addition to the process(es) 424 that carries(carry) out operations as discussed herein, other embodiments herein include the application 422 itself (i.e., the un-executed or non-performing logic instructions and/or data). The application 422 may be stored on a computer readable medium (e.g., a repository) such as a disk or in an optical medium. According to other embodiments, the application 422 can also be stored in a memory type system such as in firmware, read only memory (ROM), or, as in this example, as executable code within the main memory 406 (e.g., within Random Access Memory or RAM). For example, application 422 may also be stored in removable storage media 410, read-only memory 408, and/or mass storage device 412.

Those skilled in the art will understand that the computer system 400 can include other processes and/or software and hardware components, such as an operating system that controls allocation and use of hardware resources.

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention. In another embodiment, the process includes some human intervention (e.g., a step is performed by or with the assistance of a human).

As used in this description, the term “portion” means some or all. So, for example, “A portion of X” may include some of “X” or all of “X”. In the context of a conversation, the term “portion” means some or all of the conversation.

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

As used herein, including in the claims, a list may include only one item, and, unless otherwise stated, a list of multiple items need not be ordered in any particular manner. A list may include duplicate items. For example, as used herein, the phrase “a list of XYZs” may include one or more “XYZs”.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and/or identify, and not to show any serial or numerical limitation or ordering.

No ordering is implied by any of the labeled boxes in any of the flow diagrams unless specifically shown and stated. When disconnected boxes are shown in a diagram the activities associated with those boxes may be performed in any order, including fully or partially in parallel.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed:

1. A framework for real property appraisal, the framework comprising:
(A) a backend computer system comprising:
(A)(1) a user interface mechanism supporting a graphical user interface to said backend computer system; and
(B) one or more devices operably connected to said backend computer system and interacting with said backend computer system via said user interface mechanism, each of said one or more devices programmed to:
(B)(1) obtain information from said backend computer system about a particular property;
(B)(2) obtain user input about said particular property; and
(B)(3) provide appraisal information to said backend computer system based on said user input.

2. The framework of claim 1 wherein said user input obtained in (B)(2) comprises one or more of: photographs, text, audio input, and property measurements.

3. The framework of claim 1 wherein the backend computer system further comprises:
(A)(2) one or more analysis mechanisms for analyzing data relating to real properties, and wherein said information obtained by said one or more devices in (B)(1) comprises information determined by said backend computer system based on said data relating to real properties.

4. The framework of claim 1 wherein the backend computer system further comprises:
(A)(3) a scheduling mechanism supporting scheduling of real property appraisals.

5. The framework of claim 1 wherein the backend computer system further comprises:
(A)(4) a mechanism for producing an appraisal for a particular real property based on appraisal information about said particular real property obtained from a device of said one or more devices.

6. The framework of claim 1 wherein each of said one or more devices is further programmed to:
(B)(4) present information about one or more comparable properties to said particular property, wherein said one or more comparable properties are determined by said backend based on similarity to the particular property.

7. The framework of claim 6 wherein the similarity is based on user-selectable parameters.

8. The framework of claim 6 wherein the values of comparable properties are user-adjustable.

9. The framework of claim 6 wherein each of said one or more devices is further programmed to:
(B)(5) provide a regression summary of comparable properties with respect to various variables.

10. A device, operable in framework for real property appraisal, the framework having a backend computer system, the device comprising:
a user interface mechanism supporting a graphical user interface to said backend computer system, said device being operably connected to said backend computer system and interacting with said backend computer system via said user interface mechanism, said device constructed and adapted to:
(a) obtain, via said user interface mechanism, information from said backend computer system about a particular property;
(b) obtain, via said user interface mechanism, user input about said particular property; and
(c) provide, via said user interface mechanism, appraisal information to said backend computer system based on said user input.

11. The device of claim 10 wherein said user input obtained in (b) comprises one or more of: photographs, text, audio input, and property measurements.

12. The device of claim 10 wherein said device is further constructed and adapted to:
(d) present, via said user interface mechanism, information about one or more comparable properties to said particular property, wherein said one or more comparable properties are determined by said backend based on similarity to the particular property.

13. The device of claim 12 wherein the similarity is based on user-selectable parameters.

14. The device of claim 12 wherein the values of comparable properties are user-adjustable via said user interface mechanism.

15. The device of claim 10 wherein said device is further constructed and adapted to:
(e) provide, via said user interface mechanism, a regression summary of comparable properties with respect to various variables.

16. The device of claim 10 wherein the backend computer system comprises one or more analysis mechanisms for analyzing data relating to real properties, and wherein said information obtained by said one device in (a) comprises information determined by said backend computer system based on said data relating to real properties.

17. The device of claim 10 wherein the backend computer system further comprises: a scheduling mechanism supporting scheduling of real property appraisals via said user interface mechanism on said device.

18. The device of claim 10 wherein the backend computer system further comprises a mechanism for producing an appraisal for a particular real property based on appraisal information about said particular real property obtained from said device via said user interface mechanism.
